(19) United States
(12) Patent Application Publication
(10) Pub. No.: US 2025/0356673 A1
(43) Pub. Date: Nov. 20, 2025

(54) AUDIO ENHANCEMENT OF VIDEO THROUGH VIDEO FILE SEGMENTATION, EVENT EXTRACTION, AND CONTEXTUAL DATA STRUCTURING FOREFFICIENT MATCHING, GENERATION, AND/OR ALIGNMENT OF AUDIO TO ADEPICTED EVENT

(71) Applicant: Noctal, Inc., Los Angeles,, CA (US)

(72) Inventors: ISAIAH D. CHAVOUS, Santa Monica, CA (US); JOSHUA D. EISENBERG, Miami, FL (US); JAMES P. PAUL, Los Angeles, CA (US)

(21) Appl. No.: 19/209,600

(22) Filed: May 15, 2025

Related U.S. Application Data
(60) Provisional application No. 63/648,119, filed on May 15, 2024.

(51) Int. Cl. G06V 20/70; G06N 3/0475; G06V 20/40

(52) U.S. Cl. CPC G06V 20/70; G06N 3/0475; G06V 20/44; G06V 20/49

(57) ABSTRACT

Disclosed are a method, a device, and/or a system of audio enhancement of video through video file segmentation, event extraction, and contextual data structuring for efficient matching, generation, and/or alignment of audio to a depicted event. In one embodiment, a system includes a memory storing computer readable instructions that when executed initiate a video object in a database representing a video file and store a video segmentation reference drawn from the video object to a segmentation object, which may represent a shot or scene in the video. The system may parse the video file to extract an event including an event range, an event description, and an event ontology, and may generate encoding vector(s) therefrom. The system may initiate an event object, then link the event object to the video object through the segmentation object, to enable efficient import of context for audio matching and/or audio generation for the event.

### CLAIM FOR PRIORITY AND CROSS REFERENCE TO RELATED APPLICATIONS

This patent application claims priority from, and hereby incorporates by reference: U.S. provisional patent application No. 63/648,119, entitled ‘AUTOMATED EVENT DETECTION AND CONTEXTUAL FEATURE EXTRACTION FROM VIDEOS FOR SOUND GENERATION’, filed May 15, 2024.

### FIELD OF TECHNOLOGY

This disclosure relates generally to audio engineering, multimedia data processing devices and, more particularly, to a method, a device, and/or a system of segmentation and/or event extraction of audio enhancement of video through video file segmentation, event extraction, and contextual data structuring for efficient matching, generation, and/or alignment of audio to a depicted event.

### BACKGROUND

Multimedia may include or may be associated with audio. Multimedia may include video, audio, video games, text (e.g., a book), virtual reality or augmented reality, and other forms of digital content. For example, a video may have been filmed or otherwise associated with one or more audio channels, and the video may then have additional audio, audio channels, and/or sound effects mixed in and then mastered. Other examples of multimedia associated with audio are existing audio recordings that have additional audio added or associated, and sounds applied to video game elements, actions, and environments, and environmental interactions, etc.

In many cases, producers, studios, engineers, and other creators wish to enhance the audio of the multimedia file, for example by adding sound effects. This is often desirable so that clean and deliberate audio, especially reinforcing the purpose, objective, and/or narrative, can be selected. As just one example, despite an eagle appearing in a film, it is common for the sound of an eagle to be replaced with the sound of a red tailed hawk: while the eagle is impressive in visual stature, the red tailed hawk has a more iconic bird call. The user selecting, incorporating, editing, mixing, and/or mastering multimedia audio can range from sound engineers working on a blockbuster movie to solo influencers enhancing video content for a social media channel. Within the film industry, this process of finding, adding, editing, and mixing audio may be referred to as “foley.”

Multiple challenges can arise in the audio enhancement process. First, the events requiring audio must be defined. Traditionally, events have been identified manually, which can be time consuming. Second, the events then are generally described to create criteria for searching for matching audio. Third, audio must be found matching the event. This can be challenging because numerous factors are evaluated, including the accuracy of the intended sound in matching the event, the timing of the audio relative to event duration (e.g., is the audio too short, too long, or just right for the event?), the temporal structure of the event (e.g., does the sound of an ambulance going toward and away from the camera view match what is seen on the screen?), the narrative reinforcement (e.g., a ‘normal’ door creak versus a ‘scary’ door creak), etc. Fourth, the audio must be properly mixed. A challenge can arise in determining and defining the levels and other waveform qualities that best suit the needs of the moment, for example which audio is more important to an audience in film. The process also can be relatively time consuming (e.g., due to manual or suboptimal automated processes), expensive (e.g., requiring one or more audio engineers), and/or may be potentially limited in creative options (e.g., there may be limited sound libraries to choose from).

New systems, devices, and/or methods are desirable for increasing the flexibility, efficiency, and creative power for adding and editing audio for multimedia, along with decreasing the time in production. Such new systems, devices, and/or methods are valuable to a wide range of businesses, artists, engineers, and even consumers, from film studios and marketing departments producing advertisements, to hobbyists and social media influencers.

### SUMMARY

Disclosed are a method, a device, and/or a system of multimedia audio enhancement, and/or audio enhancement of video through video file segmentation, event extraction, and contextual data structuring for efficient matching, generation, and/or alignment of audio to a depicted event. In one embodiment, a system for parsing a video file for audio enhancement of the video file includes a processor and a memory that includes a physical non-transient computer readable memory. The memory stores computer readable instructions that when executed: specify a video file; initiate a video object in a database; store a video UID in association with the video object; and store a video file reference drawn from the video object to the video file.

The memory also stores computer readable instructions that when executed: generate a video structure data comprising a video segmentation reference drawn from the video object to a segmentation object within the database; and parse the video file to extract an event comprising an action and/or a state of being depicted in the video file. The parsing process includes: (i) determining an event range including a time range of the event and/or a frame range of the event, (ii) inputting a portion of the video file specified by the event range into an event description model, (iii) receiving an event description data and/or an event summary data, (iv) inputting the portion of the video file specified by the event range into an event ontology determination module, and (v) receiving an event ontology data including a verb class data and/or a semantic roll label data.

The memory also stores computer readable instructions that when executed initiate an event object in the database and store an event UID in association with the event object. The computer readable instructions, when executed, also store in association with the event object: (i) an event range data comprising at least one of the time range and the frame range, (ii) the event description data and/or the event summary data, and (iii) the event ontology data. Further, the memory stores computer readable instructions that when executed associate within the database the video object and the event object through: (i) an event object reference drawn between the video object and the event object and/or (ii) two or more segmentation references linking the video object to the event object through one or more interstitial segmentation objects between the video object and the event object within the database. As a result, a contextual link may be formed for efficiently importing context to assist in audio matching and/or audio generation for assigning audio to the event.

The memory further includes computer readable instructions that when executed input the event description data, the event summary data, the verb class data, and/or the semantic roll label data into a vector embedding engine. The computer readable instructions of the memory, when executed, may also receive a description vector encoding text from the event description data, the event summary data, the verb class data, and/or the semantic roll label data, and then input the event range data into the vector embedding engine and/or receive a temporal vector embedding event range data. When executed, the computer readable instructions of the memory may then store the description vector and the temporal vector in association with the event object to enable rapid query and use in at least one of audio matching and audio generation associated with the event.

The system may further include within the memory computer readable instructions that when executed parse the video file to extract a shot that includes a continuous recording from a single camera perspective. The parsing process may include determining a shot range comprising a time range of the shot and/or a frame range of the shot, inputting a portion of the video file specified by the event range into an event description model, and/or receiving a shot description data and/or a shot summary data.

The memory may further include computer readable instructions that when executed initiate a shot object in the database and store a shot UID in association with the shot object. The computer readable instructions that when executed may then associate within the database the video object and the shot object through (i) a shot object reference drawn between the video object and the shot object and/or (ii) a segmentation reference linking the video object to the shot object through an interstitial segmentation object between the video object and the shot object. The computer readable instructions of the memory, when executed, may then associate within the database the shot object and the event object through a second event object reference drawn between the shot object and the event object.

The memory may further include computer readable instructions that when executed parse the video file to extract a scene including a series of one or more shots depicting events closely interrelated in time. The parsing process may include determining a scene range that includes a time range of the scene and/or a frame range of the scene, inputting a portion of the video file specified by the scene range into a segmentation description model, and/or receiving at a scene description data and/or a scene summary data.

The memory may include computer readable instructions that when executed initiate a scene object in the database and store a scene UID in association with the scene object. The computer readable instructions when executed may also associate within the database the scene object and the shot object through a shot object reference drawn between the scene object and the shot object, and/or associate within the database the video object and the scene object through a scene object reference drawn between the video object and the scene object.

In addition, the system may include, within the memory, computer readable instructions that when executed: determine an event of the event object is associated with a different event of a different event object; classify at least one of a subject of the event and an action of the event and classifying at least one of a different subject of the different event and a different action of the different event; and/or determine that (i) the subject is higher priority than the different subject, and/or (ii) the action is higher priority of the different action. A priority value of the event then may be written in the event object which is greater than a priority value of the different event such that an audio assigned to the event is signaled for amplification relative to the audio assigned to the different event.

The memory may also include readable instructions that when executed select the event object for audio generation; extract an encoding vector of the event object, the event description data, the event summary data, an event tag, and/or the event ontology data; traverse a database reference between the event object and the shot object; and extract an encoding vector of the shot object, the shot description data, a shot summary data, and/or a shot tag. Similarly, the memory may also include readable instructions that when executed traverse a database reference between the shot object and the scene object; extract an encoding vector of the scene object, the scene description data, a scene summary data, and/or a scene tag; traverse a database reference between the scene object and the video object; extract an encoding vector of the scene object, the scene description data, a scene summary data, and/or a scene tag; and generate a context data that includes data extracted from each of the event object, the shot object, the scene object, and/or the video object, to gather relevant context for generation of the audio for the event.

The system may also include within the memory comprising computer readable instructions that when executed input the context data into a generative audio engine; receive an audio file that is output from the generative audio engine; store the audio file in association with the event object; and determine an event of the event object is associated with another event of another event object. The association may be a causal relation (e.g., one depicted event may have caused or initiated another). The computer readable instructions of the memory may also, when executed, define a third event reference drawn between the event object and another event object and impose a contrast requirement on an audio matching engine that matches the audio to be associated with the event object and/or a generative engine generating the audio associated with the event object. The audio file associated with the event also may be matched and/or generated based on contrast with a different audio file of the different event.

The computer readable instructions of the memory, when executed, may also import the context data into a context window of a generative audio model and/or an argument of the generative audio model. A context weight may be assigned to data within the context data, which may diminish with each database reference traversed from the event object. Extraction of a scene may include recognition of similar graphical data between frames within a time horizon of the video file. Extraction of a shot may include recognition of a low relative variation in graphical data between frames within a time horizon of the shot.

In another embodiment, a computer readable media that is physical and non-transitory includes a data structure for efficient audio matching and/or audio generation for a video file. The data structure includes a video object as a root of the data structure. The video object includes a video object UID, a video file reference to the video file, a video data (including a video description data, a video summary data, and/or a video tag), and/or a video structure data that includes a first segmentation object reference storing a first segmentation object UID.

The data structure further includes a first segmentation object of a first order segmentation referenced by the first segmentation reference. The first segmentation object includes the first segmentation object UID. The first segmentation object also includes a segmentation description data of the first segmentation object, a segmentation summary data of the first segmentation object, and a segmentation tag of the first segmentation object.

The data structure may also include a first event object referenced by the first segmentation object and/or one or more other segmentation objects referenced by the first segmentation object. The first event object includes an event UID of the first event object and an event range data specifying a range over which an event of the first event object occurs within the video file. The event object also includes an event description data of the first event object that includes an event description data of the first event object, an event summary data of the first event object, and/or an event tag of the first event object. The event ontology data of the first event object includes a subject-object parse of the first event object, a verb class data of the first event object, and/or a semantic roll label data of the first event object.

The first event object may further include a description vector of the first event object that encodes the event description data, the event summary data of the first event object, the event tag of the first event object, and/or the event ontology data of the first event object. The first event object may also include a temporal vector of the first event object that encodes the event range data. The first segmentation object may further include a description vector of the segmentation object that encodes the segmentation description data of the first segmentation object, and/or a segmentation tag of the first segmentation object.

The data structure may further include a second segmentation object of a second order segmentation. The second segmentation object may include a second segmentation UID, a segmentation description data of the second segmentation object, a segmentation summary data of the second segmentation object, and/or a segmentation tag of the second segmentation object. The one or more other segmentation objects referencing the first event object may include the second segmentation object.

The data structure may further include a second event object that includes an event UID of the second event object. The second event object may be referenced by the first event object and/or the second segmentation object such that the second event object can be defined to be and/or determined to be a related event to the event modeled by the first event object.

The first event object may further include a priority value of the first event object specifying a global priority, a local priority within a segmentation order, and/or a local priority among two or more event objects within a temporal proximity threshold. The second event object may include a priority value of the second event object such that query to the first event object and/or the second event object can resolve a priority between the event of the first event object and an event of the second event object. The first segmentation object may model a scene, and the second segmentation object may model a shot.

In yet another embodiment, a method for parsing a video file for audio enhancement of the video file includes specifying a video file, initiating a video object in a database stored in one or more non-transitory computer readable memories, storing a video UID in association with the video object and storing a video file reference drawn from the video object to the video file. The method then generates a video structure data comprising a video segmentation reference drawn from the video object to a segmentation object within the database and parses the video file to extract an event that includes an action and/or a state of being depicted in the video file. The parsing process may include determining an event range including a time range of the event and/or a frame range of the event, inputting a portion of the video file specified by the event range to an event description model, receiving an event description data and/or an event summary data, inputting the portion of the video file specified by the event range into an event ontology determination module, and/or receiving an event ontology data that includes a verb class data and/or a semantic roll label data.

The method further includes initiating an event object in the database and storing an event UID in association with the event object. The method then may store in association with the event object: (i) an event range data comprising at least one of the time range and the frame range, (ii) the event description data and/or the event summary data, and (iii) the event ontology data. The method also associates within the database the video object and the event object through: (i) an event object reference drawn between the video object and the event object and/or (ii) two or more segmentation references linking the video object to the event object through one or more interstitial segmentation objects between the video object and the event object within the database. As a result, a contextual link may be formed for efficiently importing context for audio matching and/or audio generation for the event.

The method may further include inputting the event description data, the event summary data, the verb class data, and/or the semantic roll label data into a vector embedding engine. A description vector may then receive encoding text from the event description data, the event summary data, the verb class data, and/or the semantic roll label data. The event range data may be input into the vector embedding engine. A temporal vector that embeds event range data may be received. The method may then store the description vector and the temporal vector in association with the event object for rapid query and use in at least one of audio matching and audio generation associated with the event.

The method also may parse the video file to extract a shot that includes a continuous recording from a single camera perspective. The parsing process may include determining a shot range that includes a time range of the shot and/or a frame range of the shot, inputting a portion of the video file specified by the event range into an event description model, and receiving a shot description data and/or a shot summary data.

A shot object may be initiated in the database and a shot UID stored in association with the shot object. The method may then associate within the database the video object and the shot object through (i) a shot object reference drawn between the video object and the shot object and/or (ii) a segmentation reference linking the video object to the shot object through an interstitial segmentation object between the video object and the shot object. The shot object and the event object may be associated within the database through a second event object reference drawn between the shot object and the event object.

The method may also include parsing the video file to extract a scene including a series of one or more shots depicting events closely interrelated in time. The parsing process may include determining a scene range including a time range of the scene and/or a frame range of the scene, inputting a portion of the video file specified by the scene range into a segmentation description model, and/or receiving a scene description data and/or a scene summary data. The method may also initiate a scene object in the database and store a scene UID in association with the scene object. Further, the method may: associate within the database the scene object and the shot object through a shot object reference drawn between the scene object and the shot object, and associate within the database the video object and the scene object through a scene object reference drawn between the video object and the scene object.

The method may determine that an event of the event object is associated with a different event of a different event object, classify a subject of the event and/or an action of the event, and classify a different subject of the different event and/or a different action of the different event. The method may then determine: (i) the subject is higher priority than the different subject, and/or (ii) the action is higher priority of the different action. A priority value of the event may be written in the event object, wherein the priority value of the event may be greater than a priority value of the different event such that an audio assigned to the event is signaled for amplification relative to the audio assigned for the different event.

The method also may select the event object for audio generation, extract an encoding vector of the event object, the event description data, the event summary data, an event tag, and/or the event ontology data, and traverse a database reference between the event object and the shot object. The method also may include extracting an encoding vector of the shot object, the shot description data, a shot summary data, and/or a shot tag; traversing a database reference between the shot object and the scene object; extracting an encoding vector of the scene object, the scene description data, a scene summary data, and/or a scene tag; traversing a database reference between the scene object and the video object; and extracting an encoding vector of the video object, the video description data, a video summary data, and/or a video tag. A context data may be generated including data extracted from each of the event object, the shot object, the scene object, and/or the video object, to gather relevant context for generation of the audio for the event.

The context data may be input into a generative audio engine. The method may receive an audio file that is output from the generative audio engine, store the audio file in association with the event object, and/or determine an event of the event object is associated with another event of another event object. The association may be a causal relation.

The method may define a third event reference drawn between the event object and another event object and impose a contrast requirement on an audio matching engine matching the audio to be associated with the event object and/or a generative engine generating the audio to be associated with the event object. The audio file associated with the event may be matched and/or generated based on contrast with a different audio file of the different event. The method may import the context data into a context window of a generative audio model and/or an argument of the generative audio model. A context weight may be assigned to data within the context data diminishes with each database reference traverse from the event object. Extraction of a scene may include recognition of similar graphical data between frames within a time horizon of the video file. Extraction of a shot may include recognition of low relative variation in graphical data between frames within a time horizon of the shot.

### BRIEF DESCRIPTION OF THE DRAWINGS

The embodiments of this disclosure are illustrated by way of example and not limitation in the figures of the accompanying drawings, in which like references indicate similar elements and in which:

FIG. 1A illustrates a multimedia enhancement network including: one or more users on client devices usable by users to enhance audio for multimedia files through a multimedia audio enhancement application; an enhancement server able to automatically (and/or with user input) extract, create, mix, and master audio including through one or more AI models, an event structure server for describing and structuring multimedia segmentations and events; an audio server capable of events to audio; a generative server for generating audio files for events; and a multimedia server storing the multimedia, to be audio enhanced such as a video file, according to one or more embodiments.

FIG. 1B illustrates a data structure for describing and associating events within a multimedia file, including an event object, two levels of multimedia segmentation object, and a multimedia object, and specifically shown as instantiated for video as an event object of the video, a shot object, a scene object, and a video object, respectively, according to one or more embodiments.

FIG. 1C illustrates multiple examples of the data structure of FIG. 1B, including a first structural level of a video object, a second level comprised of scene objects, a third level comprised of shot objects, and a fourth level comprised of event objects, and further illustrating object nodes within the data structure associated through database relations that can be traversed to move through the data structure, according to one or more embodiments.

FIG. 2 illustrates the enhancement server of FIG. 1A, including an event extraction engine, a multimedia segmentation engine, an audio creation engine, an audio mixing engine, a model training data routine, a multimedia audio enhancement application, and/or a mastering engine, according to one or more embodiments.

FIG. 3 illustrates the event structure server of FIG. 1A, including an event structure database storing the data structure of FIG. 1B and/or FIG. 1C, an object assembly routine, a vector embedding engine, and a contextual expansion routine, according to one or more embodiments.

FIG. 4 illustrates an audio server including: an audio library; an audio description engine for parsing and/or describing audio files; an audio matching engine capable of matching textural descriptions and/or encoding vectors to audio; a library description map associating audio files with audio file descriptions and/or vectors; a generative library 431 of audio files generated (e.g., through the generative audio engine of FIG. 5); and/or a master database storing master audio files that are ready for production use with the multimedia, according to one or more embodiments.

FIG. 5 illustrates a generative server of FIG. 1A, including one or more generative audio models (as may be individually trained on certain types or durations of events), a generative audio engine, and an AI attribution subroutine, according to one or more embodiments.

FIG. 6 illustrates the multimedia server of FIG. 1A, including one or more multimedia databases storing multimedia files, for example a video database, a game database, and/or a text database, according to one or more embodiments.

FIG. 7 illustrates contextual extraction of data of an event object and/or associated segmentation objects and/or event object to result in a context data usable to improve matching to audio files and/or generative synthesis of audio files, according to one or more embodiments.

FIG. 8 illustrates descriptive data mapping to preexisting audio within an audio library using a library description map, optionally in combination with a descriptive vectorspace and/or temporal vectorspace, to improve accuracy and/or efficiency in matching audio to an event object, according to one or more embodiments.

FIG. 9 illustrates generative synthesis of audio files using the context data of FIG. 7 and/or user defined modifications and enhanced instructions to improve accuracy and/or efficiency of generative audio created to enhance the multimedia, according to one or more embodiments.

FIG. 10 illustrates generative synthesis of audio files using preexisting (e.g., prerecorded or traditionally synthesized without a generative model) audio files to help the user further quickly iterate and refine audio for enhancing multimedia, including optional attribution to a rights holder of the preexisting audio such as an owner or artist, according to one or more embodiments.

FIG. 11 illustrates a user interface of the multimedia audio enhancement application that allows a user to view, select, and edit data objects and associated audio, and specifically a video audio enhancement application, according to one or more embodiments.

FIG. 12 illustrates streamlined audio preview, detection of related and/or overlapping events, and use of imperative database relations to further assist in matching and/or generating audio, according to one or more embodiments.

FIG. 13 illustrates audio mixing, including event prioritization, imputed prioritization as a result of associations and/or imperatives, and normalization of mixed audio, according to one or more embodiments.

FIG. 14 illustrates assembly and use of a training data package usable to training one or more AI models in recognition, segmentation, bounding, alignment, matching and/or generative synthesis, including for example an event segmentation model, according to one or more embodiments.

FIG. 15 illustrates a segmentation, event extraction and/or audio assignment process flow, according to one or more embodiments.

FIG. 16 illustrates an editing, mixing, and/or mastering process flow, according to one or more embodiments.

FIG. 17 illustrates a multimedia segmentation process flow, according to one or more embodiments.

FIG. 18 illustrates an event extraction process flow, according to one or more embodiments.

FIG. 19 illustrates an audio selection and/or generation input assembly process flow, according to one or more embodiments.

FIG. 20 illustrates a contextual event extraction process flow, according to one or more embodiments.

FIG. 21 illustrates an existing audio file matching process flow, according to one or more embodiments.

FIG. 22 illustrates a generative audio file synthesis process flow, according to one or more embodiments.

FIG. 23 illustrates an editing, mixing, and mastering process flow, according to one or more embodiments.

FIG. 24 illustrates another example of a user interface of the multimedia audio enhancement application, according to one or more embodiments.

Other features of the present embodiments will be apparent from the accompanying drawings and from the detailed description that follows.

### DETAILED DESCRIPTION

Disclosed are a method, a device, and/or system of multimedia audio enhancement, including a method, a device, and/or a system of audio enhancement of video through video file segmentation, event extraction, and contextual data structuring for efficient matching, generation, and/or alignment of audio to a depicted event. Although the present embodiments have been described with reference to specific example embodiments, it will be evident that various modifications and changes may be made to these embodiments without departing from the broader spirit and scope of the various embodiments.

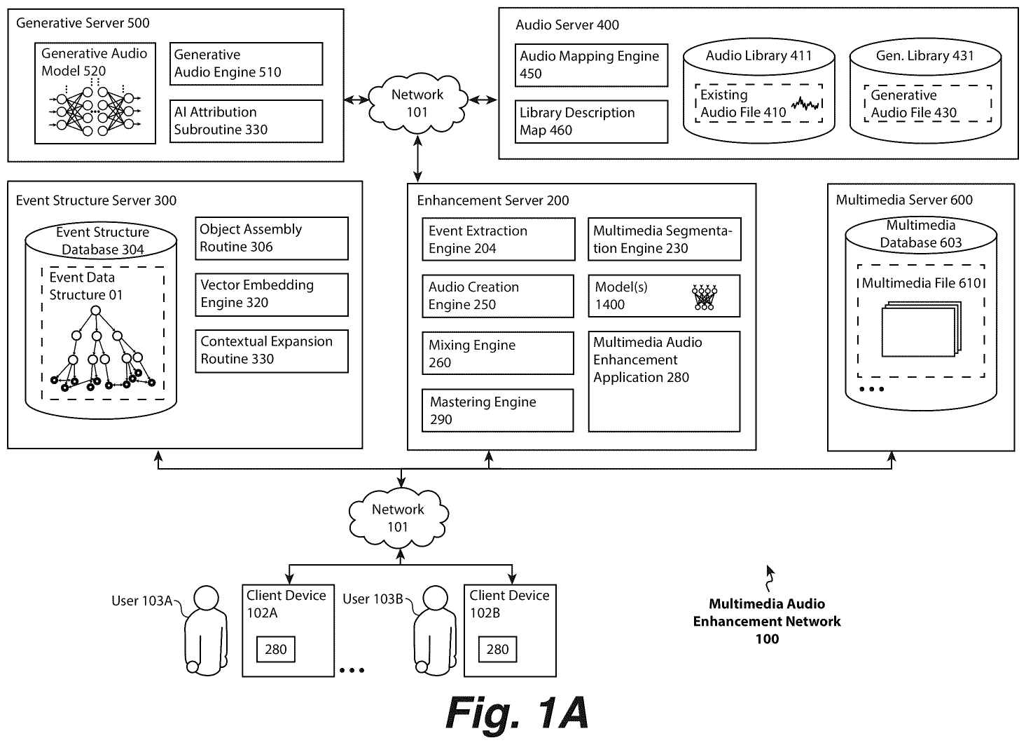

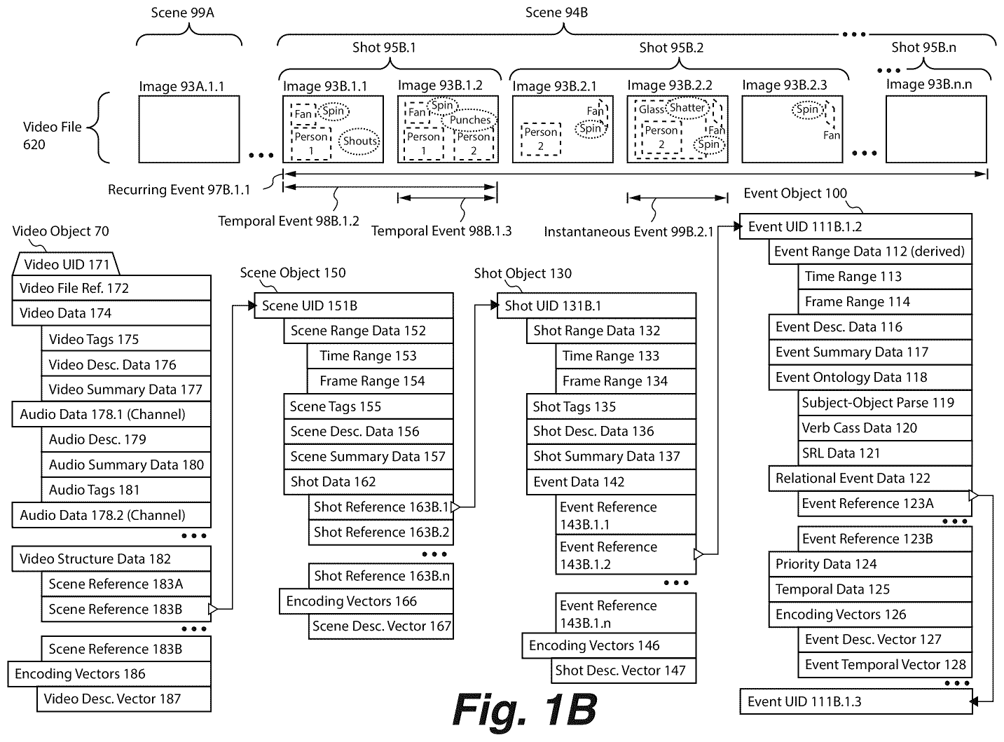

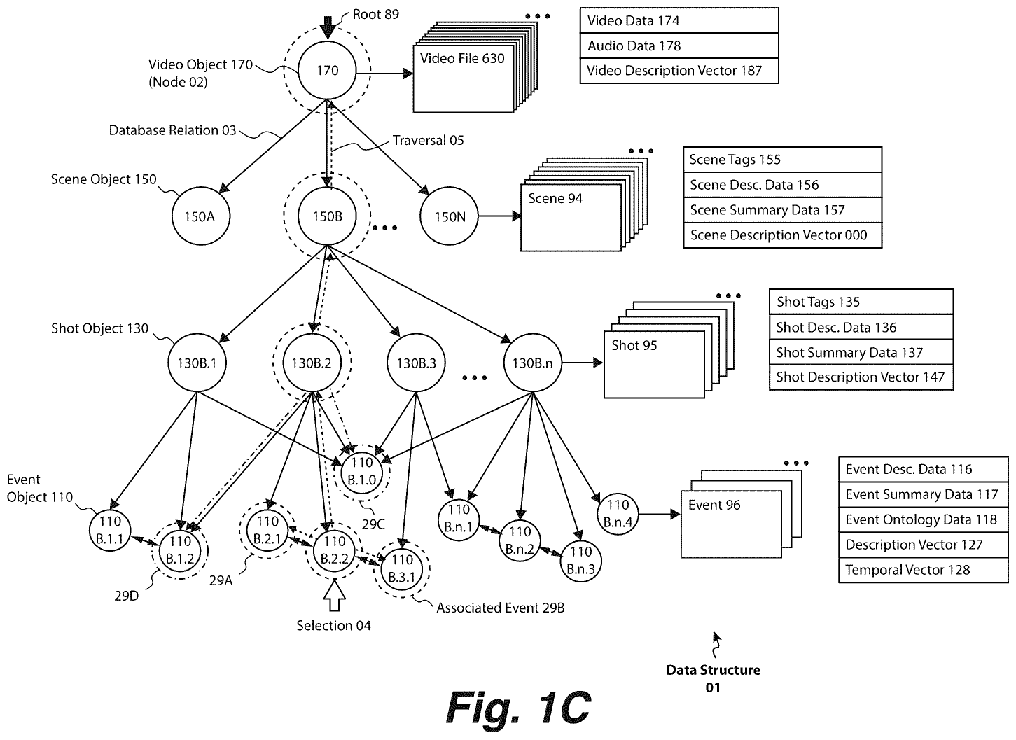

FIG. 1 illustrates a multimedia audio enhancement network 100, according to one or more embodiments.

In one or more embodiments, the multimedia audio enhancement network 100 may be used to enhance multimedia with audio, for example video (e.g., film, an advertisement, and/or a social media clip). The multimedia audio enhancement network 100 may include one or more client device 102, an enhancement server 200, an event structure server 300, an audio server 400, a generative server 500, and/or a multimedia server 600, each of which may be communicatively coupled to each other any other computers through a network 101. The network 101 may comprise one or more other networks (e.g., the internet, a wide area network (WAN), a local area network (LAN), etc.).

Each of the following systems, devices, and processes discuss multiple aspects of separate but related and potentially overlapping embodiments herein, including: (i) multimedia segmentation and event extraction, (ii) audio matching and/or generation, and/or (iii) audio editing and/or mixing. Collectively, these stages of multimedia enhancement represent a multimedia audio enhancement pipeline that individually and collectively can increase the quality, accuracy, flexibility, and creative options for audio enhancement of multimedia, while decreasing time, needed personnel, and production cost. An overview of such pipeline, and each of the servers that may be involved, will now be provided.

In one or more embodiments, one or more users 103 may use and/or access a multimedia audio enhancement application 280 installed on a client device 102. Alternatively, or in addition, application components may be installed on either or both of the client device 102 (e.g., a native application) or the enhancement server 200 (e.g., a web application accessed on a browser of the client device 102). The client device 102, for example, may be a desktop computer, a laptop computer, a tablet computer, a smartphone, and/or a server computer. The client device 102 may upload and/or select a multimedia file 610, for example as may be uploaded to and/or stored on a multimedia server 600 within a multimedia database 603. The user 103 may then select the multimedia file 610 to begin an audio enhancement process.

In one or more embodiments, the multimedia segmentation engine 230 and/or the event extraction engine 204 may parse the multimedia file 610 to determine multimedia segmentations within the multimedia file 610 and events, respectively, as further shown and described throughout the present embodiments. For example, and as shown and described in conjunction with the embodiment of FIG. 1B, a video may be described by segmentation into scenes 94, shots 95, and events 96, according to one or more embodiments. As part of extraction, the segmentations and/or events may be described, for example through text descriptions, temporal descriptions, and/or their location or extent within the multimedia file 610 (e.g., a time range 13 and/or a frame range 14 within the video file 620). In one or more embodiments, event extraction may include recognition, identification, description, and/or bounding of events 96, which may be partially or entirely carried out by one or more models 1400. In one or more embodiments, and as may be further shown and described herein, one or more models 1400 may be communicatively coupled and/or chained such that an event bounded by a first recognition model 1200A may be described by a second recognition model 1200B. In one or more embodiments, the event extraction engine 204 may additionally determine an event ontology for one or more events, for example a verb class or semantic role label parse, as known in the art of sound engineering, video production, and/or foley.

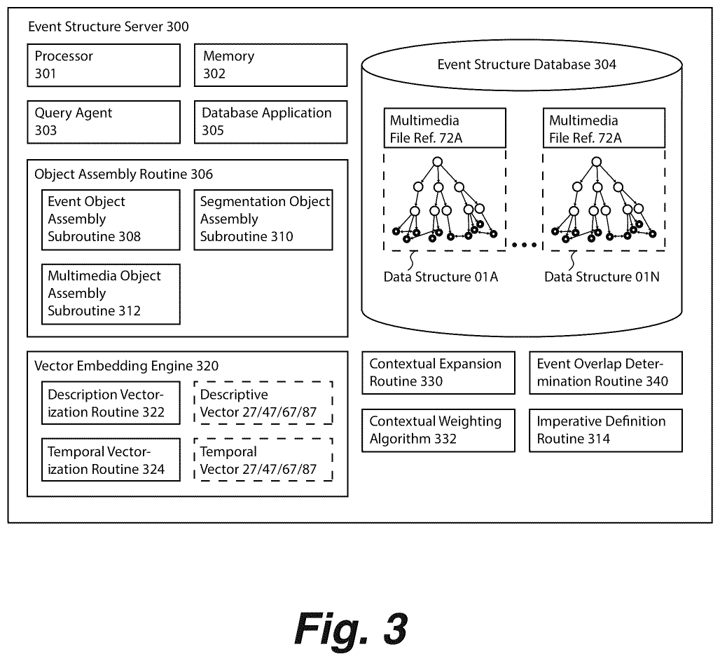

Segmentations, events, and descriptions thereof may be structured into the event data structure 01 through an object assembly routine 306, for example as shown and described in conjunction with the embodiment of FIG. 1B, FIG. 1C, FIG. 3 and throughout the present embodiments. The event data structure 01 may also be referred to herein and shown in the figures as the data structure 01. The user 103 may edit descriptions or range data to override and automatically generate data. As shown and described herein, the event data structure 01 may include rich context due to the nodes 02, data of each node 02, and database relations 03 thereof specifying various types of relational information. In one or more embodiments, the event data structure 01 may be usable to accurately, efficiently, and rapidly find, match, add effects, mix, and/or master audio for the associated multimedia file 610. As a result, a user 103 may gain the benefit of a device, system, and method that includes an automatic, fast, and accurate way to segment, define, group, and describe events for a video file 620. The technology of one or more of the present embodiments may help replace or supplement a process which may otherwise take multiple users and many hours, depending on the size of the multimedia file 610.

Following creation of the event data structure 01, the user 103 may request that audio is automatically matched to, and/or created for, each of the events 96 associated with the event objects 10 within the event data structure 01. An audio creation engine 250 may call the audio server 400 to match existing audio to the event object 10 and/or the generative server 500 to generate audio for the event object 10. In one or more embodiments, both the audio server 400 and/or the generative server 500 may output several instances of the audio file 405 (e.g., the existing audio file 410 and/or the generative audio file 430, respectively). An audio matching engine 450 may match data from the event object 10 to match to data associated with the existing audio file 410, e.g., the event description data 16 matched to the audio file description 413. In one or more embodiments, as further described below, a match may be made between one or more encoding vectors 26 of the event object 10 and one or more encoding vectors 426 of existing audio file 410.

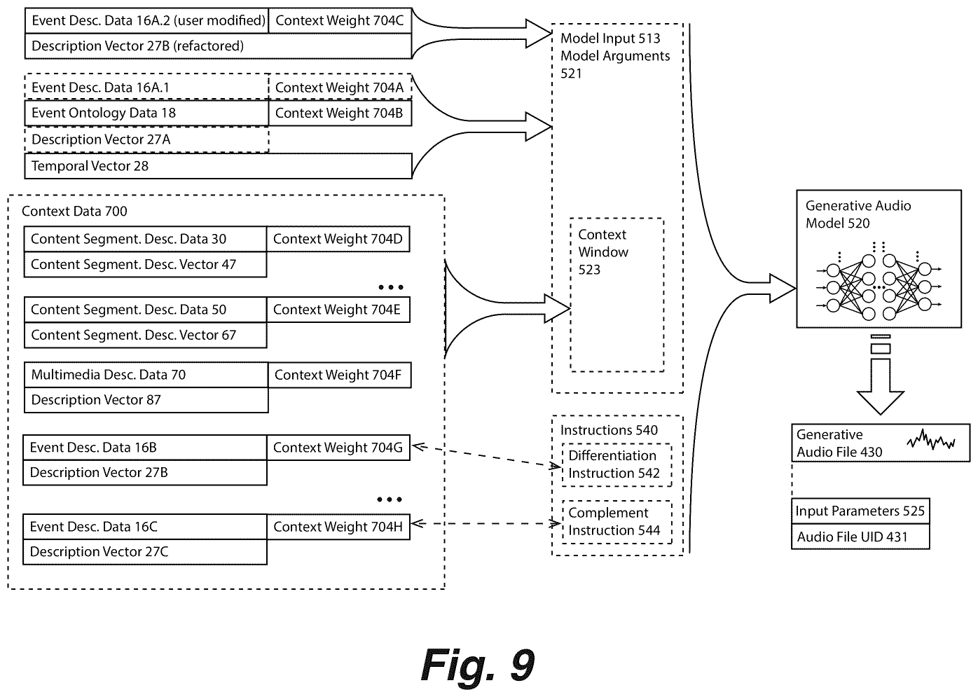

In one or more embodiments, context data 700 gathered from the multimedia segmentation objects 30 and/or other event objects 10 may assist in the matching and/or generative synthesis of audio, for example as shown and described in conjunction with the embodiment of FIG. 9 and throughout the present embodiments.

Each of the existing audio files 410 and/or generative audio files 430 may be returned to the user 103 for preview and approval (e.g., via the multimedia audio enhancement application 280), may be stored for persistent use (e.g., the generative audio file 430 stored within the generative library 431), and/or referenced by the event object 10 within the event data structure 01 for later user or query. As a result, a user 103 may now have the benefit of an automatic, fast, and accurate way to automatically select and/or generate audio, and thereafter pair the audio with event objects 10. The resulting audio might be a draft for further review and modification, or may be intended for production use with little or no human review prior to use, release, or other publication. In one or more embodiments, the multimedia audio enhancement network 100 may recognize events and associate audio or perform foley in real time. For example, the multimedia file 610 may be a streamed video to which events are automatically being identified and sound effects generated in real time (and/or near real time with a short delay for required processing).

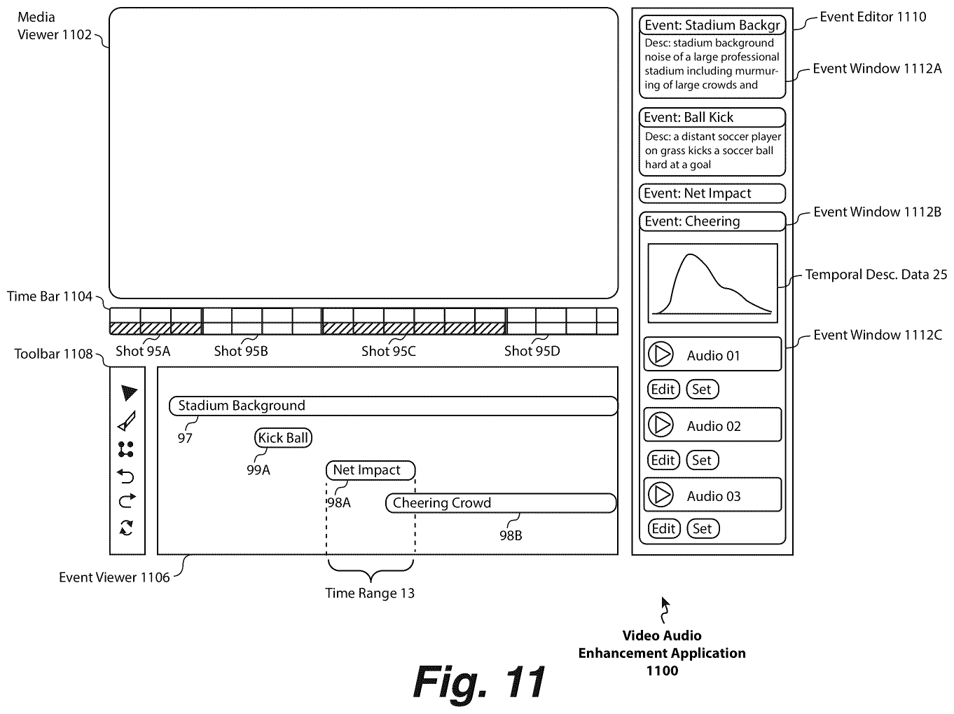

Following automatic selection and/or generation of one or more audio files, the user 103 may perform customization, editing, adjustment, tuning, and/or other modifications to the event data structure 01 and data thereof, including the associated audio files 405, according to one or more embodiments. In the present embodiment, an audio file 405 may mean any type of audio that may be associated with an event 96, including either an existing audio file 410 and/or a generative audio file 430, according to one or more embodiments. The multimedia audio enhancement application 280 may include a multimedia player that plays or otherwise displays the multimedia file 610 to the user 103, including concurrently with playing matched or generated audio. An example of a user interface for perceiving, editing, manipulating, and modifying the event data structure 01, audio files 405, is shown and described in conjunction with the embodiment of FIG. 11. The user 103 may preview the audio associated with each event object 10 or group of event objects 10; the user 103 may also adjust the event range data 12 to redo the boundaries for the event 96, edit a temporal structure of the event (e.g., a point in time in which a sound should be loudest, a gradient over which a sound becomes more quiet, etc.), define relations between events (e.g., imperative relations, causal relations, etc.) and/or edit descriptions that contribute to matching or generative synthesis.

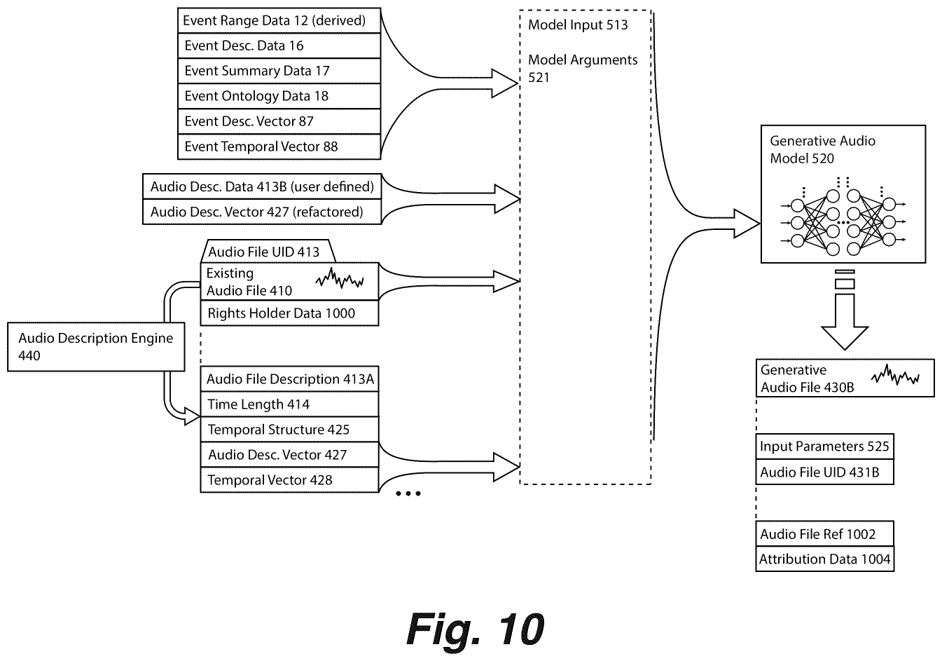

As shown and described in conjunction with the embodiment of FIG. 9, the user 103 may edit descriptive data and/or ontology used as factors to match the existing audio file 410 and/or generate the generative audio file 430. In another example, as shown and described in conjunction with the embodiment of FIG. 10, the user 103 may specify and submit an audio file 405 as a foundation and/or basis to generate a generative audio file 430, including possible attribution to a rights holder or artist of the existing audio file 410 through an AI attribution subroutine 530.

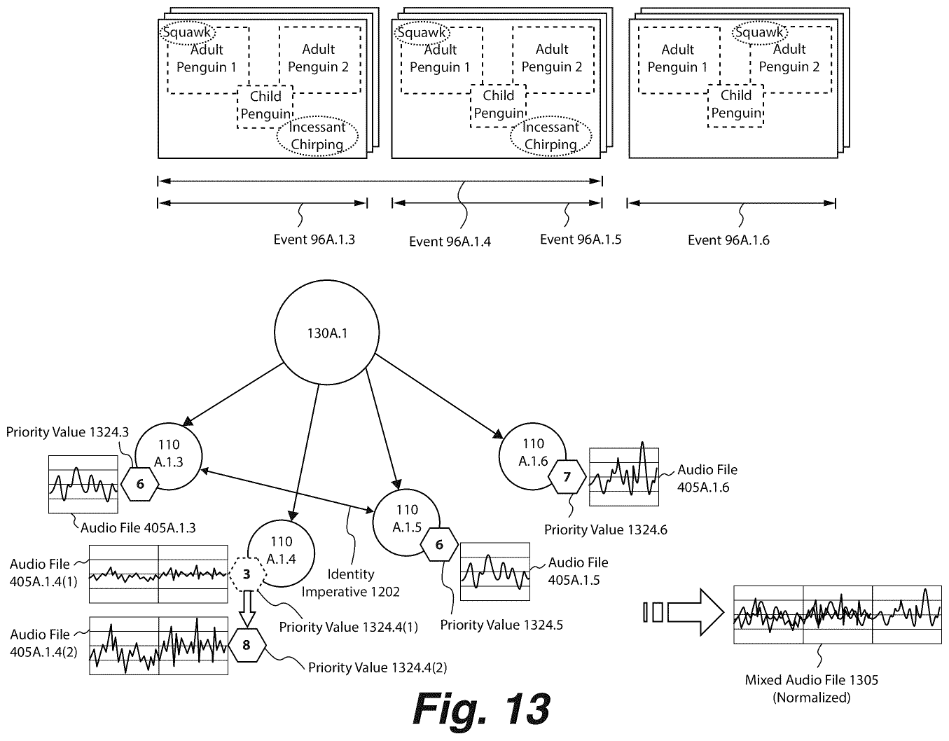

The user 103 may continue to tune and mix the collection of existing audio files 410 and/or audio files 420 specified by the event data structure 01. In one or more embodiments, automatic mixing, including waveform adjustment, may occur based on a priority value automatically and/or manually assigned to each of one or more event objects 10. The priority may be based on a common or perceived need for certain audio to be heard more clearly or at a higher volume than other audio. For example, it may be important to make an actor speaking in a film intelligible, ensuring a subject of the multimedia is audible above background noise. Prioritization may be automatically propagated based on certain database relations 03, such as imperative relations, as shown and described in conjunction with the embodiment of FIG. 13. When editing and mixing is complete, the user 103 may master the collection of audio files and/or existing audio channels of the multimedia to result in a master audio, which may be stored, for example, in the multimedia server 600 and referenced by the event data structure 01. As a result, the user 103 may have an accurate, flexible, and fast way to preview, edit, match, re-generate, mix, and master the audio to enhance the multimedia file 610.

In one or more embodiments, the multimedia audio enhancement network 100 may be used for film production, video game development, augmented reality development, virtual reality development, creation or insertion of advertising, enhancing live streaming, and/or social media video production.

In FIG. 1B and FIG. 1C the event data structure 01 for describing segmentations and events 96 in multimedia will now be further explained.

FIG. 1B illustrates data objects within the event data structure. Within the present embodiment herein, a general object that could apply to a multimedia will be numbered with two digits (e.g., multimedia object 70), whereas an instantiation for the example of video will bear an additional ‘1’ (e.g., the video object 170 which is an instantiation of, and/or specialization of, the multimedia object 70 for the case in which the multimedia is video).

In one or more embodiments, the data structure 01 may include one or more event objects 10 each modeling an event 96 within the multimedia file 610. The events 96 may be of various lengths may occur, in the foreground or background, may be a result of a subject or object (e.g., homodiegetic), and/or may be extra-narrative or (e.g., heterodiegetic part, or breaking the fourth wall in film). An event 96 may be further classified as a recurring event 97, a temporal event 98, and/or an instantaneous event 99, in any type of multimedia. For each event object 10 modeling an event 96, a number of potential data fields or attributes of the event object 10 are shown, each of which may be associated with one or more corresponding values in an appropriate data type.

Each event object 10 may include an event range data 12 specifying where, or under what conditions, the event 96 occurs within the multimedia file 610. For example, this may be a time range 13 (e.g., a time range 113 within a video file 620, a time range within a podcast, etc.) and/or a frame range 14 where the multimedia includes discrete portions or frames (e.g., a frame range 114 for video). The event object 10 may include an event unique identifier 11 as known in the art, for example a unique name, a systematically assigned unique identifier (e.g., a sequential sixteen digit number incrementing with each assignment), and/or a globally unique identifier (e.g., thirty two randomly generated alphanumeric characters). In one or more embodiments, a globally unique identifier may permit for the easy merging of multimedia content by reducing the probability of ID collisions. This may additionally assist multiple users 103 in working with and supporting various aspects of multimedia audio enhancement, for example a team of sound engineers spread around the world working on a major film production or video game.

The event object 10 may include multiple descriptions of the associated event 96, including an event tag 15, an event description data 16, and/or an event summary data 17. The event tag 15 may be data categorizing the event object 10 and/or the event 96, for example to help search, sort, match audio to, or generate audio for the event object 10. As just one example, the event tag 15 can include a desired quality of the audio to be paired with the event 96 (e.g., “silly”, “ominous”), could include emphasis or de-emphasis (e.g., “attention”, “muted”, “deemphasized”), and/or can be associated with certain narrative elements (e.g., tagged with a particular in-story character or other subject such as a magical sword with certain intended audio qualities). Other uses of the event tag 15 will be evident to one skilled in the art of software engineering and/or sound engineering.

The event description data 16 may include a narrative description of the event, for example as automatically described by one or more engines, routines or models shown and described herein, and/or as written or modified by the user 103. Similarly, the event summary data 17 may include a succinct or condensed version of the description and/or act as a single work or sentence to help the user 103 quickly recognize the event 96, as shown in FIG. 11.

An event ontology data 18 may describe the event 96 associated with the event object 10 using one or more ontologies. As one example, a subject-object parse 19 may identify a subject of the event 96 (e.g., a person holding a baseball bat and/or the baseball bat itself) and an object of the event 96 (e.g., a baseball being hit by the bat). Another ontology may include a verb class data 20, for example as provided by VerbNet: A Broad-Coverage, Comprehensive Verb Lexicon by Schuler, K. K. (2005), ProQuest Dissertations Publishing (UMI No. 3179808) (doctoral dissertation). Yet another ontology may include a semantic roll label data 21, which may be known in the art as SRL. Other ontologies that classify and provide additional structure to the recognized event 96 may also be included. It is contemplated herein that additional ontologies will be developed after the date of this specification and can be used with one or more of the present embodiments.

Relational event data 22 may include one or more relations to other event objects 10. For example, a first event object 10B.1.2 may reference a second event object 10B.1.3, as such numbering schema is more particularly described below. The relational event data 22 may comprise one or more event references 23 (e.g., an event reference 23A through an event reference 23N). Each of the event references 23 may include additional data specifying the type of reference, for example a causal relation, an imperative relation, and/or another type of relationship.

The event object 10 may further include priority data 24 which may include one or more priority values 1324 specifying a priority for audio properties relative to one or more other event objects 10, including during audio mixing. Priority values 1324 are further shown and described in conjunction with the embodiment of FIG. 13. The priority may be local to one or a few event objects 10, and/or may be global within data structure 01 with respect to a given multimedia file 610. For example, and as further described herein, a sound made by a subject may be of higher priority than background sound. Similarly, an explosion sound may be of higher priority than a collision sound.

In one or more embodiments, the event object 10 may include encoding vectors 26 which may be used to encode descriptive and/or temporal data about the event 96 modeled by the event object 10. The encoding vector 26 may represent a way to condense and make immediately usable the data describing the event 96 as a model input 513. This embedding may allow for streamlined model input and faster model use, including the ability to rapidly query and group vectors from multiple data objects within the data structure 01, according to one or more embodiments. For example, embedded vectors may assist in assembling a fast and succinct dataset for a group of data objects in the context data 700. In one or more embodiments, encoding vectors 26 may include an event description vector 27 that embeds textual descriptive data through vectorization, such as the event description data 16, the event summary data 17, and/or the event ontology data 18. As shown and described in conjunction with the embodiment of FIG. 3, a vector embedding engine 320 may receive and vectorize data, including re-vectoring as a result of any updates to the descriptive data. Such re-factoring due to updates may occur because the user 103 manually changes the description, an automatic process triggers an update, and/or for other reasons.

The event object 10 may include a temporal description data 25 that describes a structure of the event 96 modeled by the event object 10, for example a mathematical and/or narrative description of the event 96 as presented in the multimedia file 610 (e.g., visually in the case of the video file 620). For example, the temporal description data 25 may specify the irregular pattern of motion of an object in a film (e.g., a person dragging an item across the ground in a shot 95 in irregular bursts of exertion), an event 96 in which the subject is moving with respect to the shot 95 (e.g., an ambulance arriving and leaving the shot 95), and/or an event in which a subject is decreasing in velocity and/or decelerating (e.g., which may create an expectation of an audible gradient). The temporal description data 25 may be embedded within the event temporal vector 28, as further shown and described herein.

In one or more embodiments, the encoding vectors 26 may also include an event temporal vector 28 that embeds through vectorization the event range data 12, the temporal data 25, and/or other data describing temporal aspects of the event 96. The event temporal vector 28 may therefore describe temporal qualities of the event 96. In one or more embodiments, the temporal data 25 may include a duration of the event 96. However, other temporal qualities that can be described may include an intensity, gradient, or mathematical function representing the unfolding of the event 96, such as may be representative of intensity, extent, directionality (e.g., one side of the screen versus the other), distance, and/or loudness. As just one example, the temporal data 25 may encode information modeling an ambulance arriving from a left side of a shot 95 and moving to the right side of the shot 95, including a change in stereo between left and right audio channels. A similar concept may be defined for a podcast or audio book. Similarly, temporal vector 28 may encode an expected higher tone of the ambulance moving toward a camera perspective relative to moving away from the camera perspective, e.g., simulating a Doppler effect. Similarly, the temporal vector 28 may encode data representing the loudness of the sound of the ambulance as it arrives on screen. For example, while the descriptive vector 27 may encode data describing the moment the ambulance is visible in the shot 95, the event range data 12 and/or event temporal data 25 may expand the event 96 outside of the shot 95 to accurately model the perception of the ambulance arriving and departing even at times it is not visible in the shot 95. The temporal data 25 and any embedding as the temporal vector 28 may include structural data of the sound expected in this extended event 96.

In one or more embodiments, each of the event objects 10 may be grouped and associated with one or more segmentations of the multimedia. Each segmentation may be modeled by a segmentation object. There may be an arbitrary number of segmentations within the data structure 01. However, and for illustrative purposes, two examples of a multimedia segmentation object are described, a multimedia segmentation object 30 (e.g., directly grouping and/or referencing one or more event objects 10) and a multimedia segmentation object 50 (e.g., directly grouping and/or referencing one or more multimedia segmentation objects 50). For shorthand reference, the multimedia segmentation object 30 and the multimedia segmentation object 50 may also be referred to herein as the segmentation object 30 and the segmentation object 50, respectively. Similarly, any use of “multimedia segmentation” may be shortened to “segmentation” unless context requires otherwise.

The segmentation object 30 may include a segmentation UID 31 that may be a unique identifier assigned by a similar method to the event UID 11. The segmentation object 30 may also include a segmentation range data 32 with a similar time range 33 and/or frame range 34. The segmentation range data 32 may otherwise specify a range appropriate to the multimedia, for example coordinates over time of a video game action and/or a grouped block of text within narrative text (e.g., a paragraph). For non-temporal or non-sequential multimedia, it can represent different groupings. Similar to the event object 10, the segmentation object 30 may include a segmentation description data 36, a segmentation summary data 37, and a segmentation tag 35, each of which may be used to describe the segmentation.

The segmentation object 30 may include event data 42 referencing one or more event object 10 through one or more event references 43. Each event reference 43 attribute may store a value that may be the event UID 11 of the event object 10, according to one or more embodiments. Therefore, the segmentation object 30 may represent a “second order” or “second level” of structure within the data structure 01 (e.g., where the event objects 10 represent an initial or “first” level of structure.

The segmentation object 30 may also include encoding vectors 46, for example a segmentation description vector 47 which may encode data from the segmentation description data 36, segmentation summary data 37, and/or segmentation tags 35, according to one or more embodiments. Although not shown in FIG. 1B, it is also possible to create a temporal vector (e.g., a temporal vector 48, not shown) that can incorporate the segmentation range data 32 and/or describe some quality with which the events 96 grouped within segmentation proceed (e.g., a building of intensity).

FIG. 1B also illustrates a segmentation object 50. The segmentation object 50 is analogous to the segmentation object 30, and bears numbers corresponding to those of the segmentation object 30 plus twenty. For example, the segmentation range data 53 may be similar to the segmentation range data 32, except describing the range of the particular multimedia segmentation represented by the segmentation object 50. However, in contrast to the segmentation object 30, the event data 42 may be replaced with segmentation data 62 grouping and/or referencing one or more segmentation objects 30 through segmentation references 63. Therefore, in one or more embodiments, the segmentation object 50 may represent a “second order” or “second level” of structure within the data structure 01.

In one or more embodiments, the data structure 01 may also include a multimedia object 70 representing and/or modeling the multimedia file 610. The multimedia object 70 may include a multimedia UID 71, a multimedia file reference 72 (e.g., an attribute storing the value of the a UID 611 of the multimedia file 610), a multimedia data 74 that may comprise multimedia tags 75, a multimedia description data 76, and/or a multimedia summary data 77. These attributes may store descriptive data similarly to analogous attributes of the segmentation object 30 and the event object 10, but with respect to the entire multimedia file 610. For example, the multimedia description data 76 may describe the overall narrative story in one or a few succinct paragraphs, and the multimedia tags 75 may describe the genre (e.g., western, drama), type, style, or other overall qualities of a narrative within the multimedia file 610.

In addition, the multimedia may have existing associated audio, referred to as the audio data 78. For example, the audio data 78 may include audio recorded contemporaneously with the multimedia, previous attempts at audio enhancement, film production commentary (e.g., directors notes), and/or other associated audio. Each audio data 78 may include an audio description 79 describing the audio, an audio summary data 80, and/or audio tags 81, each of which may be automatically or manually generated. In one or more embodiments, these audio channels may be treated as their own form of multimedia on which the embodiments herein employed, which may then be considered alone or in combination with the visual portion of the multimedia.

The multimedia object 70 may further include a segmentation structure data 82 drawing database references to one or more multimedia segmentation objects 50 through one or more segmentation references 83. In one or more embodiments, this may establish a third level or third order of structure. The video object 170 may also include encoding vectors 86. The encoding vectors 86 may incorporate and/or embedding data from the multimedia description data 76, the multimedia summary data 77, and/or the multimedia tags 75, according to one or more embodiments.

The data structure 01 will now be described as an instantiation for video and/or film. The multimedia object 70 may instantiated as a video object 170 representing a multimedia file 610 that is a video file 620; the segmentation object 50 may be instantiated as a scene object 150 representing scenes 94 within the film; the segmentation object 30 may be instantiated as a shot object 130 represent shots within the film; and the event objects 10 may be event objects 110 representing events 96 within the film. In the present example: an “event” may include an action and/or a state of being depicted in the video; A “shot” may include a continuous recording from a single camera perspective; and a “scene” may include a series of one or more shots 95 depicting events 96 closely interrelated in time and which may take place within the same setting or environment.

In FIG. 1B, shown above the example data structure 01 that has been instantiated for video, a graphical representation of the video segmentation and events is illustrated. The video file 620 may include one or more scenes 94. Each scene 94 may include one or more shots 95. Each shot 95 may include one or more images 93 (e.g., frames) and/or may be associated with one or more events 96. The events 96 can include a recurring event 97, such as a background noise or continuous process predicted or implied throughout an extended period of time (such as the scene 94 or several shots 95). The events 96 can also include a temporal event that lasts one or more seconds, and which may have varying quality (e.g., an ambulance arriving and departing). The events 96 can also include an instantaneous event 99, which may be relatively fast or abrupt (e.g., a sound of two objects colliding, an explosion, a grunt, a short animal call, etc.).

In particular, the top of FIG. 1B depicts an action sequence of a film is shown. In this example and others herein, a particular numbering scheme is adopted to demonstrate relations within the data structure 01. Specifically, a number represents the type of element (e.g., the scene 94), a first letter represents a first segmentation (e.g., the scene 94B which may be the second scene 94 within the film), a third number past a first decimal point represents a second segmentation (e.g., the shot 95B.1 is the first shot 95 of the second scene 94), and a third number representing an event (e.g., the event 96B.2.1 is the first event 96 of the second shot 95B.2 of the second scene 94B). It will be noted that some event objects 10 may span and/or may be associated with one or more segmentation objects 30, for example where the temporal event 98B.1.3 occurs in both the shot 95B.1 and the shot 95B.2.

In the present example, shot 95.1B depicts a first person shouting to a second person who is off-screen. In the background of the shot shot 95.B.1, a fan is continuously spinning. Because the fan continues to spin for the entire scene 94 (or is assumed to spin while off screen due to its prevalence in many shots 95), a recurring event 97B.1.1 may be defined. Next, the first person who is shouting may define the temporal event 98B.1.2. Moments later (e.g., a several frames later, ten frames later assuming sixty frames per second, etc.), the second person may enter the shot 95.1, and an instantaneous event 99B.1.3 may be defined in which the first person punches the second person. The shot 95B.2 may then switch to a camera angle behind the second person, who may be reeling and falling backwards toward the camera. Between the second person and the camera may be a glass window. Within the same shot 95B.2, the second person may then fall through the window, shattering it. The shattering window may be the instantaneous event 99B.2.1. The frame may then be devoid of the second person who has fallen out of the shot 95B.2 now only showing the first person and the fan continuing to spin. After recognizing, bounding, and describing each of the events, audio may be sourced, selected, editing, adjusting, and mixed, including for the spinning background fan represented by the recurring event 96B.1.1, the prolonged shouting represented by the temporal vent 98B.1.2, the punch contact represented by instantaneous event 99.B1.3, and the breaking glass represented by the instantaneous event 99B.2.1.

Returning to the data structure 01 of FIG. 1B, it will be evident to one skilled in the art that each of the attributes and values have been adapted for use with video and film. For example, the time range 113 may specify the start and end time for the event 96 within the film; the shot range data 133 may specify the time range of the shot within the film; and the time range 153 may represent the time range of the scene within the film.

The data structure 01 and objects and data thereof may be stored in one or more commercial databases and/or implemented in any of one or more data formats. For example, the data objects may be stored as relational data objects within a relational database and/or non-relational objects within a NoSQL database, for example a columnar format (e.g., Casandra®), in a document format (e.g., MongoDB®), in a graph data structure (e.g., Neo4j®), and/or in a key-value store (e.g., Redis®). In one or more embodiments, the data structure 01 may be stored, accessed, extracted, and/or transmitted as a JSON object.

FIG. 1C illustrates the data structure 01 of FIG. 1B, further illustrating multiple instances of each type of data object as nodes 02 of the data structure 01, including event objects 10 (instantiated as the event objects 110 for video), segmentation objects 30 (instantiated as the shot objects 130), segmentation objects 50 (instantiated as the scene object 150), and multimedia object 70 (instantiated as the video object 170). It should be noted that while directional arrows are shown, any such arrows may also represent bi-directional database references that can be traversed in either direction. For example, although FIG. 1B illustrates the event data 42 comprising event references 43 to event object 10, the event object may also include references to the segmentation object 30. This may allow for fast traversal up to the segmentation object 30 upon query to the event object 10, for example as shown in the present embodiment and described widely throughout the embodiments herein.

Each of the data objects, e.g., the nodes 02, may be associated through one or more database relations 03. For example, the video object 170 may reference the scene object 150A through a scene reference 183A, as shown and described in conjunction with the embodiment of FIG. 1B. In addition, FIG. 1C illustrates relations between and among event objects 110, e.g., implemented with one or more event references 123 as shown in FIG. 1B. The relations between and among event objects 110 may represent associations between and among events 96. For example, the event 110B.2.2 may be an associated event 29 of the event 110B.3.1, and vice versa.

The data structure 01 may include a root 89, which may be the highest order of organization and/or may represent the multimedia to be audio enhanced. Although the data structure 01 may have a general hierarchical organization, it should be noted that, in one or more embodiments, a particular node 02 may be referenced by two additional nodes 02 of an organizational level above the particular node 02. For example, the event object 110B.1.0 is shown being referenced by each shot object 130B (the shot object 130B.1 through the shot object 130B.n). Therefore, the shot object B.1.0 may occur in all shot objects 130B within the scene 150B. Such an event 96 may, for example, represent an environmental or persistent sound (e.g., a recurring event 97). In other cases, event object 10 may only be associated with the first segmentation object 30 in which it occurs, even if its duration extends into other segmentations.

FIG. 1C further illustrates traversal of the data structure 01 to perform one or more purposes described herein, including for example retrieving data from an event object 10, finding related event objects 10 that relate to a selected event object 10, determining overlap in events 96, determining priority among related or global events, and/or gathering descriptive and temporal context. In one or more embodiments easily, gathering descriptive and/or temporal context is one of the advantages of the data structure 01 and its use, enabling more diverse and accurate matching and/or generation of audio due to the richness of description on various structural levels and implicit and explicit relations within that structure.

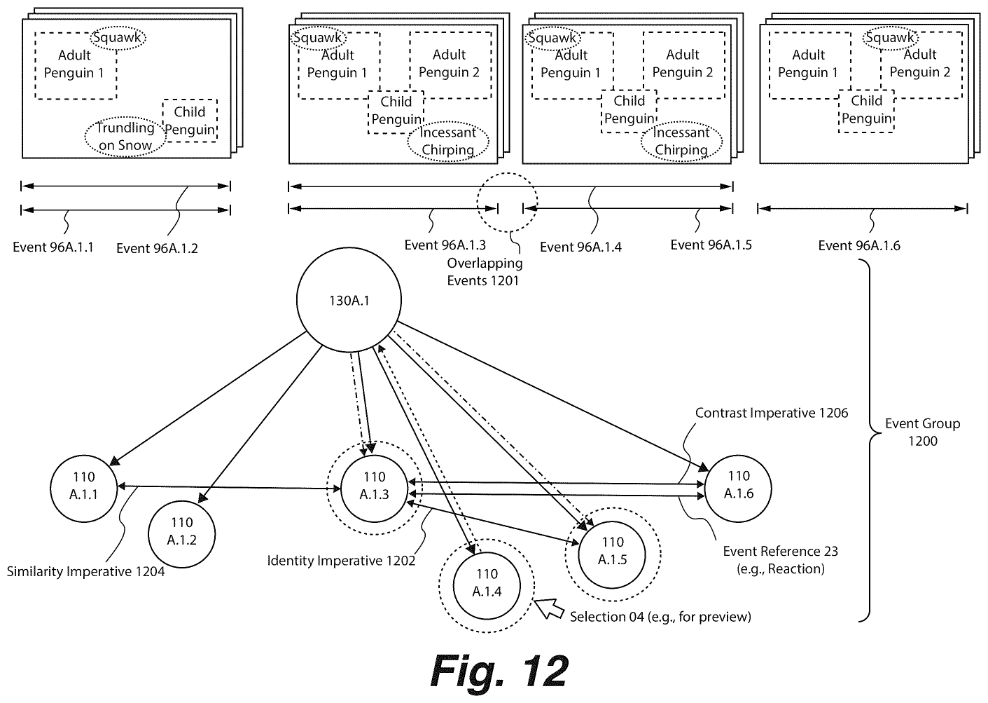

An example of traversal of the data structure 01 will now be described. A selection 04 may occur of an event object 110B.2.2. For example, an automated process may be cycling through each of the event objects 110 to match or generate audio. Conversely, the user 103 may be requesting that audio is matched or generated for the event object 110B.2.2. Database relations for the event object 110B.2.2 may be traversed (e.g., event references 123) to the event object 110B.2.1 and the event object 110B.3.1. In one or more embodiments, a database relation 03 may be traversed up to the shot object 130B.2. Alternatively, the shot object 130B.2 may be otherwise determined to be the grouping and/or embracing segmentation object 30). Additional related or proximate events can then be determined through traversal down to the event object 110B.1.2 and the event object 110B.1.0. This traversal can be useful for determining priority for nearby event objects 110, and/or to gather imperative references, as further shown and described in conjunction with the embodiments of FIG. 12 and FIG. 13. The database relations 03 can be further followed and/or embracing any nodes 02 determined. This process can be repeated until reaching the root 89 of the data structure 01, which in this example is the video object 170.

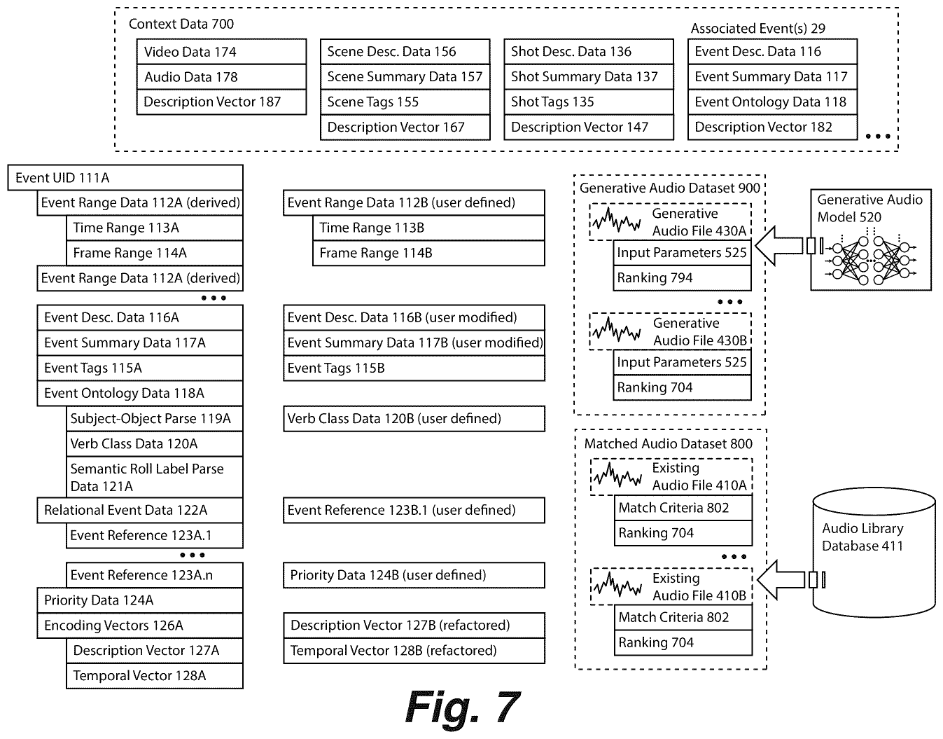

The traversal pattern may vary depending on the needed context. Sometimes, only limited or “local” context may be needed. For example, for purposes of determining audio priority during mixing, immediate event objects 110 surrounding and/or overlapping the selection 04 may be required, which may be determined by traversal up to the immediately grouping shot object 130 and back down to any embraced event objects 110. Other needs for context may be more extensive. For instance, a context data 700 may be assembled by extracting descriptive and/or temporal data in each increasing level of organization and any associated events 29, as shown and described in conjunction with the embodiment of FIG. 7. The context may expand even further under certain conditions, such as upon detecting any imperative relations, e.g., as shown and described in conjunction with the embodiment of FIG. 13.

As just one example of useful context that can be determined from the data structure 01, FIG. 1C illustrates each of the possible sets of descriptive or temporal data extracted from each type of node 02. Some or all of this data can be added to the context data 700. Each attribute-value pair can also be associated with a context weight 702 to control the influence that pair has on audio matching and/or generation, as shown and described in conjunction with the embodiment of FIG. 7.

In one or more embodiments, the data structure 01 may include a video object 170 associated with a video file 620 and, a plurality of database references 02 drawn to a set of two or more event objects 110 modeling events 96 within the video file 620. The plurality of database relations 03 may be drawn to the event objects 110 (i) directly from the video object 170 and/or (ii) indirectly from the video object 170 through one or more segmentation objects 30 and/or segmentation objects 50 (e.g., the shot object 130, the scene object 150). It therefore should be evidence that database relations 03 can “jump over” or skip levels of organization in the data structure 01. As just one example, such references jumping over one or more levels of structural organization could be useful where key plot elements or story elements need to be referenced directly by the video object 170 (e.g., “crossing the threshold”, “moment of reveal, “nadir”, etc.). This can help further call out audio to be emphasized, specialized, or take on certain qualities to reinforce the story element. The data structure 01 may also include a plurality of database relations 03 drawn to two or more audio files 405 associated with each of the two or more event objects 110, for generating audio matching an event 96 modeled by each of the two or more event objects 110.

Each of the servers of the multimedia audio enhancement network 100 will now be described. Although the multimedia audio enhancement network 100 and servers thereof illustrate one possible allocation of computing elements (e.g., engines, applications, routine, subroutines, databases, modules, agents and other software), it will be evident to one skilled in the art of computing programing, software development, and/or software engineering that such computing elements may be grouped or allocated in various servers, physical or virtual, including as a single server or device. As just one example, although FIG. 1 shows the event structure server 300 as storing the event structure database 304, the event structure database 304 also or alternatively may be stored on the enhancement server 200. In another example, the engines, routines, modules, subroutines, and agents shown in one or more servers herein may be deployed locally on the client device 102, and/or include client-side components that effect some or all of the processes otherwise shown and described herein on servers. Similarly, all audio libraries (e.g., the audio library 411 and/or the generative library 431) and multimedia files (e.g., within the multimedia database 603) may be stored together on the same server and/or within the same content delivery network (CDN). Conversely, the computing components may be dispersed or allocated among additional instances of a server. For example, there may be multiple instances of the audio servers 400, including some controlled by third party licensees and/or rights management organizations which may provide authenticated and controlled API access.

Throughout the present embodiments, the term “model” is used. Unless context requires otherwise, the model refers to a machine learning model trained with training data to receive an input data, process the input data, and then generate an output data. Models may be general (e.g., a general purpose large language model, or LLM), may be general but have additional access to data assisting in specializing its response (e.g., an LLM with access to a retrieval augmented generation file, or RAG), and/or may be specialized (e.g., an LLM trained on and/or fine tuned with training data particular to the inputs). In one or more embodiments, the model may be an artificial neural network having nodes and node weights, a deep learning model, and/or a transformer model. For example, the model may include one or more artificial neuron neural networks, recurrent neural nets, convolutional neural networks, and/or multi-layered perceptrons. The model may also include traditional machine learning techniques, such as support vector machines (SVM) and/or Markov-chains.

Additionally, one or more of the present embodiments may involve allocating inputs between models, selecting models for use, and/or moving outputs from one model to another mode, as further shown and described herein. In addition, training data, including that generated as a result of the user 103 engaging in editing of the data structure 01, modification to the data structure 01, and/or mixing of selected or generated audio may be used to increase the effectiveness of one or more models through additional RAG, training, fine tuning, and/or other techniques known in the art of machine learning.

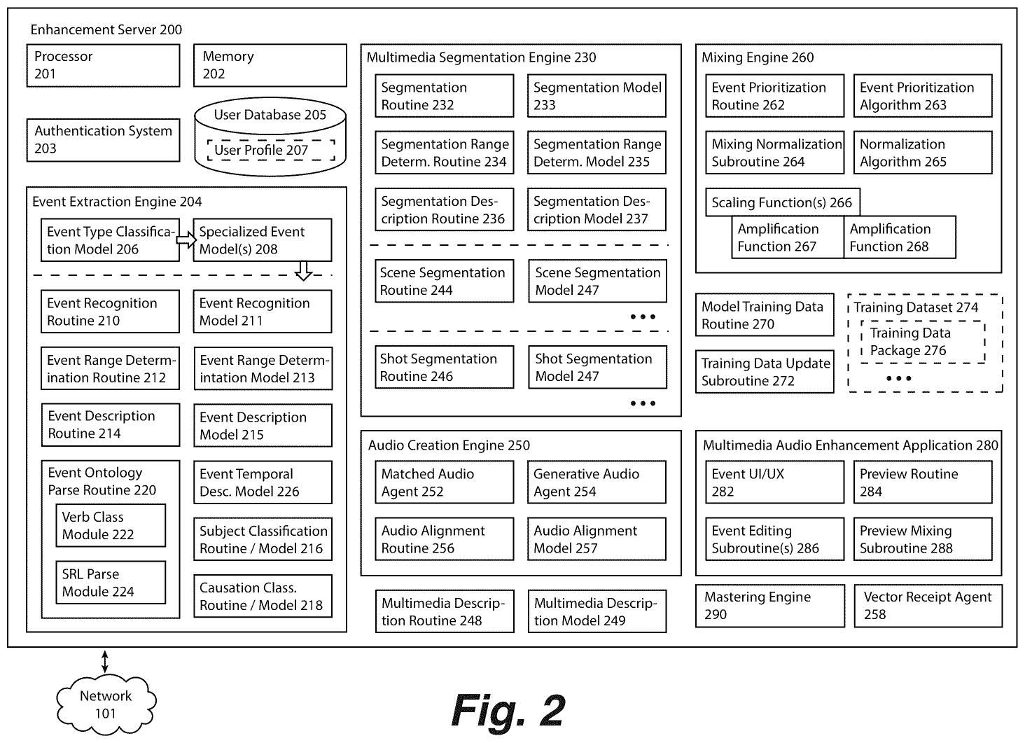

FIG. 2 illustrates an enhancement server 200, according to one or more embodiments. The enhancement server 200 includes one or more processors 201 that are computer processors and one or more instances of memory 202 that are physical, non-transitory computer readable memory. The enhancement server 200 may further include a user database 205 comprising a set of user profiles 207 for each user 103, along with access permissions and/or file ownership designations. An authentication system 203 for authenticating associated users 103 and/or client devices 102, as known in the art.

In one or more embodiments, the enhancement server 200 may include an event extraction engine 204 configured to recognize, bound, and/or describe one or more events 96 within a multimedia file 610. For example, the event extraction engine may effect an automated process which inputs a video file 620, performs computation on the video, and produces an output including information in a structured format (e.g., the event object 110) which represents a homodiegetic event depicted in the video file 620, according to one or more embodiments. In one or more embodiments, the event extraction engine 204 may include computer readable instructions that when executed parse the multimedia file 610 (such as the video file 620) to extract one or more events 96 that include an action and/or a state of being depicted in the multimedia file 610, according to one or more embodiments.

In one or more embodiments, an event type classification routine 206 may initially recognize and/or classify types of events 96, which may be particularly suited to certain routines and/or models for further recognition, bounding, and/or description. In the example of video multimedia, certain types of events may be recognized based on the subject (actions of a human), the background (e.g., environment or scene background), and/or certain specialized events (e.g., explosions). In one or more other embodiments, event length may be a classifiable differentiator shunting an input to a particular model. For example, events 96 could be classified as instantaneous, temporal, or recurring, for example as shown and described in conjunction with the embodiment of FIG. 1B. Depending on characterization, a portion of the multimedia file 610 (e.g., a video clip of the video file 620) may be forwarded to one or more specialized event models 208, which may be applied to recognize, bound, segment, and/or describe the event 96. Models may be employed specifically for this characterization. However, in one or more embodiments, generalized models may be applied to all or a portion of the multimedia file 610.

Each of several possible routines and models of the event extraction engine 204 will now be described. Such routines and models may be generalized to address any kind of event, or may be specialized to focus on certain types of event.

An event recognition routine 210 may be configured to recognize one or more events 96 within the multimedia file 610, for example events 96 within the video file 620. In one or more embodiments, the event recognition routine 210 may use an event recognition model 211, which may be trained to recognize events 96 within the multimedia file 610 through training data associating the raw data of the event 96 (e.g., sequential images of a video showing the event in video) with a market of the event. The training data (e.g., the training dataset 274) may be used in a supervised machine learning process to train the event recognition model 211.

The event range determination routine 212 may be configured to bound and/or determine a range for the event 96 within the multimedia file 610, according to one or more embodiments. In one or more embodiments, the event range determination routine 212 may include computer readable instructions that when executed determine an event range data 12 including a time range 13 of the event 96 or a frame range 14 of the event 96. Different types of extent of the event 96 also may be required depending on the particular multimedia file 610 (e.g., one or more sentences or clauses for an event occurring within narrative text, which may be designated with a starting and ending character number or other identifiers). In one or more embodiments, the event range determination routine 212 may call the event range determination model 213 to bound the event 96.

It should be noted that, in one or more embodiments, the event recognition model 211 and/or the event range determination model 213 may be combined. For example, and depending on the training data or augmentation dataset used, the event recognition model 211 may automatically bound the event 96 resulting in the event range data 12. However, in one or more embodiments, an event 96 may first be recognized within a general area or portion of the multimedia file 610, then that portion (and optional expanded context) submitted for refined boundary determination, e.g., by the event range determination model 213. This can represent a chained model use resulting in higher quality bounding and therefore audio alignment, possibly saving substantial time, according to one or more embodiments.

In one or more embodiments, the event extraction engine 204 may include an event description routine 214 configured to describe (e.g., with codes, functions, classifications, and/or natural language that may be human readable), the event 96 bounded by the event range data 12. Depending on the length or extent of the event range data 12, different instances of the event description model 215 may be used, e.g., one for environmental/background sound within a scene 94 and one for instantaneous sound effects within a scene 94. This may result in a more accurate, and/or vivid description of the relative event 96 by specializing each model. For example, better results may be achieved where a training dataset focuses on diverse and accurate background sounds for a scene, rather than also trying to model acute sounds that must perfectly align with visual cues. This in turn may help in matching and/or generation of audio to meet different purposes. For instance, one model may specialize in creating atmosphere of a scene that supports the mood, theme, and setting of the story but is not a distraction, while another model may specialize in foreground events that directly tell the story.

In one or more embodiments, the event description routine 214 may further include computer readable instructions that when executed generate an event summary data 17 and/or assign one or more event tags 15. As one example, the event summary data 17 may be generated by inputting the event description data 16 into an LLM with an instruction to condense or label the event; the event tags 15 may be assigned or generated by effecting a natural language search or LLM matching instruction to an array of predefined tags and/or database of existing tags. If none appear applicable or do not match with high confidence, a new tag may also be created.

The event extraction engine 204 may include an event ontology parse routine 220, which may include or access via API a verb class module 222, an SRL parse module 224, a simple subject-object parse module, and/or other ontological parsing modules that specify a framework for events and describe the event or semantics of the event within that framework, as currently known in the art or later developed. In one or more embodiments, the event ontology parse routine 220 may include computer readable instructions that when executed input a portion of the multimedia file 610 specified by the event range data 12 into an event ontology determination module, for example the verb class module 222 and/or the SRL parse module 224. An event ontology data 18 may then be returned, including a verb class data 20 and/or a semantic roll label data 21, according to one or more embodiments. As just a couple examples, TimeML™ and FrameNet™ may be commonly used models and ontologies for representing the semantics of events 96, and which may additionally include event timing that may be used as, along with, or in place of, the event range data 12. As each event 96 is recognized, bounded, and/or described, such data may be forwarded to the object assembly routine 306 (e.g., optionally stored on the event structure server 300) such that a corresponding portion of the data structure 01 may be assembled, as shown and described in conjunction with the embodiment of FIG. 3.

In one or more embodiments, the event extraction engine 204 may further include a subject classification routine 216 (and/or a subject classification model 217, not shown), which may recognize a subject within the multimedia file 610. This subject may be overlapping with or distinct from the event ontology (which may include the concept of a subject within the semantics of certain ontologies). However, in one or more embodiments, distinct identification of the subject may be beneficial, including gathering context for sound matching generation. For example, it may be advantageous to ensure the same subject consistently makes the same type of sound. Distinct subject identification also may be useful in assigning priority of audio during mixing (e.g., amplifying audio of a subject while attenuating or dampening competing audio). In one or more embodiments, the subject classification routine 216 may include computer readable instructions that when executed classify a subject of the event 96A and/or an action of the event 96A, such that it can be compared to a different subject of the different event 96B and/or a different action of the different event 96B. Additional rules that relate to subject or action prioritization can be applied, e.g., to help properly mix audio as described herein.

In one or more embodiments, the causation classification routine 218 (and/or causation classification model 219, not shown) may include computer readable instructions that when executed classify a causal relation between two or more events 96, for example determining a subject has affected an object. The input to the causation classification model 219 may include outputs of any of the other routines and/or models of the event extraction engine 204, such as event range data 12, event description data 16, an identified subject, an identified object, the event ontology data 18, etc.

In one or more embodiments, an event temporal description model 226 may determine one or more temporal characteristics of the event 96. This can be contrasted with event range data 12. For example, while the event range determination routine 212 can determine a boundary for an event 96 such as an unsheathing of a samurai sword, the temporal description may provide more detailed information. For example, the temporal description may describe that the sword begins to be slowly drawn from a scabbard for a few seconds, then is quickly pulled free. As a result, audio with a low volume and low tone may abruptly transition to a high volume and high tone, where the sword may even continue to emanate ringing in the hand of the bearer. The temporal data (and/or an event temporal vector 28 encoding such data) may describe this transition in data, including tabulations associating extent values with time values, perceived accelerations, and/or other characteristics. In one or more embodiments, and in contrast to some embodiments of the event description data 16, the temporal description data 25 may be mathematically specified, for example a series of timestamps each with an associated intensity that can be applied to the waveform of the audio selected for the event 96.

In one or more embodiments, the event objects 10 may be stored independently and/or within a single file without further structure, or with references between or among the event objects 10 specifying various relations. However, in one or more other embodiments, the multimedia file 610 may be segmented and the events 96 associated with each segmentation. The number and type of segmentations can be flexibly and arbitrarily defined. For example, for narrative text, the segmentation may be structural (e.g., chapters, pages, paragraphs, sentences) and/or narrative (acts, story structure elements, hero's journey stages, etc.). Segmentation may also vary based on the length or other characteristic of the multimedia file 610. For example, for a video file 620 created by an influence with a single scene 94 and single shot 95 (e.g., generated by a smartphone being held by the user 103), the data structure 01 may only need to include two levels of organization. In that case, the video object 170 may draw database relations 03 to a set of event objects 10. It will be recognized that segmentation may occur before, after, or concurrently with the designation of event objects 10.

Additional relationships also may be determined and designated by the event extraction engine 204, for example recognizing one or more imperative relations. In one or more embodiments, an identical subject or object may be identified across multiple events 96, in which case an identity imperative 1202 can be defined between two or more event objects 10, as shown and described in conjunction with the embodiment of FIG. 13.

In one or more embodiments, a multimedia segmentation engine 230 may be configured to recognize, bound, and/or describe one or more multimedia segmentations. A segmentation routine 232 may include computer readable instructions that when executed recognize, bound, and/or describe one or more segmentations within the multimedia file 610. Where one or more segmentation models are used, the segmentations may be untrained (e.g., recognizing and grouping commonality in certain portions of the multimedia file 610), or, in one or more preferred embodiments, trained and guided to recognize specific segmentations that best model the multimedia (e.g., the scene 94 and the shot 95 in the case of film).

In one or more embodiments, a segmentation routine 232 may include computer readable instructions that when executed recognize a multimedia segmentation within the multimedia file 610. The segmentation model 233 may include a model trained to recognize one or more segmentations of the multimedia file 610 based on training data that includes exemplars of the segmentation. For example, for narrative text, the training data may include chapters or narrative elements that are identified. For a podcast, training data for segmentations could include an introduction portion (e.g., intro music, introductions, and pre-topic banter) and an exit portion of a podcast (e.g., outro music, salutations, next topic preview, and post-topic jokes). Segmentation of video is further described below in conjunction with the scene segmentation routine 244 and the shot segmentation routine 246, which may be instantiations of the segmentation routine 232. Similarly, the scene segmentation model 245 and the shot segmentation model 247 may be instantiations of the segmentation model 233, according to one or more embodiments.

A segmentation range determination routine 234 may be configured to bound the segmentation within the multimedia file 610, for example by defining a segmentation range data 32 and/or a segmentation range data 52, depending on a level or order of segmentation. Similarly, the segmentation range determination model 235 may be trained to recognize and bound the segmentation, including with possible input that was produced by the segmentation routine 232 and/or segmentation model 233. The event segmentation model 233 and the segmentation range determination model 235 may be discrete or combined models. For example, in one or more embodiments, segmentation may inherently include bounding.

The segmentation description routine 236 may be configured to describe the segmentation. In one or more embodiments, the segmentation description model 237 may receive a portion of the multimedia file 610 corresponding to the segmentation range data 52 and determine descriptive text that describes the segmentation, for example the segmentation tag 35, the segmentation description data 36, the segmentation summary data 37, the segmentation tag 55, the segmentation description data 56, and/or the segmentation summary data 57. As one example, the segmentation summary data 37 may be generated by inputting the segmentation description data 36 into an LLM with an instruction to condense or label the description; the segmentation tags 35 may be assigned or generated by effecting a natural language search or LLM matching instruction to an array of tags and/or database of existing tags, or, if none appear applicable or matched with high confidence, create a new tag.

Instantiations of the elements of the multimedia segmentation engine 230 will now be described for the case of video. In one or more embodiments, a scene segmentation routine 244 may include computer readable instructions that when executed parse a video file 620 to determine that a scene 94 is present (e.g., recognize a scene 94). A scene range determination routine (e.g., an instantiation of the segmentation range determination routine 234) may include computer readable instructions that when executed determine a scene range 152 including at least one of a time range 153 of the scene 94 and/or a frame range 154 of the scene 94. In one or more embodiments, a portion of the video file 620 specified by the scene range 152 may be input into an event description model (e.g., an instantiation of the segmentation description model 237) which may output a scene description data 156 and/or a scene summary data 157. In one or more embodiments, extraction of the data for a scene 94 (e.g., to populate and define a scene object 150) may include recognition of similar graphical data between frames (e.g., images 93) within a time horizon of the video file 620. This visual recognition may be trained into the scene segmentation model 245 with supervised machine learning techniques, for example using training data of video with demarcated scenes 94. For example, a scene 94 may occur in one setting, resulting in similar environment, lighting, characters, and other visual elements that can be grouped and temporally bounded.

Shot segmentation may be similar to scene segmentation, but at a reduced time scale. For example, the shot segmentation routine 246 may be configured to parse the video file 620 to recognize and/or extract data of a shot 95 from the video file 620, including through use of a training shot segmentation model 247. In one or more embodiments, a shot range determination routine (e.g., an instantiation of the segmentation range determination routine 234 for shots 95 in film) may include computer readable instructions that when executed determine a shot range data 132 comprising a time range 133 of the shot 95 and/or a frame range 134 of the shot 95. The shot range determination model 235 may be trained to bound the shot 95 and/or to output the shot range data 132. In one or more embodiments, recognition of a shot 95 may include training for recognition of low relative variation in graphical data between frames within a time horizon of the shot 95. Relative to a scene 94, this recognition may have a reduced tolerance for background variation. For example, relatively slow variation in visual elements, such as zooming or panning of the camera over several seconds, may still be recognized as a stable transition within the same shot 95. In contrast, an instant change in a majority of color values may indicate a change in shot 95 (e.g., a different camera angle).

Similar to receiving at least one of a scene description data 156 and a scene summary data 157, a shot description routine (e.g., an instantiation of the segmentation description routine 236) and/or a shot description model (e.g., an instantiation of the segmentation description model 237) may be used to generate shot tags 135, a shot description data 136, and/or a shot summary data 137.

In one or more embodiments, the multimedia file 610 itself may be described, for example to generate the multimedia data 74 such as the multimedia tags 75, the multimedia description data 76, and/or the multimedia summary data 77 (e.g., in the example of video, the video data 174, the video tags 175, the video description data 176, and/or the video summary data 177). The tags, description, and/or summary of the multimedia may be generated by a multimedia description routine 248 and/or a multimedia description model 249, which may operate similarly to the segmentation description routine 236 and/or the segmentation description model 237, but applied to the entirety or relevant majority of the multimedia file 610 (e.g., some parts may be naturally excluded, such as credits that are already incorporated into the video, a table of contents in a book, interstitial advertisements in a podcast, etc.). In one or more other embodiments, the video data 174 may be a synthesis (including LLM summary) of each of the descriptions of each segmentation. For example, the video description model 239 may include an LLM that receives as input each of the scene description data 156 and generates a description of the narrative therefrom. It should be noted that a similar process may be arbitrarily followed for any level or order of organization, with a higher level may use a condensed portion of the descriptive data of a lower level within to generate description or summary data.

Segmentation data extracted from the multimedia segmentation engine 230, and/or the multimedia description routine 248 or multimedia description model 249, may be transmitted to the object assembly routine 306 for assembly of segmentation objects (e.g., the segmentations objects 30, the segmentation object 50), and/or the multimedia object 70.

Following description of the multimedia file 610, along with recognition, bounding, description, and/or extraction of each of its segmentations and events 96, the multimedia file 610 may be enhanced with audio for the event object 10. In one or more embodiments, the audio enhancement may take place automatically and/or initially automatically with additional possible editing and adjustment from the user 103.

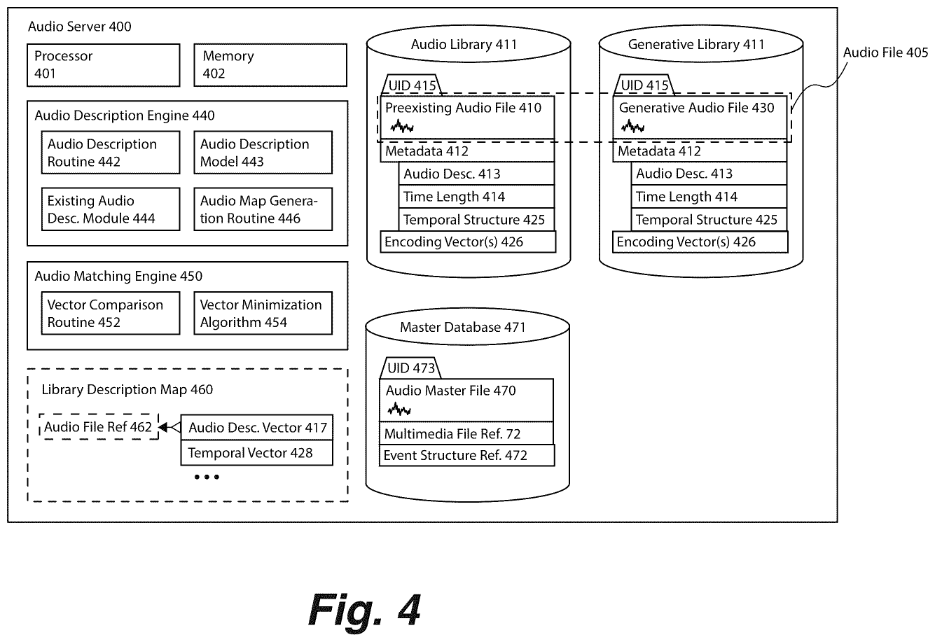

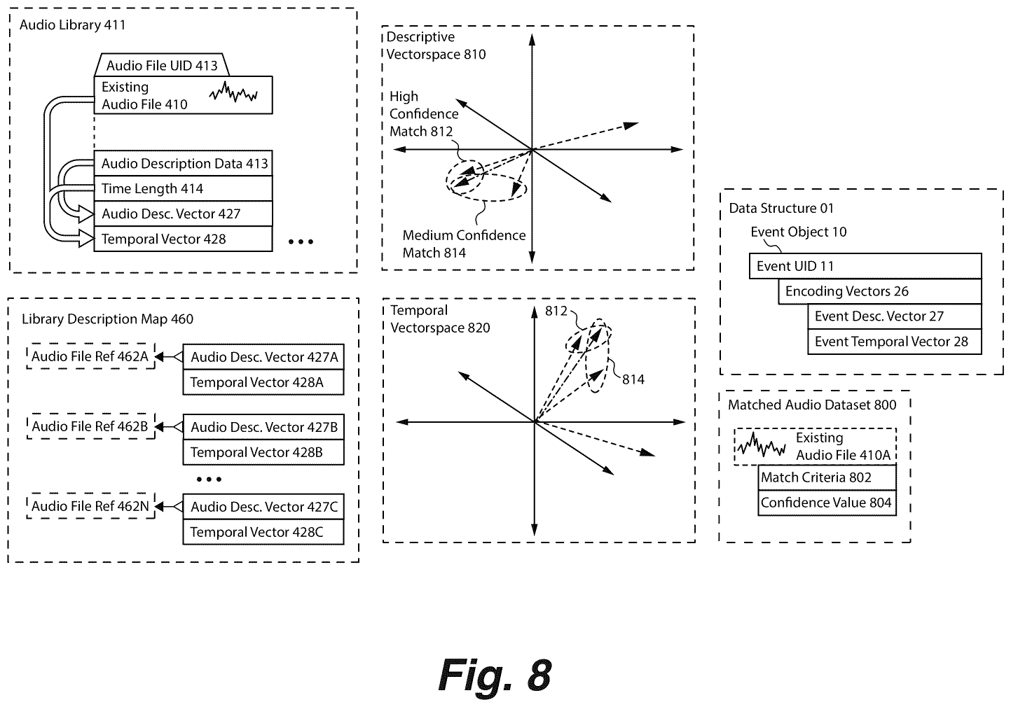

In one or more embodiments, the enhancement server 200 may include an audio creation routine 250 which may initiate matching and/or generation of audio for event objects 10 within the data structure 01, according to one or more embodiments. Specifically, the nodes 02 include a matched audio agent 252 may include computer readable instructions that when executed initiate and/or generates a remote procedure call for audio (e.g., existing audio from an audio library 411) to be matched to one or more event objects 10, for example querying and extracting data from the data structure 01 (including optionally assembling the context data 700 therefrom) to be used in efficient matching, as further shown and described in conjunction with the embodiment of FIG. 4 and FIG. 8.

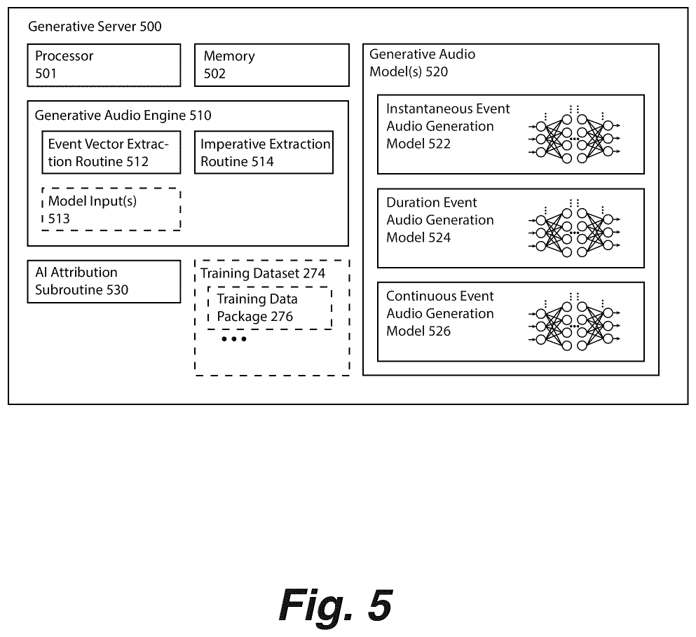

The generative audio agent 254 may include computer readable instructions that when executed initiate and/or generate a remote procedure call for audio to be generated and/or generatively synthesized by one or more generative audio models 520, according to one or more embodiments. The generative audio agent 254 may query and extract data from the data structure 01 to be used as a model input, as further shown and described in conjunction with the embodiment of FIG. 5, FIG. 9, and FIG. 10.

After receiving an existing audio file 410 matched to an event object 10, and/or receiving a generative audio file 430 generated for the event object 10, the existing audio file 410 and/or the generative audio file 430 may be aligned with the event 96 modeled by the event object 10. For example, a closest matching existing audio file 410 may not exactly fit the time range 13, e.g., may be too long or too short in duration. In one or more embodiments, the audio alignment routine 256 may include computer readable instructions that when executed move the audio file 405 and/or the generative audio file 430 within the boundaries of the event range data 12, apply one or more transformations to shorten or lengthen a playtime of the generative audio file 430 to match the event range data 12 (e.g., with an optional pitch to counteract an effect of stretching or condensing waveforms), and/or carry out additional alignment operations.

In one or more embodiments, the audio alignment routine 256 may align not just based upon duration of the audio and the event range data 12, but also alignment of the temporal description of each. Returning to the example of an event object 10 modeling an ambulance driving through a shot 95 in a film, a temporal description of the off-screen arrival, on-screen presence, and off-screen departure may be similarly aligned with a temporal description of the audio file 405 and/or the generative audio file 430 in which the ambulance tone is at first blue shifted and increasing in amplitude as it approaches off-screen, then present and unshifted when on screen, and then red shifted and decreasing in amplitude after moving off-screen.

It should be noted that, in one or more embodiments, the audio file 405 may be relatively closely aligned directly from matching, especially if the audio library 411 is relatively large, and/or multiple audio libraries 411 are matched against. Similarly, an instruction and/or input argument of the generative audio model 520 may include the exact duration or temporal description, resulting in a relatively good, or sometimes almost perfect, alignment of the generative audio file 430. An advantage of one or more of the present embodiments for matching audio and/or generating audio can include a close initial alignment due in part to descriptions within the event object 10 and/or requirements imposed on matching or the generative audio model 520.

In one or more embodiments, an audio alignment model 257 may be trained to align audio with events. For example, the model may be trained to receive inputs that include the event range data 12, an associated portion of the multimedia file 610, a temporal description of the event 96 (including optionally an event temporal vector 28), and/or the audio file 405. The audio alignment model 257 may then output an alignment of the audio file 405 with the multimedia file 610 (e.g., an exact time at which the audio file 405 should begin playing, which may differ from the event range data 12). This also illustrates an example of chained models herein. The output of the audio alignment model 257 may also include transformations of the audio file 405, for example lengthening, shortening, or providing non-linear expansions or contractions to help in matching the temporal description. As just one example in film, a shot 95 may include a slow-motion visual sequence of a gun firing, which may then increase to full speed just after the action of the gun cycles. A first portion of the audio file 405 of a gun firing may be stretched (and a resulting lowering of pitch unabated to reflect slow motion), whereas the second portion of the audio file 405 may be allowed to proceed at normal speed.

As shown and described further herein, including in conjunction with the multimedia audio enhancement application 280, the user 103 may edit event objects 10 and associated audio, including for example changing the event range data 12 and/or the audio alignment of an audio file 405. In one or more embodiments, the user 103 who is manually adjusting the event range data 12 may automatically initiate re-alignment. Re-bounding may even trigger re-matching of the existing audio file 410 and/or re-generation of the generative audio file 430.

Following selection or generation of audio for each of the event objects 10 within the data structure 01, the audio may be mixed according to the objective of the multimedia file 610. The enhancement server 200 may include an audio mixing engine 260 configured to mix audio, including automatically mix audio, associated with two or more events 96 or existing audio channels 622.

In one or more embodiments, an event prioritization routine 262 may be configured to set or determine priority among event objects 10 to determine an amplitude of audio (e.g., loudness of resulting sound or prevalence in mixed audio). Events 96 may be prioritized according to an event prioritization algorithm 263, which, for example, may receive descriptive data such as the subject, event description data 16, event tags 15, or other data, to assign a global priority value (e.g., relative to all events 96 in the multimedia file 610) and/or local priority value 1324 (e.g., relative to one or more other event 96 that may be within a temporal proximity threshold or are overlapping with a selected event 96). The priority values 1324 may be pre-assigned, for example as part of the event extraction process, assigned when mixed, and/or assigned as necessary upon request of the user 103. In one or more embodiments, query to any two or more event objects 10, for example a first event object 10A and the second event object 10B, can resolve a priority between or among them through a hierarchy of prioritized rules. Priority is further shown and described in conjunction with the embodiment of FIG. 13.

In one or more embodiments, the event prioritization routine 262 may include computer readable instructions that when executed determine that (i) a subject of an event object 10A is higher priority than a different subject of a different event object 10B, and/or (ii) an action of the event object 10B (e.g., identified within an ontology or SLR parse) is higher priority of a different action of the different event object 10B. The event prioritization routine 262 may include computer readable instructions that when executed write a priority value 1324A of the event 96A in the event object 10A that is greater than a priority value 1324B of the different event 96B such that an audio file 405A selected for the event 96A is signaled for amplification relative to the audio file 405B associated with the different event 96B.

In one or more embodiments, the event prioritization routine 262 may include computer readable instructions that when executed apply an event prioritization algorithm 263 that assigns, to each of two or more event objects 10, a priority value 1324 based on factors that may include a subject, the event description data 16, the event summary data 17, the event tag 15, and/or the event ontology data 18. In one or more embodiments, the event prioritization routine 262 may include computer readable instructions that when executed determine a priority value 1324A of a first event object 10A and a priority value of the second event object 10B, determine the priority value 1324A of the first event object 10A is greater than the priority value 1324B of the second event object 10B, and assign a scaling function 266 to a first waveform of a first audio file 405A and/or a second waveform of the second audio file 405B. In one or more embodiments, the scaling function 266 may include an amplification function 267 and/or an attenuation function 268, either of which may be applied to a wave form of the audio file 405.

In one or more embodiments, priority may be updated due to changes in descriptions of events 96, the addition of new concepts (e.g., a new subject being identified or manually introduced), and/or as a result of manual adjustments by the user 103. In one or more embodiments, automatic adjustment to priority values 1324 may occur as new data is added to the data structure 01.

In one or more embodiments, the audio mixing engine 260 may include computer readable instructions that when executed receive an updated priority value 1324 for an event object 10A, determine a match between the event object 10A and a different event object 10C, and propagate the updated priority value 1324 to the event object 10C. For example, the match may be determined based on: (i) traversing an event reference 23 between the first event object 10A and different event object 10C, where the event reference 23 is designated as an identity imperative 1202 or a similarity imperative 1204; (ii) a match between the event description data 16A of the first event object 10A and an event description data 16B of the different event object 10C; (iii) a match between a subject of the first event object 10A and a subject of the fourth event object 10B (e.g., the same protagonist in a film); and/or (iv) a match between an event tag 15A of the first event object 10A and an event tag 15C of the fourth event object 10C.

The mixing engine 260 may include a mixing normalization subroutine 264 configured to normalize the audio file 405 associated each event object 10 with each other event object 10, and/or each event object 10 with respect to a local grouping of each the other event objects 10. Such grouping may be determined through grouping within the data structure 01 and/or overlap in event range data 12. In one or more embodiments, the normalization subroutine 264 may include computer readable instructions that when executed normalize a waveform of each audio file 405 of the two or more audio files 405 associated with the event objects 10 of a data structure 01 with respect to each other waveform of each other audio file 405 of the two or more audio files 405 associated with the event objects 10 of the data structure 01. Normalization may occur, as known in the art, to prevent clipping and balance relative levels of loudness and quietness between audio samples. In one or more embodiments, the normalization may use a normalization algorithm 265 which may scale multiple samples linearly and/or proportionately. For example, to bring one audio file 405 under a clipping threshold may require a 5% reduction in amplitude, which then may be applied across audio files 405 for the multimedia file 610. However, in one or more embodiments, normalization may occur in proportion to, or inverse proportion to, priority value 1324, for example applying a non-linear normalization function based on the priority value 1324 of the two or more event objects 10.

In one or more embodiments, the audio mixing engine 260 may convert byte arrays into an audio file 405 (e.g., the mixed audio file 1305). For example, the javax.sound.sampled.AudioSystem.write( ) method may be used to convert byte arrays into audio files 405, which may be a library included in the java language. A final audio may then be prepared (either as a file or as a buffer or in the memory of one or more servers), and layered onto a multimedia file 630 (such as the video file 610). For example, FFMPEG may be used to layer the audio onto video file 610.

In some embodiments, one or more processes of the audio mixing engine 260 may be implemented as a neural network system that receives aligned audio files 405 and automatically mixes the audio files 405. The output of the neural network system may include the mixed audio file 1305, which then may be layered onto the original multimedia file 610 or video file 630 using FFMPEG.

The enhancement server 200 may additionally include a model training data routine 270 and/or a training data update subroutine 272, according to one or more embodiments. Various training datasets 274 may be defined to assist in training, re-training, fine-tuning, and/or providing RAG-accessible data to improve one or more of the models described herein. The training dataset 274 may include a rich dataset extracted from the multimedia file 610 and later user interactions approving, disapproving, editing, adjusting, and/or customizing the data.

As just one example of a potentially valuable training dataset 274, an edit in which the user 103 updates an event range data 12 may result in valuable training data for better event bounding, for example as may be used to train the event range determination model 213. In one or more embodiments, the model training data routine 270 may include computer readable instructions that when executed receive an updated event range data 12 for an event object 10 (e.g., specified by the user 103); extract a portion of a multimedia portion form the multimedia file 610 specified by the updated event range data 12 (e.g., a video clip from the video file 620); and generate a training data package 276 including the video clip and the updated event range data 12 the first event object 10. Computer readable instructions then may be executed to train an event range determination model 213, which may include an artificial neural network that receives as a model input 513 of the event range determination model 213 the video file 620 and outputs an event location and/or a location confidence, for example the time range 13 and a confidence value 804 that the event occurs within that time range 13.

Similar training data may be generated for improvement of the audio alignment model 257, for example when the user 103 manually adjusts and/or reviews and approves the alignment. In one or more embodiments, the model training data routine 270 may include computer readable instructions that when executed receive an updated alignment (e.g., specified by the user) for an audio file 405 of an event object 10; extract a portion of the multimedia file 610 embracing the alignment and/or corresponding to the event description data 16 (e.g., a video clip from the video file 620); and generate a training data package 276 including the video clip, the audio file 405, the audio alignment data, and optionally the event range data 12.

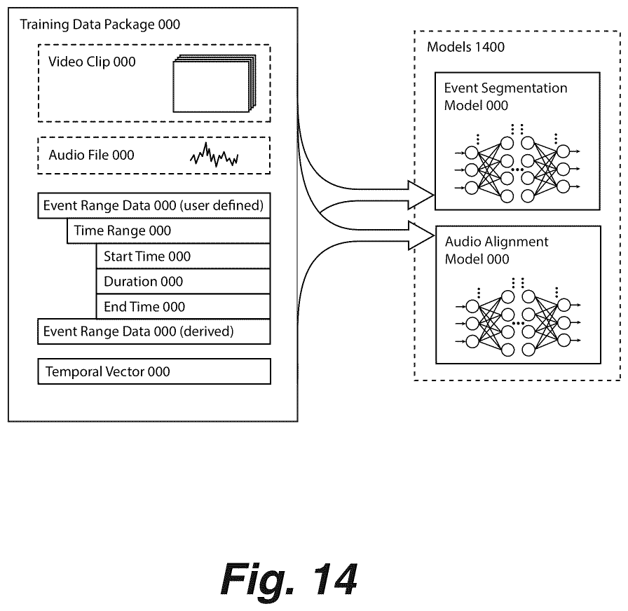

In one or more embodiments, the training dataset 274 may be updated as the user 103, or many users 103, continue to work with the data structure 01. For example, the training data update subroutine 272 may include computer readable instructions that when executed automatically override the training data package 276 following further update within the data structure 01 to copied data within the training data package, for example the event range data 12 and/or audio alignment for the first event object. Therefore, an advantage herein is that training data can be continually updated to reflect improved edits while still being available for retraining. Another example of the training dataset 273 and uses thereof is shown and described in conjunction with the embodiment of FIG. 14.

In one or more embodiments, the enhancement server 200 may include all or portions of a multimedia audio enhancement application 280 used by one or more users 103. For example, the multimedia audio enhancement application 280 shown in FIG. 2 may include back end cloud computing support for a client application running on the client device 102, and/or may be a web based or single page application hosted on the enhancement server 200 and accessed by the user 103 through a browser application on the client device 102. The multimedia audio enhancement application 280 may include an event UI/UX 282, for example as shown and described in conjunction with the embodiment of FIG. 11. The multimedia audio enhancement application 280 may also include a preview routine 284 configured to let the user 103 preview one or more event events 96 and associated selected, or generated, audio file 405.

In one or more embodiments, the preview routine 284 may include computer readable instructions that when executed receive from the user 103 a sound preview request (e.g., generated from the client device 102) for a first event object 10A that the user 103 selected (e.g., the selection 04) from the set of two or more event objects 10 (e.g., the event object 10A through the event object 10N). The preview routine 284 may include computer readable instructions that when executed query a video object 170 referencing the first event object 110, e.g., directly or indirectly through one or more nodes 02 of the data structure 01. As further shown and described in conjunction with the embodiment of FIG. 3, a reference may be traversed (e.g., from the video object 170 to a second event object 110B of the two or more event objects referenced by the video object 170). It may be determined that an event range data 112A of the first event object 110A overlaps within the video file 620 with an event range data 112B of the second event object 110A.

The preview routine 284 may include computer readable instructions that when executed load a first audio file 405A associated with the first event object 110A and a second audio file 405B associated with a second event object 110B, mixes the first audio file 405A and the second audio file 405 (e.g., in a digital to analog converter). The preview routine 284 may include computer readable instructions that when executed initiate playback of the audio file 405A of the first event object 110A and the audio file 405B of the second event object 110B overlapping the first event object 110A. In one or more embodiments, the playback may be in association with a first video clip of the video file 620 spanning a union of the event range data 112A of the first event object 110A and the event range data 112B the second event object 110B to generate a synchronized audio-visual preview of overlapping events 96. This may assist the user 103 in (i) coordinating the first audio file 405A with the video file 620, (ii) selecting a priority value for the first event object 10A associated with the video file 620, and/or (iii) selecting a different audio file 405C to replace the first audio file 405A (e.g., switching from a generative audio file 430 to an existing audio file 410, or switching between instances of the existing audio file 410).

In one or more embodiments, the multimedia enhancement application 280 may include an event editing subroutine 286, which may include computer readable instructions that when executed display data to the user 103 from the data structure 01 (e.g., the event description data 16, the segmentation range data 32, the segmentation data 62, imperative relations, etc.), and enable the user 103 to edit or modify such data, including breaking, creating, and/or rearranging database relations 03 within the data structure 01. Edited data may be destructive, for example overwriting previous data such that the original data is lost. However, as used herein, “overwriting” may also include non-destructive editing in which the new data is primarily (and by default accessed) when a query for such data is received. Data edited by the user 103 is further illustrated in the embodiment of FIG. 7.

In one or more embodiments, the event editing subroutines 286 also may be able to adjust the levels of individual audio files 405, including pitch, duration, alignment, volume, gain, compression, filtering (e.g., low pass or high pass), time stretching, pitch shifting, delay reverb, and/or other audio properties.

The enhancement server 200 may include a mastering engine 290, as may be known in the art and is commercially available. The mastering engine 290 may collect each of the mixed audio files 405 and master them into a single audio file, referred to as the master file 470, for example as shown and described in conjunction with the embodiment of FIG. 4. The master file 470 may be assigned a unique identifier 473, a multimedia file reference 72, and an event structure reference 472, e.g., a reference to the data structure 01. The master file 470 then may be ready for production use, including pairing a channel of the multimedia file 610.

The enhancement server 200 may include a vector receipt agent 258 which may call for and/or receive one or more encoding vectors from the data structure 01 for use in one or more models and/or matching. As just one example, the vector receipt agent 258 may generate a call for one or more event description vectors 27 of the event object 10 and/or the event temporal vector 28 for use in matching audio, generating audio, and/or aligning audio, according to one or more embodiments.

FIG. 3 illustrates an event structure server 300, according to one or more embodiments. The event structure server 300 includes one or more processors 301 that are computer processors and one or more instances of memory 302 that are physical, non-transitory computer readable memory.

In one or more embodiments, instances of the event data structure 01, which also may be referred to as the data structure 01, may be stored in an event structure database 304. For example, the structure 01A may be associated with a multimedia file 610A through a multimedia file reference 72A, a data structure 01B may be associated with a multimedia file 610B through a multimedia file reference 72B, etc.).

A query agent 303 may be configured to respond to queries, procedure calls and/or remote procedure calls for data from the event structure database 304, for example a query requesting data from an event object 10. In another example, the query may request data from a known number of nodes 02, for example a request to gather and assemble the context data 700 from multiple nodes 02 of the data structure 01, e.g., as shown and described in conjunction with the embodiment of FIG. 1C. The event structure server 300 may also include a database application 305, for example a commercial database management system such as MongoDB®, Aerospike®, Neo4J®, FoundationDB®, and/or Oracle®.

In one or more embodiments, an object assembly routine 306 may be configured to receive descriptive and structural data for extracted events, segmentations, and/or multimedia and define data objects with that descriptive and structural data (including a node 02 for each data object within the data structure 01).

In one or more embodiments, a multimedia object assembly subroutine 312 may be configured to assemble the multimedia object 70 from descriptive data of the multimedia. For example, in one or more embodiments, the multimedia object assembly subroutine 312 may include computer readable instructions that when executed (i) initiate a multimedia object 70 in a database (e.g., the event structure database 304) stored in one or more non-transitory computer readable memories (e.g., the memory 302); (ii) store a multimedia UID 71 in association with the multimedia object 70; (iii) store a multimedia file reference 72 drawn from the video object 170 to the video file 620; and (iv) generate a video structure data 182 including a multimedia segmentation reference 83 drawn from the multimedia object 70 a segmentation object 50 within the database. In one or more embodiments, and with reference to the above example, the multimedia object 70 may be replaced with a video object 170, the multimedia file reference 72 may be a video file reference 172, and a multimedia UID 71 may be replaced with the video UID 171. Once the multimedia object 70 is defined, descriptive data or other associations or relations may continue to be added, stored, or modified, including by the user 103. For example, the multimedia object 70 may act as a placeholder until data outputs are returned from additional models (e.g., the multimedia description data 76).

In one or more embodiments, an event object assembly subroutine 308 may be configured to receive descriptive and structural data for extracted events and initiate, define, and populate event objects 10 within the data structure 01. This function also may include defining additional database relations 03 between and among nodes 02 within the data structure 01. In one or more embodiments, an event object assembly subroutine 308 may include computer readable instructions that when executed (i) initiate an event object 10 in a database (e.g., the event structure database 304) and store an event UID 11 in association with the event object 10; (ii) store in association with the event object 10 an event range data 12 that includes one of the time range 13 and/or the frame range 14; (iii) store in association with the event object 10 the event description data 16 and/or the event summary data 17; and/or (iv) store the event ontology data in association with the event object 10.

In one or more embodiments, the event object assembly routine 308 and/or the event object assembly routine 308 may include computer readable instructions that when executed associate within the database the multimedia object 70 and the event object 10, through (i) an event object reference drawn between the video object 170 and the event object 10 (e.g., similar to the event reference 43, but draft from the multimedia object 70); and (ii) two or more segmentation references 83 linking the video object 170 to the event object 110 through one or more interstitial segmentation objects (e.g., a segmentation object 30, a segmentation object 50, etc.) between the video object 170 and the event object within 10 the database. The associations may form a contextual link for efficiently importing context (e.g., as described in the context data 700) to assist in audio selection and/or audio generation for the event object 10, according to one or more embodiments. In one or more embodiments, the event object assembly routine 308 may include computer readable instructions that when executed associate a first event object 10A with a second object 10B within the data structure 01 by storing an event reference 23 between the first event object 10A and the second event object 10B (such event reference 23 may be stored within either or both of the event object 10A and/or the event object 10B for bidirectional reference). Once an event object 10 is defined, descriptive data or other associations or relations may continue to be added, stored, or modified, including by the user 103. For example, the event object 10 may act as a placeholder until data outputs are returned from additional models, such as matched or generative audio.

In one or more embodiments, a segmentation object assembly subroutine 310 may be configured to receive descriptive and structural data for extracted segmentations and initiate, define, and/or populate segmentations objects (e.g., the segmentation object 30, the segmentation object 50) within the data structure 01, including definition additional database relations between and among nodes 02 within the data structure 01.

In one or more embodiments, the segmentation object assembly subroutine 310 may include computer readable instructions that when executed (i) initiate a segmentation object 30 (or segmentation object 50, and/or a different level of segmentation) in the database (e.g., the event structure database 304) and (ii) store a segmentation UID 31 (or segmentation object 51) in association with the segmentation object 30 (or segmentation object 50). In one or more embodiments, the segmentation object assembly subroutine 310 may include computer readable instructions that when executed associate within the database the multimedia object 70 and the segmentation object 30 (or segmentation object 50) through (i) a segmentation reference 83 drawn between the multimedia object 70 and the segmentation object 50, and/or (ii) a multimedia segmentation reference 83 linking the multimedia object 70 to the segmentation object 30 through one or more interstitial segmentation objects (e.g., the segmentation object 50) between the multimedia object 70 and the segmentation object 30. In one or more embodiments, the segmentation object assembly subroutine 310 may include computer readable instructions that when executed associate within the database the segmentation object 30 (or the segmentation object 50) and another data object, such as the event object 10, through a database reference 03, such as an event reference 43 drawn between the segmentation object 30 (or the segmentation object 50) and the data object. Once the segmentation object 30 (or the segmentation object 50) is defined, descriptive data or other associations or relations may continue to be added, stored, or modified, including by the user 103. The segmentation object 30 and/or the segmentation object 50 may act as a placeholder, similar to that of the other data objects within the event structure database 304, according to one or more embodiments.

As further shown and described throughout the present embodiments, an arbitrary number of levels or orders of segmentation organization may be defined, which may be instantiated and labeled depending on the needs and terminology of the type of multimedia file 610 being segmented. In one or more embodiments related to video and film, the segmentation object assembly subroutine 310 may be instantiated as either a scene object assembly subroutine and/or a shot object assembly subroutine. For instance, in the above paragraphs, references to the segmentation object 30 may be replaced with references to the shot object 130, references to the segmentation object 50 may be replaced with references to the scene object 150, and references to the multimedia object 70 may be replaced with references to the video object 170, according to one or more embodiments.

In one or more embodiments, the object assembly routine 306 may also define additional associations between the data objects and external data, such as data or files are stored on the audio server 400 and/or multimedia server 600. In one or more embodiments, the event object assembly routine 308 may include computer readable instructions that when executed store the event object 10 in association with an audio file 405, for example by storing the audio UID (e.g., an audio UID 415, an audio UID 433) of an audio file 405 in association with the event object 10.

A vector embedding engine 320 is configured to embed and/or encode descriptive and/or temporal data into one or more vectors. The vectors may be an array of values in multiple dimensions usable as model inputs 513, according to one or more embodiments. In some embodiments, a discrete set of data may be vectorized for ease of extraction and rapid input into one or more models. For example, descriptive and/or temporal data of each data object or other set of discrete data may be embedded prior to the intended use of such data as a model input (e.g., the encoding vectors 26 of the event object 10, the encoding vectors 46 of the segmentation object 30, the encoding vectors 66 of the segmentation object 50, the encoding vectors 86 of the multimedia object 70, and/or the encoding vectors 426 of an audio file 405). The vectorized data then may be rapidly queried and used as inputs to reduce the computing time of one or more of the present models in providing model output. For example, the model may be running on specialized hardware such as GPUs in the data center.

In one or more embodiments, a description vectorization routine 322 may be configured to receive one or more items of descriptive data or metadata about a data object, file, or other data entity, and embed such data in vector form. The dimensionality of the vector may be predetermined for one or more models in a format, match a format of one or more model inputs, or may be unspecified and variable.

In one or more embodiments, a description vectorization routine 322 may include computer readable instructions that when executed input the event description data 16, the event summary data 17, the event tags 115, and/or the event ontology data 18 (e.g., the subject-object parse 19, the verb class data 20, and/or the semantic roll label data 21) into the vector embedding engine 320. For example, the event object 10 may be queried within the data structure 01 and each type of data extracted from the event object 10. In one or more embodiments, all input to the description vectorization routine 322 may be text and/or alphanumeric data.

In one or more embodiments, a temporal vectorization routine 324 may include computer readable instructions that when executed input the event range data 12 into the vector embedding engine 320 and/or any temporal description data 25 of the event 96 represented by the event object 10. For example, the temporal description data 25 may describe, symbolically, mathematically, and/or narratively, how and when the event 96 unfolds over time. For example, for a space ship crashing on a desert planet and slowing to a halt, the temporal description data 25 may describe the initial velocity of the impact on the screen, the deceleration as the space ship as it slides across a desert scene, and a time at which the space ship comes to a complete halt. A change in the sound of the crash may be expected throughout the space ship's deceleration. In one or more embodiments, the temporal vectorization routine 324 may include computer readable instructions that when executed receive a temporal vector 28 embedding event range data 12 and/or the temporal description data 25.

In one or more embodiments, the temporal vectorization routine 324 may include computer readable instructions that when executed store the event description vector 27 and the temporal vector 28 in association with the event object 10 for rapid query and use. For example, the rapid use may be audio selection (e.g., matching to the existing audio file 410) and/or audio generation (e.g., generative synthesis of the generative audio file 430) associated with the event 96.

The vector embedding engine 320 may similarly extract, vectorize, output, and store data from other data objects, such as the segmentation objects 30, the segmentation objects 50, and/or the multimedia object 70. Although not shown in the embodiment of FIG. 1B, it should be noted that each of such objects also may have associated temporal data 25 which can describe temporally and mathematically how something within the segmentation unfolds.

For example, a temporal description data could describe an emotion throughout the scene 94 (e.g., an intensity level), which may be used in matching and/or generation at a relevant portion within the scene 94. Such temporal description data, along with the segmentation range data 32 and/or the segmentation range data 52, may be similarly embedded for use.

In one or more embodiments, the vector embedding engine 320 may also embed vectors for a discrete set of data other than the data objects within the data structure 01. For example, In one or more embodiments, the vector embedding engine 320 may include computer readable instructions that when executed (i) receive and/or extract an audio description 413 of an audio file 405; (ii) receive and/or extract a time length 414 of the audio file 405; (iii) embed a description vector 417 of the audio file 405 with the audio description; and (ix) embed a temporal vector 428 of the audio file 405, for example with a time length 414 and/or a temporal structure 425. The description vector 417 and/or the temporal vector 428 may be used in conjunction with the library description map 460, as shown and described in conjunction with the embodiment of FIG. 4 and FIG. 8.

In one or more embodiments, the event structure server 300 may include a contextual expansion routine 330 configured to respond to a query for multiple related instances of a data object (e.g., an event object 10 and its embracing segmentation object 30) and/or expand a query from one or a number of data objects to a greater number of data objects. A ruleset or logic for expansion may reside in one or more locations, including the event structure server 300 and/or the enhancement server 200. For example, the extent of contextual expansion may be context dependent, that is, depending on the purpose or system querying the data structure 01. As one example, context may be expanded from query of a selection 04 of an event object 10 to gather descriptive and/or temporal data from other relevant event objects 10, segmentation objects 30, segmentation objects 50, multimedia objects 70, and/or any of the files or other data referenced therefrom. An example of the contextual expansion for audio generation is further illustrated in FIG. 1C, with an example of its output for generation of context data 700 illustrated in FIG. 7, according to one or more embodiments.

In one or more embodiments, the contextual expansion routine 330 may include computer readable instructions that when executed: (i) select the event object 10 for audio generation, extract data such as an encoding vector 26 of the event object 10, the event description data 16, the event summary data 17, an event tag 15, the event ontology data 18, and/or the temporal description data 25; (ii) traverse a database reference between the event object 10 and the multimedia segmentation object 30; (iii) extract data such as an encoding vector 46 of the segmentation object 30, the segmentation description data 36, the segmentation summary data 37, and/or a segmentation tag 35; (iv) traverse a database reference between the segmentation object 30 and the segmentation object 50; (v) extract data such as an encoding vector 66 of the segmentation object 50, the segmentation description data 56, the segmentation summary data 57, and/or a segmentation tag 55; (vi) traverse a database reference between the segmentation object 50 and the multimedia object 70; and/or (vii) extract data such as an encoding vector 86 of the multimedia object 70, the multimedia description data 76, a multimedia summary data 77, and a multimedia tag 75. In one or more embodiments, the contextual expansion routine 330 may include computer readable instructions that when executed generate a context data 700 comprising data extract from each of the event object 10, the segmentation object 30, the segmentation object 50, and/or the multimedia object 70, to gather relevant context for the event object 10, as may be usable in matching and/or generation of the audio for the event object 10. Use of the context data. 700 is described throughout the present embodiments. As one present example, certain segmentation objects of the multimedia may carry important descriptive and/or temporal context. For instance, in film, if the event object 10 represents the last event 96 before the screen “goes black,” then it may be advantageous for the sound perceived by a view to linger into the otherwise void frames of the video file 620. It should be noted that, in one or more embodiments, a user 103 could also manually define this effect by extending the boundaries of the event range data 12 and/or re-aligning the audio file 405; one or more models may similarly define such a range or alignment as a model output based on examples on which such models have been trained).

In one or more embodiments, a contextual weighting algorithm 332 may apply one or more context weights 702 to data within the data structure 01, for example based on a ruleset or algorithm that determines how to weight each piece of extracted data, e.g., a matching or generative process. As an example from film, the “mood” intended for a scene 94, as may be described in the scene description data 156, may be more important to the audio selected for an event object 10 than the overall genre of the video object 170. For instance, the second scene of a “horror” movie (e.g., past the inciting or foreshadowing event) may otherwise show a “cheerful” scene in which the characters are presented to help the audience emotionally attach. As a result, it may be expected that the sound of doors opening in the second scene do not involve ominous creaking. Therefore, a greater weight may be provided to the scene object 150 (and/or the value of “cheerful” within the scene description data 156) relative to the video object 170 and/or the description of “horror” that may occur in the video description data 176 and/or the video tags 175. The context data 700 may be transmitted to one or more other servers for use, for example audio server 400 and/or the generative server 500, according to one or more embodiments.

In one or more embodiments, a contextual weighting algorithm 332 includes decreasing contextual weight with each referential distance from an event object 10. In one or more embodiments, contextual weight may be determined based on the amount of time that has elapsed from other events 96 and/or segmentations within the multimedia file 70, including a non-linear function (e.g., exponential decay or other diminishing or damping function).

The context weights 702 may be overwritten by the user 103, for example through the GUI of the multimedia audio enhancement application 280. The overwriting may be either while editing data of a data object and inspecting its relevant context and/or upon being presented with the context data 700 prior to use in one or more models, for matching to audio, and/or for generative synthesis of audio. In one or more embodiments, the multimedia audio enhancement application 280 may include computer readable instructions that when executed override the context weight 702 of an event object 10, override the context weight 702 of the multimedia segmentation object 30 (and/or the multimedia segmentation object 50), and/or override the context weight 702 of the multimedia object 70, with a user modification (e.g., user defined context weights 702).

In one or more embodiments, an event overlap determination routine 340 may be configured to determine an overlap between two or more events 96 modeled by two or more event objects 10. In one or more embodiments, the event overlap determination routine 340 may receive a selection of an event object 10 (e.g., the selection 04), traverse up to one or more embracing segmentation objects 30 and/or segmentation objects 50), and/or then traverse down to one or more other event objects 10; each of the event range data 12 of each event objects 10 may be extracted and compared, with event UIDs 11 for any overlapping event objects 10 returned. Alternatively, or in addition, an index for event object time ranges (e.g., an index of event UIDs 11 and event range data 12) may be maintained and referenced for query efficiency. In one or more embodiments, associated or related event objects 10 may also be referenced for overlap. Determined overlap may be used for a variety of purposes, including contextual weighting, mixing prioritization, mixing normalization, and other editing and audio engineering purposes.

In one or more embodiments, an imperative definition routine 314 may be configured to define a database reference specifying an imperative relation. The imperative relation may describe a fixed relation indicating an automatic action or disposition to be applied from one data object to another.

The imperative relations are further shown and described in conjunction with the embodiment of FIG. 12 and FIG. 13. For example, an identity imperative 1202 may specify that two events 96 are the same, the audio for the two events 96 should be the same (e.g., use the same instance of the audio file 405), and/or that the event objects 10 should be treated the same way for certain purposes. Another imperative may include a similarity imperative 1204 that may specify that two events 96 should be similar, but not identical (e.g., two similar sounding instances of the audio file 405, such as two different similar objects landing in the same bed of gravel in a film), and/or that the event objects 10 should be treated similarly, but not identical for certain purposes. Yet another imperative may include a differentiation imperative, where two events 96 are distinct, should have different sounding audio, and/or that the event objects 10 should be otherwise differentiated. Still another imperative includes a contrast imperative, in which two of otherwise similar events should contrast in one or more aspects. For example, the contrast imperative may define a requirement or strong influence that two or more audio files 405 should contrast, and/or that two or more event objects 10 should contrast. As an example in film, a first door opening to a bank may have a contrast requirement with a second door opening to a heavy bank vault door, even though many descriptive elements (e.g., the subject opening and walking through a door) are similar. In one or more embodiments, a complementary imperative may also be defined in which two events 96 and/or audio files 405 are distinct but complementary in appearance of the event 96. For example, a complementary imperative relation added between multiple event objects 10 may be used to define tonal sound effects within the same musical scale, or otherwise merge, average, or promote a similar or identical temporal structure between temporal description data 25. For instance, an identical temporal description data 25 may be used in three different generative synthesis requests such that the outputs share a similar quality that may be consciously or subconsciously congruent. The imperative may be applied to any of the data between the two linked data objects, including description data, temporal data, and/or referenced files such as the audio file 405. For example, where the audio file 405A or description thereof of a selected event object 10A is compared to an audio file 405B or description thereof of an event object 10B with an imperative relation to the event object 10A, there may be a higher probability of ensuring the imperative is performed (e.g., identical sound, contrasting sound, etc.).

In one or more embodiments, the imperative definition routine 314 may include computer readable instructions that when executed designate a relational imperative that includes an identity imperative 1202, a similarity imperative 1204, a differentiation imperative 1206, a contrast imperative, and/or a complementary imperative. Upon request for matching and/or generation of an audio file 405, the event structure server 300 may be queried. Data used for matching and/or the model input 513 of the generative audio model 520 may then include the relational imperative and any data from the event object 10 referenced by the relational imperative. For example, the audio description of an audio file 405 associated with the event object 10 that was referenced by the relational imperative may also be used in matching and generation of audio.

FIG. 4 illustrates an audio server 400, according to one or more embodiments. The audio server 400 includes one or more processors 401 that are computer processors and one or more instances of memory 402 that are physical, non-transitory computer readable memory. The audio server 400 may house one or databases storing audio, for example one or more audio libraries 411, one or more generative libraries 431, and/or one or more master databases 471. As used herein, an audio file 405 may include either a preexisting and/or traditionally recorded audio file (referred to as the existing audio file 410) and/or a generative audio file produced by one or more generative models 520 (referred to as a generative audio file 430). Even though previously generated, it will be recognized by one skilled in the art that the generative audio files 430 may have been stored for access and use, for example for reference and use by one or more event objects 10.

In one or more embodiments, the audio library 411 may store a set of one or more existing audio files 410. For example, the audio library 411 may be a sound effects and/or foley library. The audio within the audio library 411 may have been synthesized (e.g., by a digital synthesizer), recorded from a real-world environment (e.g., the sound of a truck engine), or otherwise created. The existing audio file 410 may include an audio UID 415, a set of metadata 412 (including an audio description 413 or a time length 414, which may assist in matching or alignment), a temporal structure 425, and/or a set of encoding vectors 426 of the metadata 412.

The generative library 431 may include audio and sound effects generated by a generative model (e.g., the generative audio model 520), including those specially generated for the event objects 10. The generative audio files 430 may also include extra options (e.g., four instances of the generative audio files 430 may be generated for a single event 96) so that the user 103 may evaluate multiple options. The generative audio files 430 may be periodically erased if unused, or, if popular or otherwise useful, moved to the audio library 411. The generative audio file 430 may, similar to the generative audio file 430, include an audio UID 415 and a set of metadata 412 including an audio description 413, a time length 414, and/or a temporal structure 425. The generative audio file 430 may also include a set of encoding vectors 426 of the metadata 412. In addition, input data used to generate the generative audio file 430 may be stored, including to assist the user 103 in generating similar sounds and/or prompt engineering new generative audio.

The master database 421 may include one or more audio master files 470 that may have been generated as a result of selection, generation, mixing, and mastering audio, as shown and described herein. In one or more embodiments, the audio master file 470 may include a multimedia file reference 72 to the multimedia file 70 to which the audio master file 470 is associated and/or an event structure reference 472 to a unique identifier and/or the UID of the root 89 of the data structure 01 to which the audio master file 470 is associated (e.g., the multimedia UID 71), according to one or more embodiments.

Although not shown, in one or more embodiments mixes of one or more audio files 405 may also be separately stored, provided a unique identifier, and/or described. In one or more embodiments, mixed audio files 405 may also be stored on the client device 102.

In one or more embodiments, an audio description engine 440 may be configured to parse an audio file 405 to provide descriptions, including in formats such as natural language text, temporal structure, and other types. The description may be purely a description of the multimedia in a bounded portion, or may reference or describe the event's relation to other events and/or its narrative significance. In one or more embodiments, and as described below, the descriptions may be used for matching, including natural language matching and/or vectorspace matching.

In one or more other embodiments, descriptions of the audio file 415 (as opposed to descriptions of the event 96) may also assist in re-matching and/or re-generating audio appropriate to the multimedia, especially in later editing stages. This may be a distinct dataset from the event description data 16 of the event object 10 that may have been used to match to or generate an audio file 405 presently associated with the event object 10. In one or more embodiments, describing a direct description of the audio file 405 may help the user 103 to fine tune the editing and mixing process, for example by re-matching or re-generating sounds that close, but not quite suitable, for the event 96.

In one or more embodiments, an audio description routine 442 is configured to receive an audio file 405 and generate a textual and/or temporal description. For example, the audio description routine 442 may use Pengi™ by Microsoft® (“Pengi: An audio language model for audio tasks” by Deshmukh et al., Advances in Neural Information Processing Systems 36 (2023): 18090-18108) and/or Qwen™ (“Qwen-audio: Advancing universal audio understanding via unified large-scale audio-language models.” By Chu et al., arXiv preprint arXiv: 2311.07919 (2023)). The audio description routine 442 may output the audio description 413 which may be or include a textual description, a time length 414, and/or the temporal structure 425. The audio description routine 442 may also use an audio description model 443, which may be trained with training data comprising examples of audio and textual (e.g., human readable) descriptions and/or examples of audio and temporal structural descriptions.

In one or more embodiments, an existing audio description module 444 may receive and parse an existing audio channel 622 to describe the existing audio channel 622. In one or more embodiments, existing audio from the audio channel 622 can be used to help bound the events 96 of the video, generate similar but enhanced audio, and/or more easily align any existing audio file 410 or generative audio file 430 to be played in place of, or mixed with, that portion of the audio channel 622. An existing audio channel 622 may therefore form a scaffold on which new audio files 405 can be easily matched, created, and/or aligned.

In one or more embodiments, a portion of the audio channel 622 matching the event object 10 can be extracted and used as a template or scaffold to help find a close match to existing audio file 410 and/or generate a similar generative audio file 430. In one or more embodiments, the existing audio description module 444 may include computer readable instructions that when executed extract a portion of one or more existing audio channels 622 associated with the multimedia file 610 (such as the video file 620) associated with the multimedia object 70 (such as the video object 170). The portion of the existing audio channel 622 may be extracted within the time range 13 of the event object 10. The existing audio description module 444 may include computer readable instructions that when executed input the portion of the one or more existing audio channels 622 into an audio description model 443 which may output an audio description 413 of the portion of the one or more existing audio channels 622.

A model input 513 of a large language model used in matching descriptions to descriptions of existing audio files 410 may further include the audio description 413 of the portion of the existing audio channel 622. Similarly, a model input 513 of the generative audio model 520 may further include the audio description 413 of the portion of the existing audio channel 622, which may then become a factor in the generative audio process, for example as an engineered prompt and/or additional available data within the context window 523, model argument 521, and/or a RAG file.

Once a description of an audio file 405 is generated, in one or more embodiments, encoding vectors 426 may be generated therefore, for example through a call to the vector embedding engine 320. As a result, the audio description vector 427 and/or the temporal vector 428 can be produced, as may be used in building the library description map 460, according to one or more embodiments.

In one or more embodiments, an audio map generation routine 446 may be configured to generate a map between descriptive data for each audio file 405 to a UID 415 of each audio file 405, such that once the descriptive data is matched against the audio file 405 can be queried and extracted for use through query to the UID 415.

In one or more embodiments, the audio map generation routine 446 may include computer readable instructions that when executed generate a library description map 460 associating, for each audio file 405 (e.g., each existing audio file 410): the description vector 417 of each audio file 405, the temporal vector 428 of each audio file 405, and/or the audio UID 415 of each audio file 405. The audio map generation routine 446 may include computer readable instructions that when executed connect the library description map 460 to a large language model that may be used by the audio matching engine 450, as described below. In one or more embodiments, the library description map 406 may be connected to the large language model and/or another model through storage in a retrieval augmented generation (RAG) file.

In one or more embodiments, the audio server 400 may include an audio matching engine 450 configured to match a text description and/or temporal description of either an event, an audio file 405, or an audio channel 622 to a different audio file 405 such as the existing audio file 410. For example, the audio matching engine 450 may be used to match an audio file 405 to: (1) the event range data 12, the event description data 16, the temporal description data 25, and/or the encoding vectors 26; to (2) the audio description 413, the time length 414, and/or, the temporal structure 425 of a different audio file 405, according to one or more embodiments. In another example, the audio matching engine may match (1) the audio description 413, the time length 414, and/or, the temporal structure 425 of all or a portion of the existing audio channel 622; to (2) the audio description 413, the time length 414, and/or, the temporal structure 425 of a different audio file 405, according to one or more embodiments.

When used to find a match for event descriptions, the audio matching engine 450 may additionally use imported context data 700, and/or contextually weighted context data 700 that may be associated with various context weight values 702, for example as shown and described herein and as used for generative synthesis of audio.

In one or more embodiments, the audio matching engine 450 may use a vector comparison routine 452 configured to compare two or more encoding vectors (e.g., the encoding vectors 26 to the encoding vectors 426; or the encoding vectors 426A with a different set of the encoding vectors 426B). The audio matching engine 450 may make such comparison using a vector minimization algorithm 454. In one or more embodiments, the vector comparison routine 452 and/or the vector minimization algorithm 454 may use and/or may be implemented with a large language model.

In one or more embodiments, the audio matching engine 450 may include computer readable instructions that when executed extract from an event object 10 an event description data 16, an event summary data 17, an event ontology data 18 (e.g., which may include a verb class data 20 and/or a semantic roll label data 21), and/or a time range 13. The audio matching engine 450 may also include computer readable instructions that when executed input into the large language model a match instruction along with input comprising an encoding vector 26 that embeds the event description data 16, the event summary data 17, the event ontology data 18, and/or the time range 13.

In one or more embodiments, the vector comparison routine 452 may include computer readable instructions that when executed determine a minimum vectorspace distance between the encoding vector 26 and a description vector (e.g., an audio description vector 417) of a first audio file 405 or a plurality of audio files 405 within the audio library 411. In one or more embodiments, the minimum vectorspace distance calculated based on at least one of a Euclidean distance, a dot product, a Manhattan distance, and/or a cos distance. The audio matching engine 450 may include computer readable instructions that when executed determine the audio UID 415 of the first audio file 405 through association with the audio description vector 417 of the audio file 405. For example, the audio matching engine 450 may retrieve the audio UID 415 that may be stored as a value in the audio file reference 462 attribute. In one or more embodiments, the audio matching engine 450 may include computer readable instructions that when executed output an audio UID 415 of the audio file 405 and a confidence value measuring match strength between the encoding vector 26 and the description vector 417 of the audio file 405. The confidence value may be proportional to the minimum vectorspace distance, according to one or more embodiments. In one or more other embodiments, multiple matches may occur (e.g., the top three may be determined), each of which may have its confidence value recorded and stored in association with the UID 415 to provide for ranking or prioritized presentation to the user 103. Such storage of the UID 415 and confidence value may occur within the event object 10 to reference the matched instances of the audio files 405. A matching process using the library description map 406 is further shown and described in conjunction with the embodiment of FIG. 8.

FIG. 5 illustrates a generative server 500, according to one or more embodiments. The generative server 500 includes one or more processors 501 that are computer processors and one or more instances of memory 502 that are physical, non-transitory computer readable memory.

In one or more embodiments, the generative server 500 may include, or may further have access to, one or more generative audio models 520. In some embodiments, the generative audio model 520 may be a general generative audio model, broadly trained with a diverse training dataset and capable of generating any type of sound. Examples of commercial generative audio models 520 may include tangoFlux™ (“TangoFlux: Super Fast and Faithful Text to Audio Generation with Flow Matching and Clap-Ranked Preference Optimization”, by Hung et al. arXiv preprint arXiv: 2412.21037 (2024)) and/or Stable Open Audio™ (“Stable audio open” by Evans, et al. In ICASSP 2025-2025 IEEE International Conference on Acoustics, Speech and Signal Processing (ICASSP), pp. 1-5. IEEE, 2025).

While such models are commercially available, it will be appreciated that the prompt engineering, selective inputs provided to the model, and new use of outputs, may provide novel and non-obvious use of such commercially available tools.

In one or more other embodiments, the generative audio models 520 may be specialized, for example specially trained in generating certain lengths, types, and/or genres of audio. For example, in one or more embodiments, and as shown in FIG. 5, custom models may be fine tuned or trained to produce audio of certain duration, including instantaneous audio (e.g., a couple seconds or less), duration audio (e.g., several seconds or in the range of tens of seconds), and/or continuous audio (e.g., background or environmental sound, a recurring or persistent event such as the sound of a printing press running in the background of a video scene, etc.). Therefore, an instantaneous event audio generation model 522 may be trained on designations of events 96 with an instantaneous range and receive generative requests for event objects 10 specifying a time range 13 of two seconds or less; a duration event audio generation model 524 may be trained on designations of events 96 that endure for more than a couple seconds, and therefore receive generative requests for event objects 10 specifying a time range 13 between three and twelve seconds; and a continuous event audio generation model 526 which may be trained on designations of events 96 that endure for more than twelve seconds, and therefore receive generative requests for event objects 10 specifying a time range greater than twelve seconds. Such time ranges classifying events 96 may be arbitrarily selected depending on multimedia or even within multiple types.

Other specialized generative audio models 520 are possible. For example, a generative audio model 520 may be trained solely to generate the sound of music instruments, solely for gun shots, solely for vehicle sounds, etc. Although the generative audio models 520 can be specially trained or fine tuned, in one or more embodiments, various RAG files may be loaded for each type of generative request or query. When a generative audio model 520 outputs an audio file 405, computer readable instructions of the generative audio engine 510, when executed, may store the audio file 405 in association with the event object 10. For example storing the audio file 405 within the generative library 431 which can then be referenced by the event object 10, according to one or more embodiments.

In one or more embodiments, the generative server 500 may include a generative audio engine 510 configured to receive a generative audio request and/or generative instruction, gather any additional data or context required for the model inputs 513, input the data from the request and any additional gathered data into the generative audio model 520, and/or collect an output such as a generative audio file 430.

In one or more embodiments, the generative audio engine 510 may include computer readable instructions that when executed input into a generative audio model 520 a generative instruction along with a model input 513 of the generative audio model 520 that includes: (i) the event description data 16 and/or the event summary data 17, (ii) the event ontology data 18, and/or (iii) the time range 13. Once the generative audio model 520 outputs a generative audio file 430, an audio UID 415 may be generated for the generative audio file 430. The generative audio file 430 may then be stored for preview, editing, production use, or other purposes (e.g., in the generative library 431)

The generative audio engine 510 may include a vector extraction routine 512 that may query and/or extract an event object 10 and one or more related or associated data objects from the data structure 01, including to generate the context data 700. The data from the selected event object 10 for which audio is to be generated, and any context data 700 or encoding vectors thereof, may be used as model inputs 513, according to one or more embodiments. The context data 700 may be input into and/or parsed into arguments for the generative audio engine 510 along with a generative request.

In one or more embodiments, the generative audio engine 510 may also include an imperative extraction routine 514 that may query, determine the existence of, and/or extract one or more imperative relations between or among other event objects 10. The generative audio engine 510 may also query and/or extract data from such other event objects 10 to gain the data with which to impart or require the imperative. The generative audio engine 510 may include computer readable instructions that when executed may determine an imperative and/or a requirement, such as an identity requirement, a similarity requirement, a differentiation requirement, a contrast requirement, a compliment requirement, and/or another kind of requirement, as each may be explicitly stored in one or more attributes of the data structure 01. In one or more embodiments, the audio file 405 associated with the event 96 may be selected and/or generated based on the requirement of an imperative relation to a different event object 10 and/or a different audio file 405.

In one or more embodiments, generative audio may include a rich context that may be described in the data structure 01, and/or emergent of relations therein. In one or more embodiments, the generative audio engine 510 may include computer readable instructions that when executed query the data structure 01 to initiate traversal of a database reference between the event object 10 and a multimedia segmentation object 30, then extract an encoding vector 46 of the multimedia segmentation object 30, a multimedia segmentation description data 36, a multimedia segmentation summary data 37, and/or a multimedia segmentation tag 38. Such extraction to gather a descriptive context for generation of audio for an event 96 modeled by the event object 10. The descriptive context may be stored within the context data 700, which may be returned to the generative audio engine 510, according to one or more embodiments. The generative audio engine 510 may include computer readable instructions that when executed add to model input 513 the multimedia segmentation description data 36, the multimedia segmentation summary data 37, and/or the multimedia segmentation tag 35, according to one or more embodiments.

Context may be further expanded, for example as shown and described in conjunction with the embodiment of FIG. 7 and in conjunction with the contextual expansion routine 330 of FIG. 3. For example, the generative audio engine 510 may cause a database reference to be traversed within the data structure 01 between the multimedia segmentation object 30 and the multimedia object 70 and/or the multimedia segmentation object 50 and the multimedia object 70 (such as the video object 170). Extraction of data at the multimedia object 70 may occur as a result, including extraction of the encoding vectors 86, the video description data 176, a video summary data 177, and/or one or more video tags 175. A context data 700 may be generated including data extracted from the event object 10, data extracted from the multimedia segmentation object 30, data extracted from the multimedia segmentation object 50, and data extracted from the multimedia object 70, for example as shown and described in conjunction with the embodiment of FIG. 7. The context data 700 may be imported into a context window 523 of the generative audio model 520 and/or parsed into one or more model arguments 521 of the generative audio model 520, according to one or more embodiments.

In one or more embodiments, and as shown and described in conjunction with the embodiment of FIG. 3, contextual weight values may also be applied to any data of the event object 10 and/or associated data within the context data 700. For example, after a first context weight value is extracted from a multimedia segmentation object 30 and a second context weight value is extracted from the multimedia object 70, the context data 700 may be input into one or more generative audio models 520 along with the context weight values associated with the relevant data. As shown and described herein, the context weight may decrease with each referential distance from a selected event object 10. In one or more embodiments, therefore, generating a new generative audio file 430 may be based on the referential distance from the event object 10 to other data objects within the data structure 01.

In one or more embodiments, the generative audio engine 510 may be used to generate a generative audio file 430 using an existing audio file 410 (or a different generative audio file 430) as a starting point, which may thereafter influence the generative output. In one or more embodiments, the generative audio engine 510 may include computer readable instructions that when executed receive a generative request from the user 103 generate the audio file 405 (in the first instance, or possible to replace an existing audio file 410 that user 103 is not satisfied with). The generative audio engine 510 may include computer readable instructions that when executed a generative instruction input into a generative audio model 520 along with a model input 513 of the generative audio model 520. The model input 513 may include (i) the audio description 413 of the first audio file, and/or (ii) the first audio file. The generative audio engine 510 may include computer readable instructions that when executed output a generative audio file 430 from the audio generation model 520, generate an audio UID 415 for the generative audio file 430, and/or store the generative audio file 430 in association with the event object 10 within the data structure 01.

In some embodiments, in the case where an existing audio file 410 may be used as the basis for generating a generative audio file 430, attribution of the contribution or involvement of the existing audio file 410 may be tracked. For example, in one or more embodiments, an AI attribution subroutine 530 may include computer readable instructions that when executed store the audio UID 415 of the existing audio file 410 in association with the UID 415 of the generative audio file 430, to track a creative contribution of an artist of the existing audio file 410 and/or a rights holder of the existing audio file 410. In one or more embodiments, the artist or rights holder may be able to receive a royalty, compensation, and/or credit for having created and/or for owning the existing audio file 410 that formed the basis of, or acted as a major factor in, the creation of the generative audio file 430, according to one or more embodiments.

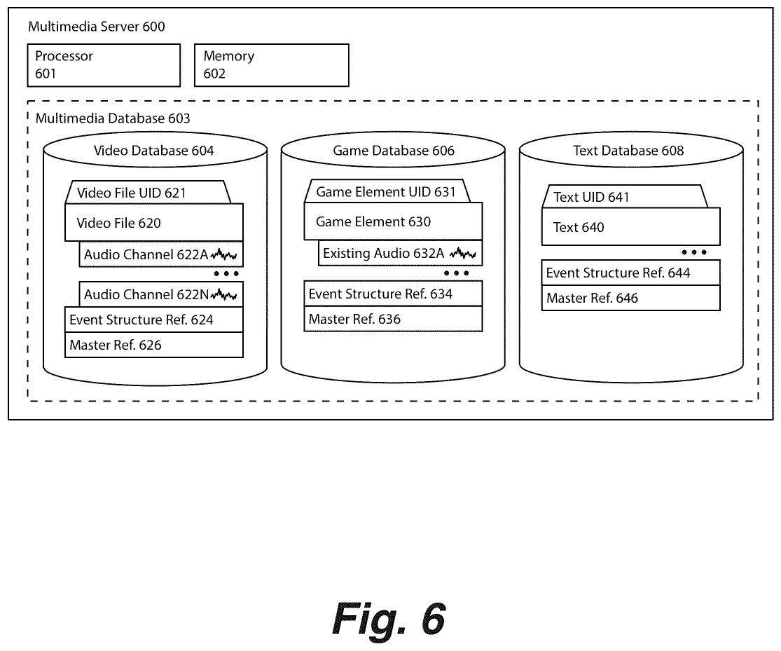

FIG. 6 illustrates a multimedia server 600, according to one or more embodiments. The multimedia server 600 includes one or more processors 601 that are computer processors and one or more instances of memory 602 that are physical, non-transitory computer readable memory. The multimedia server 600 may store a number of multimedia files, which may be generally referred to as the multimedia file 610. The multimedia file 610 may include a UID 611 of the multimedia file 610, one or more existing audio channels 612, an event structure reference 614 pointing to the associated event and segmentation extraction and description of the multimedia file 610 (e.g., the data structure 01), and/or a master reference 626 to a master file 470, according to one or more embodiments. In one or more embodiments, the multimedia file 610 may include text, images, audio, video and/or animation. Other examples of multimedia may include narrative text video games, podcasts, comic books, and/or interactive graphical images (e.g., graphics with associated sound, digital art, NFTs, etc.). It should be noted that some events 96 may occur conditionally, rather than temporally or sequentially. For example, a piece of digital art may make certain sounds when certain portions are moused over, and where a mouseover of each defined portion of the digital art defines an event 96.

In one or more embodiments, and as described extensively herein, the multimedia file 610 may be or include a video file 620. One or more instances of the video file 620 may be stored in a video database 604. The video file 620 may include a video file UID 621, one or more audio channels 622 (e.g., an audio channel 622A through an audio channel 622N), an event structure reference 624, and/or a master reference 626. The video database 604 may include a private database of a film studio, may include private uploads (e.g., from a consumer or social media influencer), may include a shared database of uploaded videos, may include a database of stock videography, and/or other may be uploaded or compiled from sources.

In one or more embodiments, the multimedia file 610 may include video game elements 630, for example recorded screenshots or video streams that may have been prepared by software engineers or game developers from a game engine (e.g. Unity®, Unreal®). In one or more other embodiments, the game element 630 may include a game engine description of an event, interaction, character action, environment, or other sound generating element within the game to be modeled as an event object 10. For example, for a game that involves cooking, a game engine may request sounds that different tools make when performing different actions: a vegetable knife cutting different types of vegetables on different surfaces, sounds of different types of pots, and/or sounds of different items sizzling in a pan. In addition, the game may include descriptions of the location of the sound to assist in generating sound echoes or reverberates correctly. The video game element 630 may include a game element UID 631, existing audio 632 (e.g., native to the game engine, or another source), an event structure reference 634, and/or a master reference 636.

In one or more embodiments, the multimedia file 610 may be or include a text 640, for example a narrative text (e.g., a novel), a news story, or other text. For example, a news story may include audio added to portions of the audio based on a description or contents of a title (e.g., chanting for a protest, or sounds of general disorder or civil unrest for a riot), paragraph, or sentence, including automatic triggers (scrolling to that section of text) and/or manually activated by buttons or hyperlinks). The text 640 may include a text UID 641, an event structure reference 644, and/or a master reference 646, according to one or more embodiments. Although three forms of multimedia are shown stored in FIG. 6, it will be appreciated that many other types of multimedia are possible.

FIG. 7 illustrates contextual extraction of data of an event object 10, related event object(s) 10, and segmentation objects (e.g., the segmentation object 30, the segmentation object 50, and/or other segmentation objects) to result in a context data 700 usable to improve matching to existing audio files 410 and/or generative synthesis of generative audio files 430, according to one or more embodiments. FIG. 7 also illustrates editing of the event object 10 to result in customized and/or describe data and other values defined by the user 103, according to one or more embodiments.

On the left side of FIG. 7, an event object 10 is illustrated, where the values of each shown attribute may have been automatically assigned during event extraction. Such initially defined values are denoted for the embodiment of FIG. 7 with an ‘A’, with multiple instances of any attribute defined with a decimal point and trailing number (e.g., the event reference 23A.1 through the event reference 23A.n).

Following initial extraction, the user 103 may make modifications to the event object 10. These modifications may come before audio is selected, after audio is selected, and/or during an editing and mixing phase. The user 103 may modify the data of the event object 10 through a number of means. First, the multimedia audio enhancement application 280 may include within the UI/UX one or more windows in which data from each event object 10 populates. The user 103 may be able to select and edit some of the data, for example the event description data 16. Similarly, graphical elements in the UI/UX may represent the event 96 on a timeline, with initial values or boundaries set according to the event range data 12. The user 103 may be able to slide the graphical elements to re-bound the event 96, including in relation to any visual multimedia (e.g., a video file 620). In another example, the user 103 may have access to an “explorer” that may visualize the data structure 01, its nodes 02, and its database relations 03. This visualization may enable the user 103 to view, comprehend, and edit data within the data structure, including defining new relations (e.g., associations, causations, imperatives, etc.). An advanced user 103 may be able to query the data structure 01 (e.g., view the data structure in a returned JSON file), edit it directly, and re-commit it. Similarly, a non-person user 103 such as an autonomous agent may have API direct access to be able to retrieve, review, update, and modify the data structure 01.

FIG. 7 illustrates several of such user-based modifications. First, the user 103 may determine that the event range data 12A is slightly off, and provide an updated event range data 12B, for example through the adjustment of UI elements representing the boundaries of the event 96 modeled by the event object 10. This may result in updating the time range 13A to the time range 13B and/or updating the frame range 14A to the frame range 14B. Such editing may be, according to one or more embodiments, non-destructive to the event object 10A by continuing to store both the original and modified values. This may allow for reversions to past states, or to log additional valuable training data. Next, the user 103 may view and feel the need to adjust the event description data 16A, the event summary data 17A, and/or the event tags 15A. For example, the user 103 may feel the event description data 16A is inaccurate, or lacks key detail that may help in matching or generating the most appropriate audio. For example, the user 103 may desire to select audio that: meets a certain narrative objective, meets the expectation of the audience (runs counter to expectation), is vivid (or muted), is bold (or subtle), is attention-grabbing (or non-distracting), and/or is intended to meet other practical, comedic, narrative, scientific, and/or artistic purposes.

Similarly, the user 103 may also update event ontology data 18, for example directly viewing and modifying the verb class data 20A to result in the verb class data 20B. As an example, an automatic determination of ontology may have determined that a “child is eating noodles from a plate with a fork.” However, the user 103 may decide this is inaccurate, or wish to frame the event differently to result in more articulate audio matching and/or generated audio. As a result, the user 103 may determine that the “instrument” is a pair of “wooden chopsticks”, and the “source” is a “ceramic bowl”. The user 103 may be able to make these corrections to the event ontology data 18, in addition to the event description data 16.

The user 103 may also create one or more associations with different event objects 10, for example by defining the event reference 23B. The event reference 23B could define a related event, a causal event, and/or an imperative relation, as shown and described in conjunction with the embodiment of FIG. 12. The user 103 may further add or edit a priority value 1324, as shown and described in conjunction with the embodiment of FIG. 13. As a result of the changes, the encoding vectors 26A may be re-factored to include the new data, specifically description vector 27B and/or the event temporal vector 28B. Refactoring may occur through a call to the vector embedding engine 320, for example as shown and described in conjunction with the embodiment of FIG. 3.

Next, the user 103 may generate a request for audio to be paired with the event object 10, for example either matched to an existing audio file 410 and/or associated with a generative audio file 430, according to one or more embodiments. Initially, an event UID 11A may be queried and all data relevant to a matching or generative process may be extracted, for example as shown and described in conjunction with the embodiment of FIG. 9. The user-defined values may be taken in place of, or in addition to, the initially defined data of the event object 10.

Next, the context for generation may be expanded by traversing from the event object 10 to one or more other data objects within the data structure 01, e.g., as shown and described in conjunction with the embodiment of FIG. 1C and FIG. 3. For example, certain data from each embracing segmentation object (e.g., the segmentation object 30, the segmentation object 50) and the multimedia object 70 may be extracted for context. In the present instance related to video, this may include data, as shown in FIG. 7, from each of one or more associated events 29, data from a shot object 130 embracing the selected event object 10, data from a scene object 150 embracing the selected event object 10, and data from a video object 170 embracing the selected event object 10. Although not shown, context data 700 can be comprised entirely of embedded vectors (e.g., the encoding vectors 26, the encoding vectors 46, the encoding vectors 66, and the encoding vectors 86). Use of the embedded vectors for context extraction can streamline data extraction and transmission, and can increase matching and/or generation response time from one or more models. The data also may be contextually weighted as further described in FIG. 9. The user 103 may be provided the option to review and edit contextual weighting, e.g., to help the accuracy of the matching or generation process.

In one or more embodiments, the data from the selected event object 10, along with the context data 700, may be used to match one or more existing audio files 410 to result in the matched audio dataset 800 and/or one or more generative audio files 430 to result in the generative audio dataset 900. Match criteria 802 or a confidence value 804 may be stored for each existing audio file 410, which may assist the user 103 in understanding why (or the basis for how) the match occurred. This data may also further assist in editing to re-match new audio if desired. Similarly, input parameters 525 may be stored for each generative audio file 430 to assist the user 103 in iteratively re-generating or otherwise adjusting the generative audio. Rankings 704 within either the generative audio dataset 900 or the matched audio dataset 800 may enable the user 103 to easily determine the best matches and/or generative attempts and prioritize review and approval. The ranking may be performed by confidence values (e.g., the confidence value 804) or other criteria. The user 103 may then preview, edit, mix, select, re-match, and/or re-generate one or more of the existing audio files 410 and/or generative audio files 430, according to one or more embodiments.

FIG. 8 illustrates descriptive data mapping to preexisting audio (e.g., the existing audio file 410) within an audio library (e.g., the audio library 411) using a library description map 460 (and optionally a descriptive vectorspace 810 and/or temporal vectorspace 820), to improve accuracy and/or efficiency in matching audio to an event object 10, according to one or more embodiments. In one or more embodiments, the audio library 411 may include a set of two or more existing audio files 410, each associated with an audio file UID 411. Each existing audio file 410 may include metadata 412 such as an audio description data 413, a time length 414, a temporal structure 425, and encoding vectors 426 such as the audio description vector 427 and/or the temporal vector 428. The audio description data 413 may be preexisting and/or have been prepared through use of software such as the audio description engine 440, as shown and described in conjunction with the embodiment of FIG. 4. In one or more embodiments, the encoding vectors 426 may be preexisting and/or prepared by the vector embedding engine 320, for example as described in conjunction with FIG. 3.

FIG. 8 further illustrates preparation of the library description map 460. In one or more embodiments, the library description map 460 may include associations between data representative of some characteristic or quality of the audio in the audio library 411 that can be matched against. In one example, the library description map 460 can include a set of audio file references 462 that are attributes each storing an audio file UID 411. Each audio file reference 462 associated inside the map with data describing the existing audio file 410 that can be matched against for one or more purposes. For example, the descriptive data that can be matched against can include the metadata 412 such as the audio description data 413, the time length 414, and/or the temporal structure 425. In one or more embodiments, straightforward text matching using natural language processing, can be used against the audio description data 413. Mathematical comparison known in the art may compare times and/or temporal structures to the time length 414 and/or the temporal structure 425.

However, in one or more other embodiments, and as shown in FIG. 8, the data to be matched against may include the encoding vectors 426. This may enable a large language model and/or adapted large language model to compare vectors and determining closest vector pairs within a multi-dimensional vectorspace and/or high-dimensional vectorspace. Such proximate vector pairs may indicate a high confidence match, for example as further shown and described in conjunction with the embodiment of FIG. 4. This approach may promote efficient, accurate, and rapid matching, which may enable the user 103 to edit and create faster, or explore more creative options.

The vectorspace may include a descriptive vectorspace 810 that is an n-dimensional vectorspace into which each audio description vector 427 of the library description map 460 may be stored or imported. In one or more embodiments, the vectorspace may be inherent in the trained LLM or data the LLM has access to. Although FIG. 8 shows a 3-dimensional vectorspace, it will be appreciated by one skilled in the art as an n-dimensional vectorspace capable of storing vectors that are tens, hundreds, thousands, or tens of thousands of dimensions. As also will be appreciated by one skilled in the art, weight values (e.g., the context weights 702, or other weights) may be used as coefficients to adjust values within the array that comprises the vector. Such weighting coefficients may influence matching by transforming the vector along one or more of its n-dimensions.

As illustrated in FIG. 8, a first vector representing data to be matched (e.g., the event description vector 27) is shown in a dot-dashed line, whereas three existing vectors (e.g., the audio description vectors 427) are shown in dashed lines. The first vector is shown close to a second vector, demonstrating a high confidence match, somewhat close to a third vector, showing a relatively medium confidence match, and far from a third vector, showing no match. Similarly, imperatives may perform vector math that may bring a vector closer to another vector (e.g., a similarity imperative 1204 is determined) or bringing the vector further from the other vector (e.g., a differentiation imperative). Still other imperatives may affect or transform some values in a vector array, but not others.

In one or more embodiments, temporal data may be similarly matched. For example, the temporal vector 428 may include an array of values that describe visual tempo, frequency, amplitude, sound wave complexity, or any of their changes over time, either in absolute or relative terms within a set of audio. Similarly, the event temporal vector 28 may include an array of values that describe progression of the event 96 over time, including in the case of video its tempo, frequency, intensity, coordinates within the shot 95 or the field of vision at a given time, distance from the camera, and any of their changes in time. A mapping or alignment of visual concepts to auditory concepts may be defined, and/or the audio matching engine 450 may include or access one or more models trained to associate temporal visual events with corresponding temporal audio, including existing film or real-world audio-visual recordings of various events and object-on-object interactions. The temporal vectorspace 820 may similarly include an example in which a dot-dashed line representing a vector (e.g., representing the event temporal vector 28) may form a high confidence match 812 against a second vector (e.g., representing the temporal vector 428), a medium confidence match 814 against a third vector, and no match or a low confidence match against a fourth vector.

Where both descriptive and temporal data is used trying to find a good match, the results of each may be additive, averaged, equally weighted, or calculated through one or more mathematical vector operations. For example, in one or more embodiments, the proximity of vectors in the descriptive vectorspace 810 may be weighted equally, in terms of match and any ranking thereof, compared with the proximity of vectors in the temporal vectorspace 820. In other cases, a non-linear function may be used (e.g., least square mean) or other function or filter to ensure neither a text description nor a temporal description distal to a confident match. For example, even where a confidence value within one vectorspace is high, the entire potential match still may be discarded if the confidence value from the other vectorspace is below a certain threshold.

Although two vectorspaces are shown, it will be appreciated that an arbitrary number of vectorspaces may be used and matched against, which may be defined for comparison efficiency, model format, and/or other factors as determined by one skilled in the art of data science, linear algebra, and/or machine learning.

Following one or more matches, possibly within required confidence thresholds, the associated audio file references 462 may be followed to corresponding existing audio files 410 within the audio library 411. A matched audio dataset 800 then may be assembled that includes one or more such matches. The matched audio dataset 800 may include references to the existing audio file 410 and/or store copies of the actual existing audio files 410. The audio dataset 800 may also include any matched criteria 802 and/or confidence values 804 which can be used in informing the user 103, help the user 103 to edit matching criteria in subsequent matching attempts, and/or for ranking within a UI to assist the user 103 to prioritize review, according to one or more embodiments.

FIG. 9 illustrates generative synthesis of audio files 405 (e.g., the generative audio files 430) using the context data 700 of FIG. 7 and/or user defined modifications and enhanced instructions (e.g., from imperatives) to improve accuracy and/or efficiency of generative audio creation, according to one or more embodiments.

Data from the event object 10 may be extracted for use in generating the generative audio file 430, including the event description data 16A.1 and the event ontology data 18A.1, both of which may have been embedded in an event description vector 27A.1. In one or more embodiments, each of the items of data of the event object 10A may be reviewed by the user 103 prior to submission as a model input 513, for example through a pop-up UI window within the multimedia audio enhancement application 280. The user 103 may then review the descriptive data of the event object 10A and decide whether to adjust the event description. In the present example, this may result in the user submitting the event description data 16A.2, which may initiate refactoring of the event description vector 27. Additionally, the user 103 may optionally adjust one or more context weights 702, including for the newly defined event description data 16A.2 and resulting event description vector 27.

In the present example, the user 103 may also review the context data 700, which may include segmentation description data 36 and segmentation description data 56 for two levels of segmentation object (e.g., the segmentation object 30, the segmentation object 50), event description data 16 for at least one related event object 10A (e.g., an associated, overlapping, or imperative event), and a multimedia description data 76 of a multimedia object 70. It should be noted that the context data 700 need not match each of the fields extracted for the selected event object 10A, such as the event ontology data 18A.1. The user 103 may similarly change the context weights 702 within the context data 700. As just one example, the user 103 may prefer that the description, feel, emotion, and/or style of a particular segmentation should receive more weight (e.g., more contextual influence) on the generative audio process than a different segmentation and/or a description of the multimedia as a whole. The user 103 may also expand context, for example through additional UI interactions that generate further queries on the data structure 01 to bring in additional context (e.g., using the contextual expansion routine 330), according to one or more embodiments. Similarly, the user 103 may contract context by narrowing which portion of the data structure 01 are relevant. In one or more embodiments, the act of the user 103 adjusting descriptive data may result in prompt engineering for the generative audio model 520.

After gathering, reviewing, and any manual editing of the data for the event object 10 and any contextual data, such data may be submitted as a model input 513 of a generative audio model 520. In one or more embodiments, the model input 513 may be a general textual input that receives natural language. In one or more other embodiments, however, the model inputs 513 may receive any of the extracted vectors and associated context weights 702. The model inputs 513 may also include specific model arguments 521 that may receive particular inputs that may be identified or defined to assist in the generative process. For example, a model argument 521 may include an exact time duration of the audio to be generated (e.g., which will have a high probability of aligning with the time range 13 of the event object 10A).

The model input 513 may also include a context window 523, which may be an amount of text or other data that can be received by the model input 513 during a single generative request, e.g., measured in tokens, and which may provide generative context such as storing the context data 700.

In submitting the descriptive data of the event object 10A and any context data 700, as modified and/or weighted, the user 103 may be submitting a generative instruction implicitly or explicitly to the generative audio model 520. In one or more embodiments, however, the user 103 and/or an automatic process may provide additional instructions 540, for example a differentiation instruction 542 and/or a complement instruction 544. The differentiation instruction 541 may be in reference to a particular segmentation. For example, within a film, the differentiation instruction 541 may be used to differentiate the sound generated for an event 96A of the selected event object 10A from the description of a different event 96B having the event description data 16A.2. In one or more embodiments, the differentiation may result in a negative prompt and/or negative prompt engineering based on the event description data 16B. The extent of differentiation may be weighted with the context weight 702F. The differentiation instruction may be automatically generated as the result of a differentiation imperative.

Similarly, a complement instruction 544 may be defined to complement the event object 10C, where the generated audio may be requested to be complementary to the event description data 16C. In one or more embodiments, and as further shown and described in conjunction with the embodiment of FIG. 10, differentiation instructions, complementary instructions, or other imperatives may be defined with reference to audio files 405 of one or more referenced event objects 10 (or descriptions thereof).

In one or more embodiments, it will be appreciated that certain aspects of the descriptive data of the event object 10A and/or the context data 700 may result in selection of a particular or specialized instance of the generative audio model 520, for example as shown and described in conjunction with the embodiment of FIG. 5. In the present example, modification of the event description data 16A.1 to the event description data 16A.2 may have introduced key words that may be identified. Such key words may cause selection of a particular generative audio model 520 (or retrieval of particular RAG or other supporting data) paired with those keywords (e.g., “slow motion”, “nature”, “explosion”, “insect”, “musical instrument”, etc.).

Following receipt of the model inputs 513, the generative audio model 520 may output one or more generative audio files 430. In one or more embodiments, each generative audio file 430 may be assigned an audio UID 415, and held in temporary memory until approved by the user 103 or otherwise surpassing a threshold for approval or use within the audio intended to enhance the multimedia file 610. For example, an audio file 405 may be stored in association with the data structure 01 and/or the event object 10A after the user 103 previews the audio file 405 and interacts with a UI element of the multimedia audio enhancement application 280 to approve or tentatively approve its use. Input parameters 525 of the model input 513 also may be stored, such that the generative audio model 520 can recreate the generative audio file 430 (if following a deterministic process) and/or such that prompt engineering may continue to systematically iterate, explore, and/or refine the output of the one or more generative audio models 520. The input parameters 525, especially when deemed successful, also may be useful as training data for one or more models.

FIG. 10 illustrates generative synthesis of audio files 405 (e.g., the generative audio file 430) using preexisting audio files 405 (which may be prerecorded or human generated), to help the user 103 further quickly iterate and/or refine audio for enhancing multimedia, including optional attribution to a rights holder of the preexisting audio, according to one or more embodiments. In one or more embodiments, the user 103 may wish to generate audio that is similar to existing audio or that uses the existing audio as a scaffold on which to generate new audio. For example, the existing audio file 410, which may be stored in the existing audio library 411, can be used as the existing audio, as shown in FIG. 10. The existing audio file 410 may include an audio description 413, a time length 414, a temporal structure 425, and/or encoding vectors 426 generated therefrom. If the descriptive data had been previously generated, the audio file UID 415 optionally may be queried and the description extracted from the audio library 411. Such descriptive data may have been generated by the audio description engine 440, for example as shown and described in conjunction with the embodiment of FIG. 4. Similarly, the encoding vectors 426, including an audio description vector 427 and/or a temporal vector 428, may have been generated by the vector embedding engine 320, for example as shown and described in conjunction with the embodiment of FIG. 3.

In one or more embodiments, the user 103 may review the descriptive data 413 of the existing audio file 410 prior to submission of such data as model inputs 513 along with a generative instruction. For example, the user 103 may read the audio description 413A and decide it should be modified to increase the probability that the audio description 413A, acting as a prompt for the generative audio model 520, will result in a better output as the generative audio file 430. For example, the user 103 may propose a modification, shown in the present example as the audio description 413B. Alternatively, or in addition, the user 103 may submit additional prompts or arguments to assist the generative process that may be outside of the format or capability of the existing descriptive data for the existing audio file 410.

In one or more embodiments, data from the event object 10 that contributed to matching of the existing audio file 410 may also be queried, imported, and submitted as a model input 513, for example, as shown and described in conjunction with the embodiment of FIG. 9. Although not shown in FIG. 10, the context data 700 also may be extracted from the data structure 01 and imported. The user 103 may similarly modify descriptive data for the event object 10 or its associated context data 700. The context weight 702 may be used to weight the impact of data of the event object 10, data of the context data 700, and/or data of the existing audio file 410. In one or more embodiments, and provided that proper model training or specialization of the generative model(s) 520 has occurred, as will be apparent to one skilled in the art after reading the disclosure herein, the existing audio file 410 also may be submitted (or pre-parsed and submitted) to aid in generation of the generative audio file 430.

In one or more embodiments, a process may track inclusion of data of the existing audio file 410 in generating of the generative audio file 430, especially where the actual existing audio file 410, its temporal structure 425, and/or its temporal vector 428 is submitted as a model input 513. This process may provide attribution citing the contribution of what may be traditionally recorded audio or synthesized audio creating the generative audio. The rights holder may be, for example, an owner or artist of an audio file 405, or the intellectual property or moral rights therein. In one or more embodiments, the existing audio file 410 may include a data attribute that can be used to store the rights holder information, copyright information or other proprietary rights information, referred to as the rights holder data 1000. Following generation of the generative audio file 430, an audio file reference 1002 to the existing audio file 410 and attribution data 1004 bearing some or all of the rights holder data 1000 may be appended thereto.

Although one instance of an existing audio file 410 is used in FIG. 10, it will be recognized that multiple instances may be simultaneously submitted to assist the generative process, including choosing or weighting elements of each. For example, a user 103 may approve of the temporal structure 425 of existing audio file 410A, but the time length 414 and audio description 413 of another existing audio file 410B. In one or more embodiments, and depending on the available model arguments 521, the user 103 may be able to compare or contrast existing audio files 410. For example, the user 103 may instruct that audio “between” or “combining” the properties of existing audio files 410A and existing audio files 410B is to be generated.

FIG. 11 illustrates a user interface of the multimedia audio enhancement application 280, and specifically a video audio enhancement application 1100, according to one or more embodiments. FIG. 11 illustrates a graphical user interface (GUI) through which the user 103 may view data in the data structure 01, modify the data (e.g., re-bound the event range data 12), preview audio files 405 (for preview, approval, rejection, and/or mixing), synchronize and align audio files 405, and/or perform additional actions. A media viewer 1102 in the upper center of the GUI may be used to display a portion of the video file 620 relevant to editing. Under the media viewer 1102, a time bar 1104 may display graduations of time (e.g., seconds) and/or sub-graduations thereof (e.g., milliseconds), along with color coding showing segmentations, such as the shots 95. Specifically, four shots 05 are shown in alternating hashing, the shot 95A through the shot 95C (e.g., all within the same scene 94).

Below the time bar 1104 an event viewer 1106 is shown in which graphical elements representing events 96 may be arrayed horizontally to represent time (e.g., in alignment with the time bar 1104) and vertically spaced for visual clarity and/or to show any overlap. The horizontal alignment may correspond with the time range 13 of each event object 10, and may be editable by dragging either end of the GUI element. A toolbar 1108 may be set on the left edge of the GUI. On the right side of the GUI, a vertical event editor 1110 may list events 96 and display details of events 96 in each of several event windows 1112 (e.g., queried from the event objects 10). Each event window 1112 may select or preview existing audio files 410, and/or edit event description data 16. In the present example, the event summary data 17 may be used as the title for each event 96.

Specifically, FIG. 11 illustrates a film including a scene in which a professional athlete playing in a large stadium scores a goal. The shot 95A may be a medium shot of the athlete juking defending players as they convey the soccer ball toward the opposing goal. The shot 95B may be a long shot of the athlete winding up and kicking the soccer ball. The shot 95C may be a slow motion low angle shot of the ball hurling toward the goal and then striking the net. Following the goal, the shot 95D may be a long shot of the entire stadium seating.

The event 96A may be a recurring event 97A representing stadium background noise, for example having an event description data 16 of: “stadium background noise of a large professional stadium including murmuring of large crowds and indiscernible acoustic effects and echoes for an announcer.” The event summary data 17 (“stadium background”) may be used as the title, which may also appear as a label in the event viewer 1106. The instantaneous event 99A may be described as “a distant soccer player on grass kicks a soccer ball hard at a goal.” Similar narrative descriptions may be applied to the temporal event 98A modeling the net impact and the temporal event 98B modeling the cheering of the crowd.

Within the event editor 1110, an event window 1112C may represent the temporal event 98B through data extracted from a corresponding event object 10. In the present example, the event window 111C may include a graphical display of the temporal description data 25, which may represent the rise and fall of the crowd cheering, and which may be editable by the user 103. Below the graphical representation of the temporal description data 25, several reviewable audio files 405 initially matched and/or generated may be shown. Selecting the preview may play the audio file 405 along with a portion of the video file 620 corresponding to the time range 13.

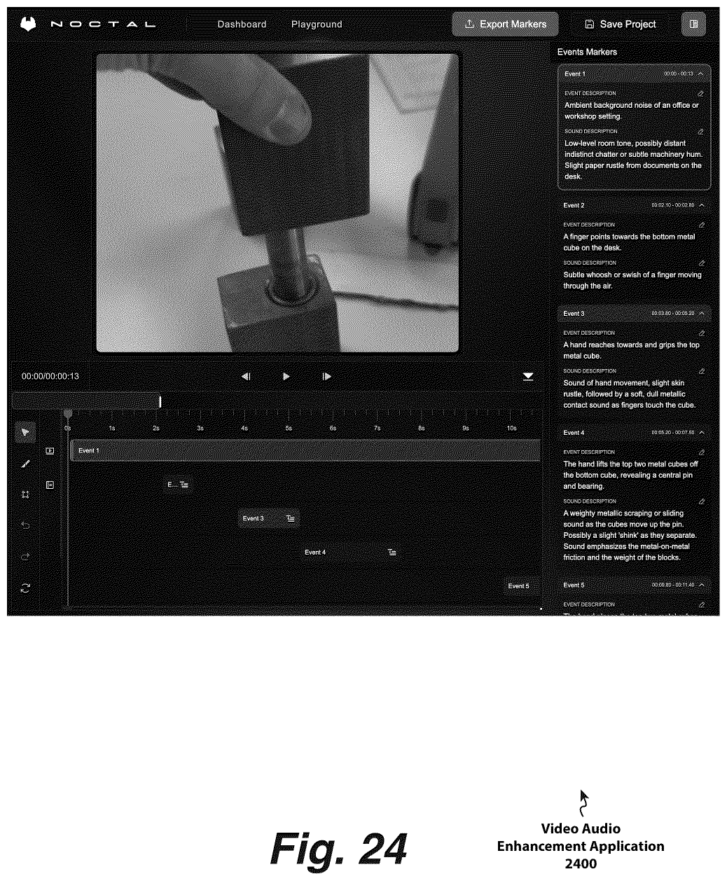

Although one GUI has been shown, it will be appreciated that many variations of the GUI are possible, both for video and other multimedia. A working example of a GUI is further shown and described in conjunction with the embodiment of FIG. 24.

FIG. 12 illustrates streamlined audio preview, detection of related and/or overlapping events 96, and use of imperative data (e.g., defined in imperative relations) to further assist in matching and/or generating audio for multimedia, according to one or more embodiments. FIG. 12 illustrates both a representation of portions of a video file 620 and corresponding elements of the data structure 01. The present embodiment may adopt the numbering schema of FIG. 1C for ease of direct comparison. Specifically, a grouping of a set of event objects 110 embraced by the shot object 130A.1 is shown, labeled as the event object 110A.1.1 through the event object 110A.1.6. The grouping may form the event group 1200 of a set of related events that should be considered, previewed, and/or have its audio mixed for review, in this case conveniently structured within the data structure 01 as all connected with the shot object 130A.1.

Depicted in the video file 620 is an animal scene including a child penguin and two adult penguins, e.g., a mother and father penguin. A series of events 96 may occur: a first event 96A.1.1 may represent a squawk by the first adult penguin; a second event 96A.1.2 may represent the child penguin trundling onto the screen from the right side; both a third event 96A.1.3 and a fifth event 96A.1.5 may represent two additional squawks by the first penguin; an event 96A.1.4 may represent incessant chirping by the child penguin; and the event 96A.1.6 may represent a singular squawk by the second penguin. Each event 96 in the nature film corresponds to a shown event object 10, shown in the lower half of the figure. For example, the second event 96A.1.2 corresponds with the event object 110A.1.2.

In the present example, audio may already have been matched to and/or generated for each of the event objects 10 (labeled in this example as the event objects 110 due to their use with video in the present embodiment). However, imperative relations defined between or among the event objects 110 may impact the matching or generation, and/or may automatically propagate the section of audio files 405 from one to the other. As an example, the user 103 may wish for the first adult penguin to have a similar voice, e.g., a more feminine call to match the expectation of a mother. Therefore, the event object 110A.1.1 may be automatically or manually defined to have a similarity imperative 1204 to the event object 110A.1.3, such that it is an imperative that the resulting sounds of the call are similar, but not identical. Likewise, an identity imperative 1202 may be defined between the event object 110A.1.3 and the event object 110A.1.5. This may be selected by the user 103 because two squawks in rapid succession from the same animal may be unnoticeable (or even preferred) by a viewer. For example, it otherwise may be efficient or judicious to carefully use available prerecording sound files of animals within an available audio library 411. For example, in some cases recorded sound files may be preferred over generative versions in some cases, for instance for scientific or journalistic integrity of a nature film. A film crew filming the nature video may have separately recorded or licensed audio of the same species which then must be carefully matched and aligned.

In another example, a contrast imperative 1206 may be defined between the event object 110A.1.3 and the event object 110A.1.6: the sound may be of the same type (e.g., a penguin call), but contrast between the male and female may be desired. Also illustrated, the event reference 23 may model a reaction of the second penguin to the squawks of the first, in one or more embodiments, which may assist in alignment (e.g., to help make sure the first penguin has stopped squawking before the other “responds”).

In one or more embodiments, the user 103 may wish to preview one or more of the audio files 405 selected for the event objects 110. For example, the user 103 may select the event object 110A.1.4 (“incessant chirping”) for preview. In order to provide an accurate and contextual preview, other events surrounding the event 96A.1.4 may be referenced and gathered. In one or more embodiments, a database reference 03 (shown by the broken line) may be traversed to the shot object 130A.1. In one or more other embodiments, the corresponding video from the video file 620 for every other event object 110 referenced by the shot object 110A.1 used in the preview. For example, the preview may include video from the beginning of time range 113 of the event object 110A.1.1 through end of the time range 113 of the event object 110A.1.6. However, in one or more other embodiments, only those overlapping events 96 may be extracted, mixed, and previewed with corresponding multimedia such as video. For example, a portion of the video corresponding to the overlaying events 1201 may be played, corresponding to a union of the time range 13 of the event object 110A.1.3, the time range 13 of the event object 110A.1.4, and the time range 13 of the event object 110A.1.5, as each are shown traversed to by dot-dashed lines in the present embodiment.

In still other embodiments, a preview may be made of specific imperatives such that the user 103 can compare each side-by-side. This may form a different type of event group 1200. For example, the user 103 may select an event object 10 and wish to view all similarity imperatives to ensure they are similar (or different) enough. These may be played for the user 103 in sequence, even if not overlapping. Where imperatives of the same type are defined, an index listing event UIDs 11 may be stored in association with the data structure 01.

Following preview, the user 103 may decide to change the audio file 405, change the event range data 12 of the event object 10 to better match the event 96, and/or re-align the audio. The user 103 may also decide whether to define additional imperatives (e.g., trying to create more contrast between two otherwise similar sources of sound by defining a contrast imperative). The user 103 may also continue to match or generate new audio files 405, including continuing to edit data resulting in matching and/or generation.

FIG. 13 illustrates audio mixing, including event prioritization, imputed prioritization as a result of associations or imperatives, and normalization of mixed audio, according to one or more embodiments. FIG. 13 continues the example of FIG. 12 but highlights different potential aspects of the data structure 01. Specifically, the event object 110A.1.3 through the event object 110A.1.6 are shown, each with a representation of the waveform of a selected audio file 405 that may have been matched and/or generated for the event object 110. In one or more embodiments, selection of the audio file 405A.1.3 may be automatically propagated to the event object 110A.1.5 as a result of the identity imperative 1202.

As known in the art of sound engineering, each of the audio files 405 may initially have varying waveform characteristics, such as varying amplitudes, that if mixed may result in incongruent audio. For example, certain sounds may be too quiet, while others are relatively too loud. This may cause one to “drown out” or overpower the other. However, certain sounds may be more important than others. It may be important to adjust these levels depending on the objective of the multimedia. For example, in film, it may be especially important to clearly hear any audio channel that includes speaking clearly. Similarly, actions taken by characters (even sounds resulting from interactions with the environment or setting) may take higher priority than other sounds, background noise, etc. Still other sounds may have to be adjusted for emphasis, surprise, and/or to meet an expectation of the audience or other consumer of the multimedia.

In the present example, the audio file 405A.1.4 that can be used to produce the sound of incessant chirping during the nature film may be substantially quieter than the other audio due to a relatively diminished amplitude. However, the child penguin actually may be intended as the subject or focus of the shot 95 (and/or the scene 94). Therefore, the user 103 may manually adjust the levels of the audio 405A.1.3 before mixing, e.g., through the UI of the multimedia audio enhancement application 280. The user 103 may continue previewing and adjusting in iterative loops. An alternative or additional approach using event priority to address the audio deficiency next described.

In one or more embodiments, priority values 1324 may be used to determine a priority for sound wave amplitude and/or other audio characteristics. The priority value 1324 may be automatically or manually assigned. For example, and as shown and described in conjunction with the embodiment of FIG. 2, the event prioritization routine 262 and/or the event prioritization algorithm 263 may assign priority values 1324 based on a ruleset applied to the descriptive data of the event object 10. For example, the sound made by a subject (e.g., identified in a subject-object parse 19 may receive a higher priority; a subject that is a human or animal may receive an even higher priority; a human that is a main character of a story may receive a highest priority. In one or more other embodiments, a priority assignment model may be trained and developed based on visual or other multimedia input.

In the present example, four priority values 1324 may have been assigned: a priority value 1324.3 equal to “six” for the event object 110A.1.3 (the squawk of the first adult penguin); a priority value 1324.4 equal to “three” for the event object 110A.1.4 (incessant chirping by baby penguin); a priority value 1324.5 equal to “six” for the event object 110A.1.5 (another squawk of the first adult penguin); and a priority value 1324.6 equal to “seven” for the event object 110A.1.6 (the reply squawk of the second adult penguin). In one or more embodiments, the application of the priority value of “six” may be automatically propagated from the event object 110A.1.3 to the event object 110A.1.5 due to the identity imperative 1202. However, in one or more other embodiments, identity does not necessarily mean priority in a different local context (e.g., a different shot 95 or scene 94).

The user 103 may review the priority assignments and wish to change them. The baby penguin may have automatically received a relatively low priority value, for example because the baby is smaller on screen, does not appear in the rest of the film, or has relatively small body and beak movements relative to the larger penguins. However, the baby penguin may be the intended subject of the shot 95. Therefore, the user 103 may intentionally increase the priority value 1324 from “three” to “eight”, elevating it above the audio for the calls of the two adult penguins. In one or more embodiments, an amplification function 267 may be applied to the waveform of the audio file 405A.1.4, resulting in a sound wave transformation as shown in FIG. 13.

Although integers are used to clearly demonstrate the concept of priority herein, it will be recognized that any real numbers may be used, including decimals between ‘zero’ and ‘one’, with ‘zero’ representing a lowest priority and ‘one’ representing a highest priority. Priority values 1324 also may be defined globally within the entire multimedia file 610, regionally (e.g., within a segmentation), and/or locally, within a small segmentation or a given time horizon.

FIG. 13 also illustrates mixing of one or more audio files 405 to form the mixed audio file 1305, according to one or more embodiments. In the present example, each of the waveforms may be combined but also normalized relative to one another to prevent clipping and ensure suitable head room, as known in the art of audio engineering. As just an example, the audio file 405A.1.6 may extend out of an acceptable range (as depicted). All audio files 405A.1 depicted in FIG. 13, when mixed, may be scaled linearly and/or proportionally until enough headroom in the audio file 405A.1.6 has been established. (It should be noted that, without previous scaling of the priority value of the audio file 405A.1.4, the sound of the baby penguin chirping may have become almost inaudible if further transformed during normalization). Normalization may also be conducted non-linearly, for example following a function that may depend exponentially or logarithmically on an absolute or relative priority value 1324. The simplified representation of the normalized instance of the mixed audio file 1305 is illustrated in a lower right corner of FIG. 13.

FIG. 14 illustrates a training data package 276 that may be used to train one or more models described herein, and specifically a training data package 276 for a model that can visually assess contents of a video clip 278, according to one or more embodiments. The training data package 276 may be generated as a result of interactions performed by the user 103 that reject, approve, and/or modify automatic or manual determinations. For example, the user 103 or an automatic process may generate training data in recognizing events 96 within the multimedia file 610, bounding events with the event range data 12, generating or editing event description data 16, determining temporal structure or generating temporal data 25, aligning audio to events, building event ontology data 18, associating events or defining relational event data 22, setting priority data 24 (including priority values 1324), setting context weights 702, automatically detecting or suggesting imperative relationships, matching existing audio files 410, and/or generating generative audio files 430. Such models for recognition, segmentation, bounding, and/or description may be referred to as the models 1400. The video clip 278 may correspond to the event range data 12B and/or the event range data 12A, plus any additional range that may be helpful in further providing context for machine learning.

In some embodiments, the training data package 276 may be used to train models for use on video, including an event recognition model 211, the event range determination model 213, and/or an event description model 215. The training data package 276 may have been generated as a result of the user 103 confirming that an event 96 was adequately recognized, adequately bounded (e.g., in the event range data 12), and adequately described (e.g., in the event description data 12). In this case, the training data package 276 may include a video clip 278, the event range data 12B (e.g., which may be the user defined editing), and the time range 13B (e.g., the adjusted user time range). In one or more embodiments, the time range 13B may include a start time 1401, a duration 1402, and/or an end time 1403, each of which may have been set or confirmed by the user 103. In some embodiments, the incorrect or outdated data, such as the event range data 12A, also may be included as exemplars of incorrect description, which may further help to train some models.

In one or more embodiments, the training data package 276 may be used to train an audio alignment model 257 for use with video. In this case, the training data package 276 may include the video clip 278, the audio file 405, the event range data 12B, and the event temporal vector 28B that has been refactored as a result of the updated event range data 12B. Optionally, such training data package 276 may also include the event range data 12A and temporal vector 28A.

It should be noted that, in one or more embodiments, the same training data package 276 may be prepared for future use of many models, which may select the appropriate data therefrom. Thus, a single training data package 276 from decisions of the user 103 or other affirming processes may be able to build a training data for supervised machine learning processes, according to one or more embodiments. Similarly, an entire log or dataset of decisions of one or more users 103, including substitutions, selections, editing, and other actions performed by the user 103, may be stored as model training data.

Although the example of video is provided in FIG. 14, the training data package 276 may be prepared for any kind of multimedia file 610, in which case the video clip 278 is replaced with a relative portion of the multimedia (e.g., as may be described and numbered as a multimedia portion 277).

It should be noted that two or more related and/or time-synchronized multimedia may each have events and segmentations extracted, and may then be coordinated and/or merged. For example, events recognized and bounded in one multimedia may assist in event bounding and recognition in a synchronized multimedia. For instance, within film, the audio channel 622 of a video file 620 may be treated as its own form of multimedia file 70, which could also have events and segmentations extracted and a data structure 01 assembled, including event objects 10.

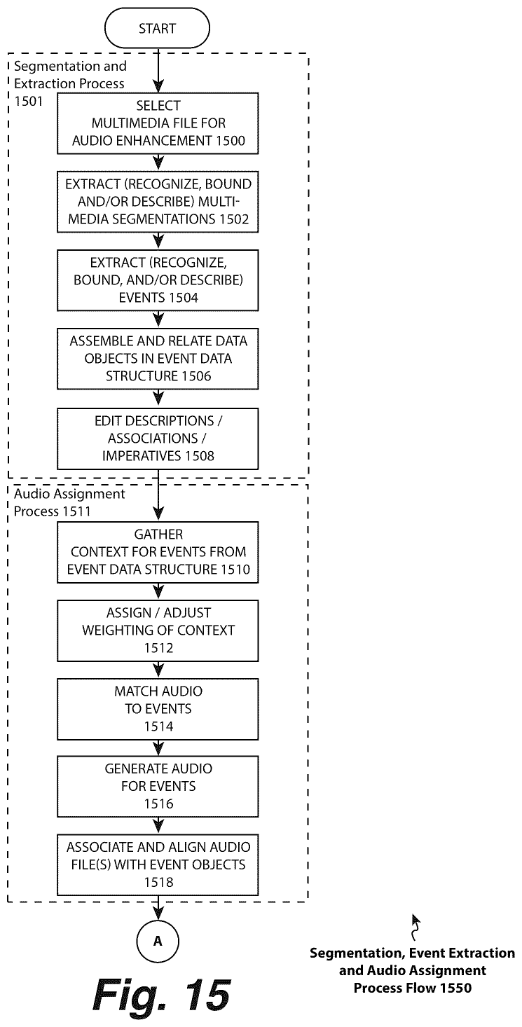

FIG. 15 illustrates a multimedia segmentation, event extraction, and audio assignment process flow 1550, according to one or more embodiments. Operation 1500 through operation 1508 illustrate a segmentation and extraction process 1501, and operation 1510 through operation 1518 illustrate an audio assignment process, according to one or more embodiments.

In one or more embodiments, operation 1500 selects a multimedia file 1610 for audio enhancement. For example, a user 103 may select an existing multimedia file (e.g., a piece of stock videography in a stock video library) and/or upload a video file 630. Operation 1502 extracts one or more multimedia segmentations. Extraction may include recognizing a segmentation of the multimedia, bounding the segmentation of the multimedia within extents of the multimedia, and/or describing the segmentation. The extraction may also include recognizing a type of segmentation (e.g., a scene, a shot, etc.). The description of the segmentation may include a textual description that may include natural language and/or may be human readable. The description may be structural (e.g., a group of pixels of a digital photo, a shot 94 within a video, an intro portion of a podcast, an interview within the podcast, etc.). Alternatively, or in addition, the description of the segmentation may be narrative and/or functional (e.g., a narrative element depicted in a film, a topic segment of a podcast within an interview, etc.). In addition, an event type may be recognized and assigned (e.g., an instantaneous event, a temporal event, a recurring event). Operation 1504 may then extract one or more events 96 within the multimedia. The extraction may include recognizing events, bounding events, and/or describing the events. The description of the event may include a textual description that may include natural language and human readable. The description of the event may also include a mathematical description and/or a temporal description of an extent or quality of the event unfolding over time or other state changes of the multimedia.

Operation 1506 may assemble and relate data objects in an event data structure, including data objects representing the multimedia file 630, the segmentations, and/or the events 96. In one or more embodiments, the data objects each may be represented as nodes 02 within a hierarchy and/or directed acyclic graph (e.g., a DAG, as shown in FIG. 1C), where each node 02 may be related to other nodes through one or more database relations 03. The database relations 03 may include database references of various types, including those intended to group other data objects (e.g., the segmentation reference 83, the segmentation reference 63, the event reference 43) and/or to designate other types of associations (e.g., the event reference 23, an imperative relation, etc.).

Operation 1508 may edit descriptions and/or associations, which might include imperative associations. In one or more embodiments, the user 103 may review and edit descriptions. Following the segmentation and extraction process 1501, the user 103 therefore may have received a fast, efficient, and consistent description of their multimedia, and its segmentations and events. The data structure that results can allow the user 103 to easily edit (rather than draft from scratch) a full description of the multimedia for applying audio effects and/or foley.

The audio assignment process 1511 may assign audio for each event 96 designated with an event object 10. Operation 1510 may gather context for the event objects 10 within the structure 01. For example, descriptive data from one or other data objects that share an aspect in common with the event object 10 of the event 96 may be pulled into a context data 700 for use in facilitating audio assignment such as matching or generation of audio. Similarly, descriptive data for one or more data objects that are related to the event object 10 (e.g., through or more database relations 02), including within a threshold “relational distance”, may be gathered. Operation 1512 then may assign a contextual weighting 702 to each piece of descriptive data from the gathered context and/or descriptive data from the event object 10. Operation 1512 may also adjust weighting of the context, for example according to an algorithm. As just one example, the algorithm may define diminishing weight with each database relation 03 traverse measured from the event object 10 and/or through manual updates from users 103. As a result of the ability to gather context within the segmentations and related event assignments, there may be an automatic, efficient, consistent, and thorough way to generate rich contextual information for each event 96 to increase the probability that a highly relevant, appropriate, and/or artistically significant sound can be selected to enhance the multimedia.

Operation 1514 may match audio, such as existing audio files 410, to the events 96 of the event objects. For example, descriptive and/or temporal descriptions of events 96 stored within the event objects 10, and any context, may be matched to descriptions in a database, for example an audio library 411. Matching may also occur using vectorizations of descriptive data from each event object 10 and its gathered context data 700, which may promote relatively fast and precise matching, including through use of models capable of vector comparison. Each audio file 410 that was determined to be a match then may be associated with the event objects 10.

Operation 1514 may generate audio for the event objects 10. In one or more embodiments, descriptive and/or temporal descriptions of events 96 stored within the event objects 10, and any associated context, may be input into one or more generative audio models 520. The generative audio model 520 selected may have a specialty based on the description of the event audio and/or any gathered context. The outputs of the one or more generative models 520 may be stored in association with the event objects 10. Each event object 10 may then have either or both of an existing audio file 410 and/or a generative audio file 430 associated therewith. As a result, there may be an efficient way to automatically find existing sounds and generate new sounds using AI models that have a high probability of being highly relevant, appropriate, and artistically significant. In addition, the user 103 may have been rapidly provided with multiple options from which to select, iterate, and/or further submit as a basis for additional generative processes to efficiently hone in on what the user 103 may decide is an excellent fitting sound for the multimedia.

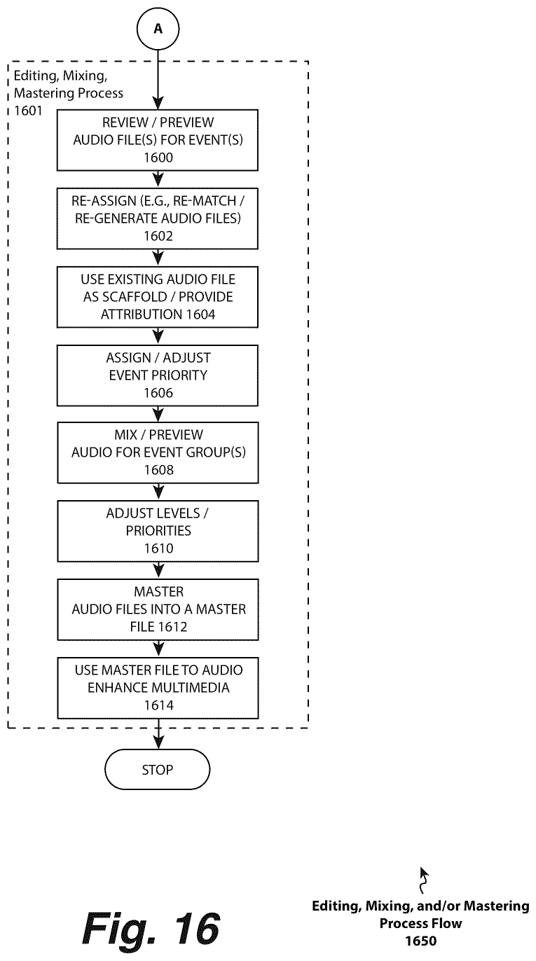

Operation 1518 associates and aligns the audio files 405 (e.g., the existing audio 410, the generative audio 430, other audio files) with each event object 10. Alignment may be based on event bounding (e.g., start time, end time, duration), duration of the audio file 405, temporal structure of the event 96, temporal structure of the audio file 405, and/or other factors. A model may be used to align the event 96 of the event object 10 with the audio files 405. As a result, the user 103 may have automatically received a set of preview-able audio alignments that not only have a higher probability of being relevant sounds, but are also paired with the events 96 such that, if the sound is selected, it may already have a relatively good alignment with the event 96. This may also assist the user 103 in more quickly selecting the correct sound, because the sounds may be pre-aligned such that they are easily able to be previewed. The process flow of FIG. 15 may then end, or proceed along path ‘circle A’ to the embodiment of FIG. 16.

FIG. 16 illustrates an editing, mixing, and/or mastering process flow 1650, according to one or more embodiments. Operation 1600 reviews and/or previews audio files 405 associated with each event 96 within the multimedia file 610. For example, the user 103 may use an application with a graphical user interface to cycle through, query, and present data from each of the event objects 10. The user 103 may preview the audio for each event 96 to ensure it is appropriate for the multimedia, artistically advantageous, and/or properly aligned.

Operation 1602 may re-assign one or more audio files 405 to one or more event objects 10 within the event data structure 01 (which may re-assign the resulting sounds paired with the events 96 depicted within the multimedia). The user 103 may review and select the audio to be used. Alternatively, the user 103 may change one or more parameters and attempt to re-match and/or re-generate additional audio. Operation 1604 may use an existing audio file 410 as a scaffold for generation of a generative audio file 430, for example using the descriptive data, temporal data, or parsed audio file 410 as one of the model inputs 513 for a generative model 520. Operation 1604 may also provide for attribution, credit, and/or another form of citation to an owner, artist, or other rights holder of the existing audio file 410 in this generative process. Therefore, in one or more embodiments, an advantage includes the user 103 to make small generative adjustments to existing audio, while still providing attribution, allowing for tracking potential licensing revenue, and/or meeting other legal needs with respect to the existing audio. These possibilities may potentially increase audio editing, artistic options, and engineering speed.

Operation 1606 may assign an event priority, for example priority values 1324 that may specify an importance of the sound of the event 96 within the multimedia (e.g., from a perspective of the audience or other consumer of the multimedia). In one or more embodiments, priority may be assigned based on event descriptions and/or associations within the data structure 01. An automatic process may assign priority based on event descriptions, database relations 03 (including imperative relations that can define two events 96 are identical, similar, or different), and/or other factors. The user 103 may also manually edit the priorities. As a result, importance of events 96 and their audio may be able to be explicitly defined, helping ease manual or implicit prioritization during mixing, and therefore speed multimedia audio enhancement.

Operation 1608 may mix and preview audio for each event 96 or group of events 96. For example, a group of events 96, including both their audio and an associated portion of the multimedia file 630, may be presented to the user 103. The event groups, for example, may include events 96 within a segmentation, events related to one another (e.g., all events with a “similar” imperative), and/or events occurring close in time. Where the multimedia and its audio are sequentially processed, and/or time-synchronized (e.g., a video with an audio track, a podcast with an added audio channel, etc.), the portion of the multimedia may be played simultaneously with the mixed audio. It should be noted that any of the assigned audio files 405 also may be mixed with existing audio channels 622 and/or existing audio 632 of the multimedia file 610. For example, sound effects may have been added over, not in place of, the audio captured when recording a video on a cell phone.

Operation 1610 may adjust levels and/or priorities, for example in response to the preview of the mixed audio and groups thereof. The user 103 may have access to traditional audio editing, including within a software application usable for viewing and manipulating data from the event data structure 01 and associated audio files 405. The user 103 may then iteratively review, re-assign, adjust priority, mix, and/or preview the audio until satisfied.

Operation 1612 masters the mixed audio files 405 (e.g., one or more of the mixed audio file 1305 and/or a mixed audio file 1305 with one or more channels) into an audio master file 470. The audio master file 470 may be stored in association with the multimedia file 410 and/or event data structure 01. Operation 1614 may use the audio master file 470 to audio enhance the multimedia, for example as the new or additional audio channel for the multimedia file 610 in a production setting. As a result, an efficient, time-saving, and cost-saving process may have resulted in a final, usable audio master that enhances a multimedia file 410. The process may decrease time-to-production, decrease the cost, and/or increase the creative opportunities available to artistic directors, sound engineers, and others performing foley. Several of each of the above processes will now be further described in greater detail.

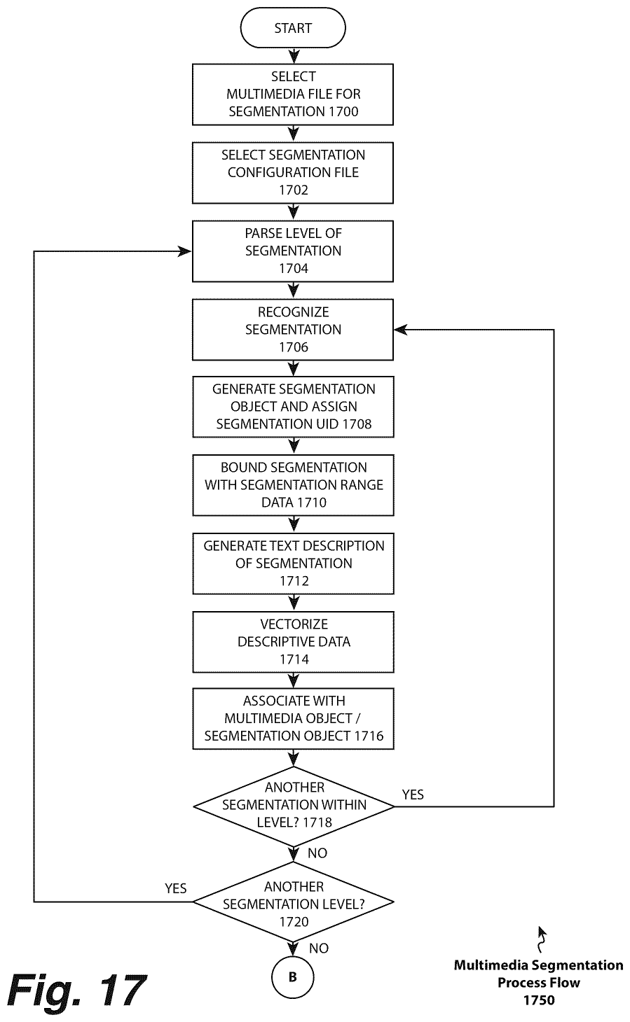

FIG. 17 illustrates a multimedia segmentation process flow 1750, according to one or more embodiments. Operation 1700 selects a multimedia file 610 for segmentation. Operation 1702 selects a segmentation configuration. For example, a segmentation configuration file may specify the number of levels or orders of organization, their names, or labels and how such levels are interconnected. The configuration may be automatically selected based on the multimedia and/or may be custom definable by the user 103 (the selectable levels or other structure may, in part, depend on available routines and models for recognizing, bounding, describing, and/or otherwise parsing segmentations). For example, a video file 410 may have a defined number of levels of organization depending on the length of the video (e.g., the multimedia object 70 and event objects 10).

Operation 1704 may parse a level of segmentation. For example, a highest order level of segmentation may be selected. In the example of film, scenes 94 may be the highest level of organization, according to one or more embodiments. Operation 1706 then recognizes each of the segmentations of the selected level of segmentation. In one or more embodiments, a model may be trained to recognize a segmentation through training the model with training data or retrievable example data that includes sections of the multimedia designated with the segmentations (e.g., a a video with scenes 94 designated) to effect supervised machine learning, as known in the art.

Operation 1708 generates a segmentation object for each recognized segmentation of the specified level (e.g., the segmentation object 50, or a segmentation object from another level of segmentation). Operation 1708 may also assign a unique identifier (e.g., a segmentation UID 131) to the segmentation object.

Operation 1710 bounds the segmentation with a segmentation range data (e.g., the segmentation range data 32). For video, bounding may occur through a graphical analysis routine that determines similarity in graphical aspects in time periods within the video to propose bounding, including for example a start time, duration, and/or end time. In one or more embodiments, boundaries also may be established through one or more trained models. In one or more embodiments, the model(s) may be trained to bound a segmentation through training data or access to retrievable examples that includes sections of the multimedia designated with the segmentations (e.g., video boundaries of shots) to effect supervised machine learning, as known in the art.

Operation 1720 may generate a text description of the segmentation. For example, the text description may include natural language, a human readable description, a summary, and/or one or more tags, according to one or more embodiments. In one or more embodiments, a model may be trained to describe a segmentation. The model may be trained with training data (or have access to retrievable example data) that includes segmentations and descriptions (e.g., video with scenes descriptions thereof) to effect supervised machine learning, as known in the art. In one or more other embodiments, it should be noted that a mathematical description and/or a temporal structure of the segment also may be generated or stored.

Operation 1714 may vectorize and/or embed vectors for descriptive data of a segmentation. For example, descriptive data generated in operation 1712 may be tokenized and converted into an array of values for use in efficient storage, retrieval, and model inputs. Operation 1716 may associate the segmentation object (e.g., the segmentation object 30 that was initialized, bounded, and/or described) with either a multimedia object 70 or a different segmentation object (e.g., a segmentation object 50). The association may occur through a database relation 03.

Operation 1718 determines whether another segmentation is present, or likely present, within the selected level of segmentation. If present, operation 1718 returns to operation 1706, which may then initiate a new loop for segmentation recognition, segmentation object initialization, bounding, and/or description. For example, if segmentation recognition is occurring sequentially in a multimedia file 610 with a timing, then operation 1718 may loop back to operation 1704 where additional time in the multimedia file 610 remains to be analyzed. If no additional segmentations are present (or likely present) on the current level of organization, then operation 1718 may proceed to operation 1720.

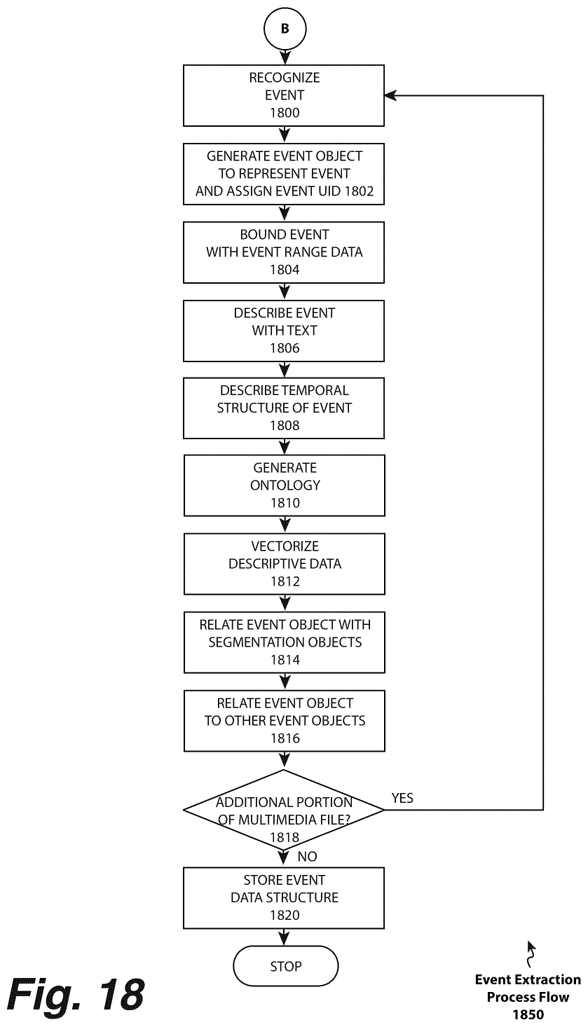

Operation 1720 may determine if another segmentation level is to be evaluated, in which case operation 1720 may return to operation 1704 to begin parsing a new level of segmentation. For example, where the multimedia file 610 is a video file 630, operation 1718 may proceed to operation 1720 when all scene objects 150 have been identified, then operation 1720 may return to operation 1704 to begin evaluating shot objects 130. The configuration file or other data may explicitly specify rules for segmentations. For example, a segmentation rule may establish that no shot 95 can span two scenes 94. Alternatively, or in addition, the process or sequence of segmentation may enforce such requirements, e.g., where each scene object 50 is first parsed, then each shot 95 is recognized wholly within the bounded scene 94. Once all segmentation levels have been evaluated, operation 1720 may terminate, or may proceed along path ‘Circle B’ to the embodiment of FIG. 18.

FIG. 18 illustrates an event extraction process flow 1850, according to one or more embodiments. The event extraction process flow 1850 may start at operation 1800, or may be a continuation of the process flow of FIG. 17, according to one or more embodiments.

Operation 1800 may recognize an event 96 depicted or otherwise presented within the multimedia file 610 or segmentation thereof. In one or more embodiments, one or more models may be trained to recognize the event 96. The model may be trained with training data (or have access to retrievable example data) that includes designed events to effect supervised machine learning of the models, as known in the art. Operation 1802 may generate an event object 10 to represent the event 96 and assign a unique identifier to the event object 10 (e.g., an event UID 11).

Operation 1804 may bound the event 96 with an event range data 12, for example a time range 13 and/or a frame range 14. Where time or frames are not applicable, another extent of time-series progress or a state advancement progress of the multimedia file 610 may be specified as a metric for bounding the event 96. In one or more embodiments, a model may be trained to bound the event 96. The model trained with training data (or have access to retrievable example data) that includes event boundary designations to effect supervised machine learning, as known in the art.

Operation 1806 may describe the event 96 with text, for example natural language text. The natural language text may include a human readable description. In one or more embodiments, a model may be trained to describe the event 96, the model trained with training data or having access to retrievable example data that includes events 96 and associated descriptions (e.g., video with events and descriptions thereof) to effect supervised machine learning, as known in the art. Similarly, operation 1808 may describe temporal structure of the event 96, for example its progression, extent as a function of time, cadence, periodicity, intensity, rate of change, and/or other temporal characteristics.

Operation 1810 may generate an ontology for the event 96. For example, an ontology may include a subject-object parse, and SRL parse, and/or a verb class parse. Operation 1812 may vectorize and/or embed vectors for descriptive data of an event 96 stored within the event object 10. For example, descriptive data generated in operation 1804 through operation 1810 may be tokenized and converted into an array of values for use in efficient storage, retrieval, and as model inputs (e.g., the model inputs 513). The vectors (e.g., the encoding vectors 26) may be stored in association with each event object 10.

Operation 1814 may relate each event object 10 to one or more segmentation objects (e.g., the segmentation object 30, the segmentation object 50) within the event data structure 01, for example through the event references 143. Similarly, operation 1816 may determine whether one or more event objects 10 should be related to one or more other event objects 10. Relations may be automatically detected and stored or proposed (e.g., for confirmation by a user 103). Such relations may include: an explicit reference to an event 96 that causes or is caused by another event 96; detection of two similar or identical events 96 (e.g., or events 96 that would have similar or identical sound); events 96 that have the same descriptive keywords in their descriptions or summary (or the same tags), etc.

Operation 1818 may determine if an additional portion of the multimedia file 610 has yet to be reviewed for events 96. If an additional portion remains to be reviewed, operation 1818 may return to operation 1800. Otherwise, operation 1818 may proceed to operation 1820, which may store the event data structure 01 and new event objects 10, according to one or more embodiments.

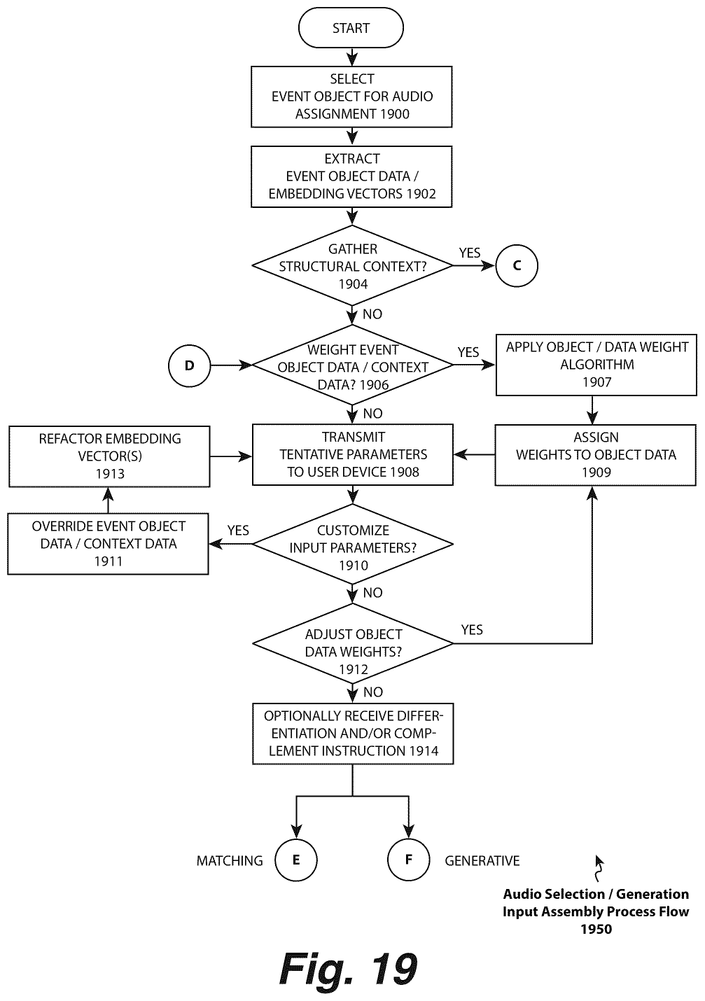

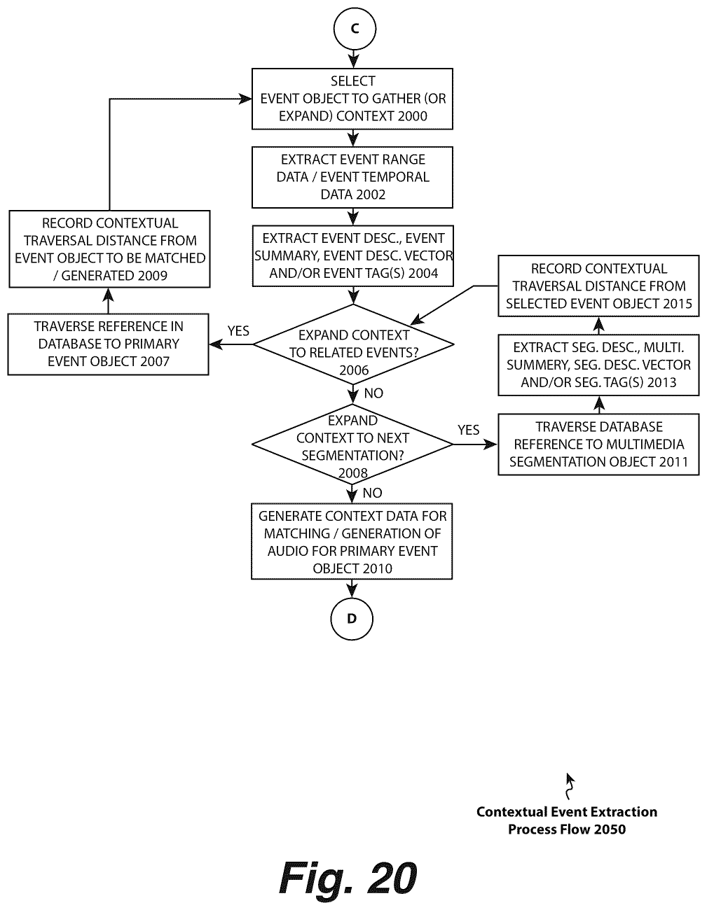

FIG. 19 illustrates an audio selection and/or generation input assembly process flow 1950, according to one or more embodiments. Operation 1900 selects an event object 10 for which to assign audio. Operation 1902 extracts descriptive data from the event object and/or encoding vectors 26. The descriptive data of the event object 10 may include, for example, event tags 15, an event description data 16, an event summary data 17, and/or an event ontology data 18. Operation 1904 may then determine if a structural context should be gathered for the event object 10, for example other descriptive data of other data objects proximate to (or related to) the event object 10 within the event data structure 01. If structural context is to be used, operation 1904 may proceed along path ‘Circle C’ to the embodiment of FIG. 20 (once context is gathered, the process flow of FIG. 20 may return along path ‘Circle D’ to operation 1906). Otherwise, if no structural context is to be gathered, operation 1904 may proceed to operation 1906.

Operation 1906 may determine whether to weight an importance of the event object data and/or context data (if applicable). If weighting is to occur, operation 1906 may proceed to operation 1907, which may apply an object and/or data weight algorithm to determine and apply contextual weights 702. Weights may be applied to all data of the data object, individual attributes or groups of attributes of the data object, and/or categories of data across data objects (e.g., all summaries, all tags, etc.). For example, an automatic process or the user 103 may desire to place a relatively high weight on the event description data 13 and the event ontology data 18, and a relatively low weight on the event tags 15 and the event summary 17. In one or more other embodiments, an automatic process may systematically assign or randomly assign weights to the descriptive data of the event object 10 and/or the context data 700 to create varying results in matching and/or generating audio. Operation 1909 may then assign contextual weights 702 to the descriptive data of the event object 10 and/or the context data 700 (if applicable). In one or more embodiments, individual items of the event object data, or relevant portions of embedded vectors thereof, may be separately weighted. Operation 1909 may then proceed to operation 1908.

Operation 1908 may transmit tentative parameters (e.g., potential model inputs 513 or match criteria) to the user 103, e.g., on the client device 102. For example, the user 103 may use the multimedia audio enhancement application 280 to review the tentative or proposed submission and criteria thereof for matching or generation. Operation 1910 determines whether the tentative parameters should be customized, in which case operation 1910 proceeds to operation 1911. Operation 1911 may then override the descriptive data of the event object 10 and/or the context data 700. As just one example, there may be a particular word or event tag 15 within the event object 10 or context data 700 that the user 103 does not wish to include, either because the user 103 knows or suspects the matching or generative process will be less likely to yield an accurate or desired audio file 405. For example, despite a depicted explosion, the explosion may take place in outer space where there is no atmosphere. The user 103 and/or an artistic director may therefore desire a different auditory effect that may balance realism due to the lack of sound bearing medium with audience expectation of some form of sound. The user 103 may also add data (e.g., more keywords or description to assist in prompt engineering for a model), and/or delete data. Operation 1911 may then proceed to operation 1913, which may refactor any encoding vectors 26 based on the new or overwritten data, before returning to operation 1908.

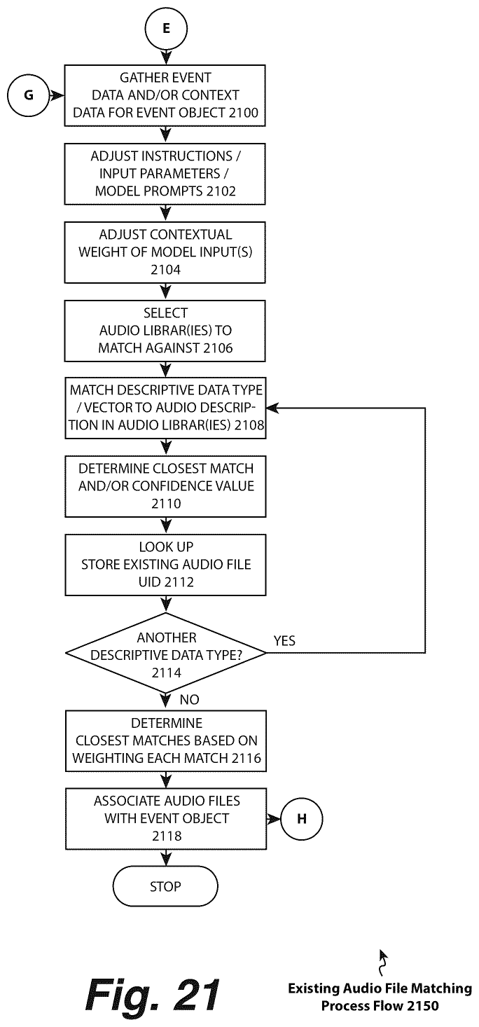

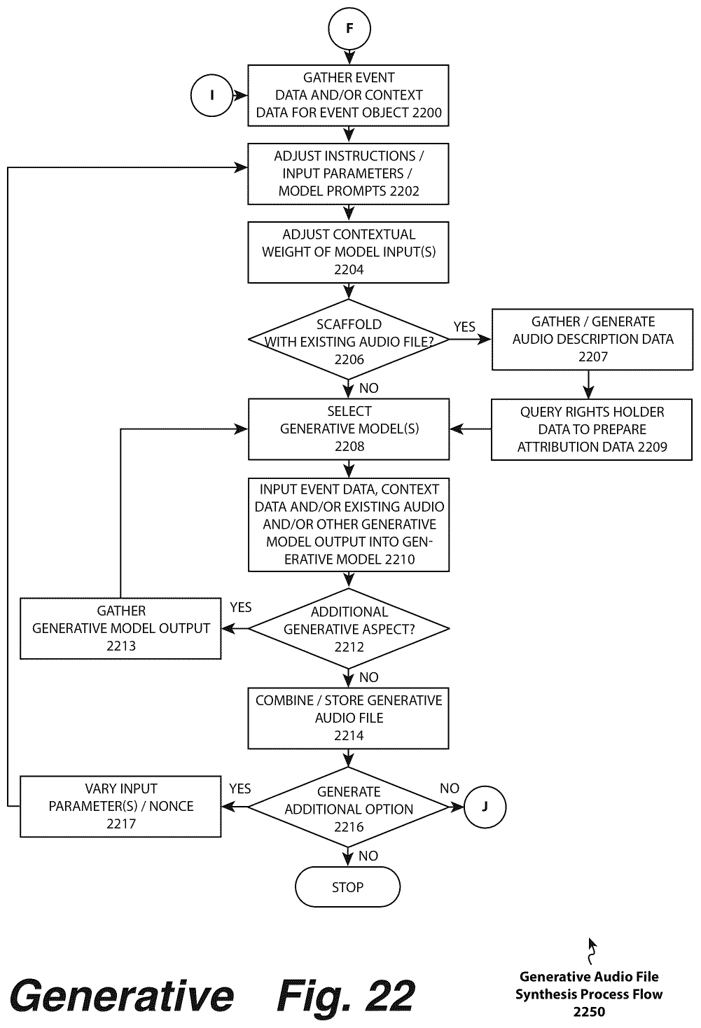

Once the user 103 has completed customization, operation 1910 may proceed to operation 1912, which may determine again whether any contextual weights 702 of descriptive data of the event object 10 and/or any context data 700 should be updated, in which case operation 1912 returns to operation 1909. If all contextual weights 702 appear to be set at appropriate values, operation 1912 may proceed to operation 1914, which may optionally receive a differentiation and/or complementary instruction with reference to one or more other segmentation objects (e.g., the segmentation object 130) and/or event objects 10. For example, an imperative relation may be followed from the selected event object 10 to one or more other event objects 10, for example an identity imperative 1202 or a similarity imperative 1204. Alternatively, or in addition, it should be noted, imperative relations and data objects they point to may be part of context data 700 gathered in the process of FIG. 19 and returned to aid in the matching or generative audio process. In such case, the imperative data also may be contextually weighted. Operation 1914 may then proceed upon path ‘Circle E’ to FIG. 21 in order to match audio and/or along path ‘Circle F’ to FIG. 22 in order to generate audio, according to one or more embodiments. In one or more embodiments, selection of one or more paths may be followed, or the user 103 may select whether to match or generate the audio. In one or more other embodiments, one approach may be first attempted before switching to another. For example, if attempted matches against an existing audio file 410 are insufficient (e.g., resulting in low confidence scores), the audio may be generated through one or more of the generative models 520, according to one or more embodiments.

FIG. 20 illustrates a contextual event extraction process flow 2050, according to one or more embodiments. The process flow of FIG. 20 may initiate at operation 2000, or may be a continuation along path ‘Circle C’ from the embodiment of FIG. 19. Operation 2000 may select an event object 10 to be evaluated for context. Initially, this may be the event object 10 selected for audio matching and/or generation (referred to in this example as the “primary event object 10”, which may be the same event object 10 selected in operation 1900). In subsequent loops, as context expands, operation 2000 may select additional and different event objects. Operation 2002 may extract an event range data 12, an event temporal data 25 from the event object 10 selected in operation 2000, and/or any temporal description vector(s) 28 thereof. Operation 2004 may similarly extract event tags 15, the event description data 16, the event summary data 17, and/or event description vector(s) 27 thereof. In one or more embodiments, operation 2002 and operation 2004 may be dispensed with for the primary event object 10 for which audio is to be matched or generated, if such data was already extracted in operation 1902.

Operation 2006 may determine whether to expand context to additional related event objects 10, in which case operation 2006 may proceed to operation 2007 which may traverse a reference (e.g., an event reference 23) to another event object 10. The event UID 11 for each event object 10 may be stored and each separately traversed. This may potentially create a branching and widening set of expanding options for extraction and possible further widening. In one or more embodiments, the traversal may be a causal relation and/or an imperative relation. Operation 2007 may then proceed to operation 2009, which may record the contextual traversal distance from the primary event object 10 for which matching and/or generation is to occur. For example, the immediate event objects 10 that reference and/or are referenced by the primary event object 10 may be referred to as “secondary event objects” relative to the primary event object 10. Operation 2009 may then return to operation 2000 which may select the event object 10 traversed to which operation 2007 traversed. This may initiate a loop for extracting descriptive data in the new event object 10. Likewise, each event reference 123 of the primary data object 10 may be selected and descriptive data extracted in the loop that includes operation 2000, operation 2002, operation 2004, operation 2006, operation 2007, and operation 2009. As will be recognized, it is also possible to follow event references 23 from the secondary event objects 10 to tertiary event objects 10, from tertiary event object 10 to quaternary event objects 10, etc.

Upon gathering all relevant context with respect to an event object 10 (e.g., primary, secondary, tertiary, or otherwise), operation 2006 may proceed to operation 2008, which may determine whether to expand context to a next segmentation. Referring to the embodiment of FIG. 1C, expanding to a segmentation may include a traversal within the data structure 01 from the current event object 10 up to an immediately embracing segmentation object (e.g., from the event object 10 to the segmentation object 30). Operation 2011 may traverse a database reference either from or to the event object 10 to the segmentation object 30. Operation 2023 may then extract the descriptive data for the segmentation object, for example the segmentation tag (e.g., the segmentation tag 35), the segmentation description data (e.g., segmentation description data 36), the summary data (e.g., the segmentation description data 37), and/or any encoding vectors thereof (e.g., the encoding vector 46). Although not shown, temporal data for the segmentation also may be optionally extracted. Operation 2015 may then record a traversal distance from the primary event object 10 and return to operation 2006.

In one or more embodiments, operation 2006 can again proceed to operation 2007 to begin determining each event object 10 referenced by the segmentation. However, in one or more other embodiments, operation 2006, operation 2008, operation 2011, operation 2013, and operation 2015 may continue to loop, which may continue to increase the traversal “height” within the levels of organization of the data structure 01 until the multimedia object 70 or another root 89 is reached. The multimedia object 70 may be treated as a segmentation for purposes of operation 2011, operation 2013, and operation 2015, and therefore may have descriptive data extracted and included within the gathered context.

Numerous algorithms or processes may determine how much contextual expansion is prescribed. For example, in one or more embodiments, there may be a traversal proximity threshold that may gather all context within up to two database traversals. In another example, only any embracing or “upstream” segmentation, along with any immediately related event objects 10, are gathered. In yet another example, expansion may occur conditionally, for example if certain keywords or imperatives are encountered. In one or more embodiments, the structure of relations to the primary event object 10 also may be stored, which may have relevancy to how contextual weight 702 may be applied to each data object and/or its descriptive data in operation 1907 and/or operation 1909.

After all relevant context has been gathered, operation 2008 may proceed to operation 2010, which may generate a context data 700 for use in matching and/or generation of audio for the primary event object 10. Operation 2010 may then terminate, or return to the process flow of FIG. 19 along path ‘Circle D’.

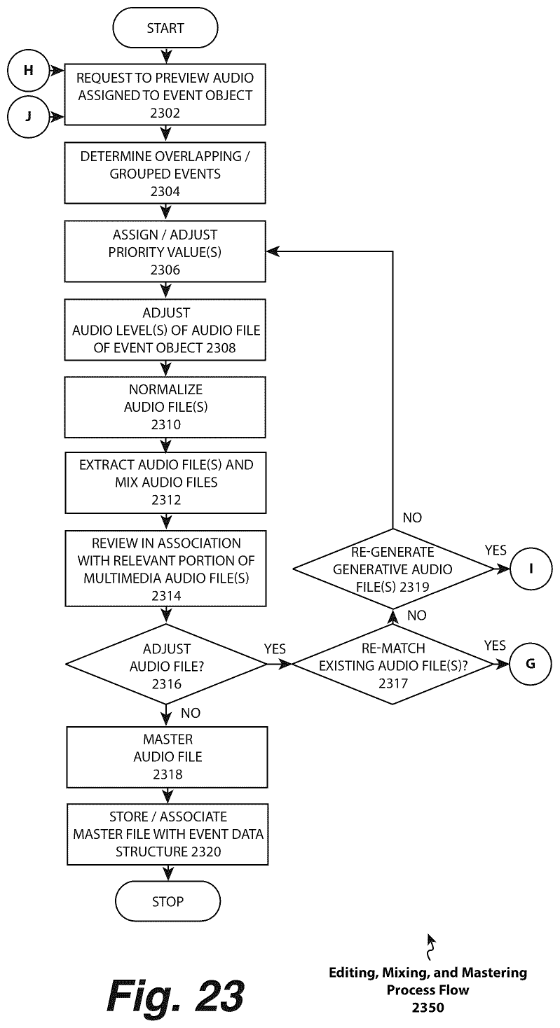

FIG. 21 illustrates an existing audio file matching process flow 2150, according to one or more embodiments. Operation 2100 gathers event data from an event object 10 (e.g., descriptive data from the event object 10 for which audio is to be matched) and/or context data 700 for that event object 10. In one or more embodiments, operation 2100 may continue the process flow of FIG. 19 along path ‘Circle E’ and/or continue the process flow of FIG. 23 along path ‘Circle G’.

Operation 2102 may adjust one or more input parameters and/or model prompts for matching. Such adjustments may or may not update the event object 10 or its data within the data structure 01. For example, the user 103 may desire wide latitude to modify inputs and find potential matches without updating any of what may be the “raw” data of the event object 10. Instructions, input parameters, and/or model prompts may be separately logged or stored in association with each matched instance of the existing audio file 410. Operation 2104 may adjust one or more contextual inputs 702. Alternatively, operation 2104 may be dispensed with if sufficient adjustment was completed in operation 1909.

Operation 2106 may select one or more audio libraries 411 against which to match the event object 10 and/or its context data 700. The audio libraries 411 may be automatically and/or manually selected. For example, the user 103 may select both a personal collection of foley sound effects, studio's collection, and/or a huge audio library with individually licensable audio files offered by an enterprise managing rights on behalf of many copyright holders and/or artists.

Operation 2108 may then match descriptive data type (e.g., text, summary, tags, temporal description, etc.) against one or more descriptions of audio. In one or more embodiments, each type of data may be separately matched such that a separate confidence for the type of match may be determined (e.g., summary or name of the event object 10 to summary or name of the existing audio file 410). In one or more embodiments, a data map may be used in which descriptions of each existing audio file 410 are associated with an identifier of each audio file 410, such as an audio UID 415. Optionally, a separate map may occur for each data type (e.g., a map for summaries or file names; a map for descriptive data; a map for temporal data, etc.). In one or more embodiments, a method for comparison may include matching encoding vectors 126 of the event object 10 and/or within the context data 700 against an audio description vector 427 and/or a temporal vector 428 of the existing audio file 410. In one or more embodiments, a separate encoding vector may be prepared for each data type.

Operation 2110 may determine a closest match and/or an associated confidence value for the match of the given data type. One or more methods known in the art may be used to determine closeness of a match in a natural language search and/or temporal data comparison. In one or more other embodiments, confidence values may be generated for vector matches using one or more methods known in the art of computer science, machine learning, software development, and/or software engineering. Context weights 702 of each data type, or other factors, may be used in matching, and/or determining the confidence value. One or more (e.g., several) top matches may be selected for potential use, according to one or more embodiments. Operation 2112 may then look up or otherwise determine an identifier such as the audio file UID 415 for each matched existing audio file 410.

Operation 2114 may determine whether another descriptive data type should be matched. If another descriptive data type should be matched, operation 2114 may return to operation 2108. Otherwise, if all data types have been matched, operation 2114 may proceed to operation 2116.

Operation 2116 may determine a closest match based on weighting each data type match. For example, a high confidence score in describing a match between the event description data 116 and the audio description 413 may be offset by a weak confidence score describing the temporal data 26 of the event object 10 and the temporal data 124 of the existing audio file 410. As a result, a collection of the best overall matching audio files 405 may be established. Data of how each type was weighted may be maintained, for example such that the user 103 may be able to sort or filter by data type match. For instance, the user 103 may desire to find a sound with a strong match for temporal structure rather than focus on description, especially if the user 103 may use the temporal structure as a scaffold for the temporal structure of a generative audio file 430, according to one or more embodiments. Operation 2118 may then associate one or more existing audio files 405 with the event object 10, for example an automatically selected existing audio file 410 that will be used without further review, or one or more instances of the existing audio file 410 intended for preview, re-matching, re-generation, selection, and/or level adjustment. Operation 2118 may terminate, or return to the process flow of FIG. 23 along path ‘Circle H’.

FIG. 22 illustrates a generative audio file synthesis process flow 2250, according to one or more embodiments. Operation 2200 may initiate the process flow of FIG. 22, or may be a continuation from the process flow of FIG. 19 along path ‘Circle F’ and/or FIG. 23 along path ‘Circle I’. Operation 2200 gathers event data from an event object 10 and/or context data 700 for the event object 10.

Operation 2202 may adjust one or more input parameters and/or model prompts for generation. Similar to operation 2102, adjustments may or may not update the event object 10 or its data within the data structure 01. For example, the user 103 may want wide latitude to modify or experiment with model input 513 without permanent updates to the event object 10. Instructions, input parameters, and/or model prompts may be separately logged or stored in association with each matched instance of the existing audio file 410. Operation 2204 may adjust a contextual weight (e.g., the context weight 702) of one or more model inputs 513. In one or more embodiments, operation 2204 may be dispensed with if any edits to contextual weight occurred in conjunction with operation 1907 and/or operation 1909.

Operation 2206 may determine whether to scaffold an audio generation process with an existing audio file 405. For example, in one or more embodiments, the scaffold may be extracted or prepared from an existing audio file 405, including descriptions of temporal aspects. If a scaffold is to be used, operation 2206 may proceed to operation 2207, which may gather and/or generate a temporal structure 425 of an audio file 405 (e.g., an existing audio file 410 and/or a previously generated instance of the generative audio file 430). Operation 2209 may then optionally query rights holder data 1000 for preparation of an attribution data 1004, and then return to operation 2208.

Operation 2208 may select a generative audio model 520 for generation of the audio. For example, operation 2208 may select a generative audio model 520 that specializes in the type, category, or context for which generation of the generative audio file 430 is to occur. As just one example, a generative audio model 520 might be selected for sounds occurring in a certain setting depicted in the multimedia, such as a battlefield, a sports arena, or a hospital. In one or more embodiments, operation 2208 may alternatively, or in addition, select augmentation data that specializes the generative audio model 520 by supplementing the data available to it. For example, the user 103 may point the generative audio model 520 to a RAG file matching one or more characteristics with the descriptive data of the event object 100 or its context data 700. In one or more embodiments, portions of the generative audio file 410 may be generated separately or sequentially. For example, a first generative model 520 may generate a temporal structure such as may be similar in data structure to the temporal structure 25, and a second generative model 520 may apply additional sound to the temporal structure.

Operation 2210 may input some or all inputs into the generative model 520, depending on the model arguments 521 for the particular generative model 520. The input may also include the output of one or more generative audio models 520 in future loops of operation 2208, operation 2209, operation 2210, and operation 2213. The output then may be collected from the generative model 520. The output may include the entire generative audio file 430, or may include just one aspect of the generative audio file 430 that will be further combined, used as input to another generative audio model 430, and/or otherwise processed to contribute to the generative audio model 430.

Operation 2212 determines whether an additional generative aspect remains which is required or advantageous to create for the generative audio file 430. If additional generative aspects are to be generated, operation 2212 may proceed to operation 2213, which may gather a generative model output from the generative audio model 430 just applied, then return to operation 2208. Operation 2008 may then select another generative audio model 520, and/or the next generative audio model 520 in a sequence or model pipeline. If no additional generative aspect needs to be generated, operation 2212 may proceed to operation 2214. Operation 2214 may combine multiple generative aspects generated by two or more generative audio models 530, if applicable. Following any combination or synthesis, operation 2214 may store the generative audio file 430, for example in the generative library 431 and/or in association with the event object 10.

Operation 2216 may determine whether an additional generative option should be generated, in which case operation 2216 may proceed to operation 2217. Operation 2217 may vary one or more input parameters (randomly, systematically, or through prompting for the user 103 to make manual changes). In one or more embodiments, a nonce may be added in such cases where a random number or value may influence the generative process of one or more generative models 520. Alternatively, rather than vary input parameters, a different set of generative models 520 and/or a different generative pipeline may be used to generate alternative instances of the generative audio file 430, according to one or more embodiments. The number of options generated and stored may include a set number (e.g., four generative options), may include a user preference, and/or may depend on detected aspects or data of the event object 10 or its context 700. If no additional operations are to be generated, operation 2216 may terminate, or return to the process flow of FIG. 23 along path ‘Circle J’.

FIG. 23 illustrates an existing, mixing, and/or mastering process flow 2350, according to one or more embodiments. The process flow of FIG. 23 may initiate at operation 2303, or by a continuation from the process flows of FIG. 21 and/or FIG. 22. Operation 2302 may receive a request to preview audio assigned to an event object 10, for example an audio file 405 such as the existing audio file 410 and/or the generative audio file 430. The request may have been generated by the user 103, for example with the multimedia audio enhancement application 280 installed on or accessible as software-as-a-service (SAAS) through the client device 102.

Operation 2304 may determine if there are any overlapping and/or grouped events 96, for example represented by event objects 10. The overlapping and/or grouped events, other than the selected event object 10, may be referred to in this example as the ancillary event objects 10. Overlap may be determined based on temporal overlap for a multimedia file 610 that advances with time, may be determined by overlapping states for a multimedia file 610 that advances with state (e.g., as a forward moving state machine), and/or based on overlapping conditions for a multimedia file 610 that may trigger audio based on one or more sensed conditions. In one or more embodiments, a group of related event objects 10 may be selected, as shown and described herein (e.g., an event group 1200).

Operation 2306 may assign priority values 1324 and/or adjust priority values 1324 assigned to each of one or more event objects 10. Priority may be automatically assigned according to a ruleset or algorithm, for example providing a score to various keywords, ontologies or ontological elements (e.g., a subject), and/or other descriptive or relational aspects within the data structure 01. The user 103 may also manually adjust priority. Operation 2308 may adjust one or more audio levels of an audio file 405 assigned to the event object 10. For example, the audio levels may be automatically adjusted as a result of priority values 1324, and/or manually adjusted by the user 103. Operation 2310 may normalize the audio files 405, for example to automatically establish headroom within the audio files 405 and/or prevent clipping.

Operation 2312 may automatically extract the audio files 405 associated with each ancillary event object 10 to be previewed with the selected event object 10. Operation 1310 may also mix the audio files 405 such that they can be previewed, e.g., as the mixed audio file 1305. In addition, any other audio that will be overlaid or played alongside the audio files 405 may be mixed, for example, one or more audio channels 622. Operation 2314 may then extract a relevant portion of the multimedia file 610 corresponding to the mixed audio file 1305 and simultaneously play the portion of the multimedia file 610 and the mixed audio file 1305. That the user 103 therefore is enabled to easily check audio alignment, appropriateness, artistic quality, imperative veracity, and/or other aspects.

Operation 2316 determines whether additional adjustments are required to the audio file 405 for the selected event object 10, in which case operation 2316 may proceed to operation 2317. For example, operation 2316 may depend on the acceptance of a user 103 reviewing and previewing and reviewing the sounds associated with the events 96 within the multimedia audio enhancement application (e.g., reviewing and previewing the audio files 405 associated with the event objects 10). If additional adjustments are to be made, operation 2318 may proceed to operation 2317. Operation 2317 may determine if re-matching is to be performed, in which case operation 2317 may proceed to the process flow of FIG. 21 along path ‘Circle G’, and otherwise advance to operation 2319. Similarly, operation 2319 may determine if the audio file 405 should be re-generated, in which case operation 2319 may proceed to the process flow of FIG. 22 along path ‘Circle I’. Otherwise, operation 2319 may return to operation 2306 where direct edits in priority, audio, and other aspects may be made to the existing audio file 405.

Once an existing audio file 405 is accepted for an event object 10, the process may be repeated for each event object or group of event objects 10 until all assigned audio files 405 may have been confirmed. Operation 2318 may then master the confirmed audio files 405 and/or mixed audio files 1305 to form an audio master file 470, for example as known in the art of sound engineering and according to common industry practices. Other sources or types of audio also may be mixed in and mastered, such as existing audio channels 622. Finally, operation 2320 may store the audio master file 470 (e.g., in a master database 471), including with a new UID 473. The audio master file 470 then may be associated with the multimedia file 630 (e.g., through the multimedia file reference 72) and/or to the data structure 01 (e.g., through the event structure reference 472), according to one or more embodiments. Following operation 2320, the multimedia file 630 and the audio master file 470 may be usable together as a production quality audio enhanced multimedia file 630.

FIG. 24 illustrates a working example comprising a user interface of the multimedia audio enhancement application 280, according to one or more embodiments. FIG. 24 illustrates a graphical user interface (GUI) through which the user 103 may view data in the data structure 01, and modify the data (e.g., re-bound the event range data 12). Future examples may include capability to preview audio files 405 (for preview, approval, rejection, and/or mixing), synchronize and align audio files 405, and/or perform additional actions. A media viewer (e.g., similar to the media viewer 1102 of FIG. 12) in the upper center of the GUI may be used to display a portion of the video file 620 relevant to editing. Under the media viewer, a time bar (e.g., similar to the time bar 1104 of FIG. 11) may display graduations of time.

Below the time bar is an event viewer is shown (e.g., similar to the event viewer 1106 of FIG. 11) in which graphical elements representing events 96 may be arrayed horizontally to represent time (e.g., in alignment with the time bar) and vertically spaced for visual clarity and/or to show any overlap. The horizontal alignment may correspond with the time range 13 of each event object 10, and may be editable by dragging either end of the GUI element. A toolbar (e.g., similar to the toolbar 1108 of FIG. 11) may be set on the left edge of the GUI. On the right side of the GUI, a vertical event editor (e.g., similar to the event editor 1110 of FIG. 11) may list events 96 and display details of events 96 in each of several event windows (e.g., similar to the event windows 1112 of FIG. 11), the data of which may be queried from the event objects 10. Each event window 1112 may select or preview existing audio files 410, and/or edit event description data 16. Each of the events generated in the working example of FIG. 24 were prepared through model recognition, bounding, and description of events 96.

Specifically, FIG. 24 illustrates extracting events from a video of a person manipulating a hinge (e.g., in a continuous shot), which in each major phase of the manipulation is described as an event. Adding audio to such a video may help to add interesting and theme-reinforcing sound effects to the interaction and manipulation of the hinge. This may be useful, for example, in a product marketing video to instill a feeling of tight tolerances and/or well-machined components. Added audio may therefore help accentuate the product qualities, including sounds otherwise not capturable in the video, and therefore improve sales. The user 103 may be able to edit descriptions to assist in matching and/or generating audio to properly fit their commercial and/or artistic requirements.

One or more embodiments herein describe a multimedia audio enhancement system, device, method, and computer readable media. One or more embodiments herein describe multimedia segmentation and/or event extraction through descriptive, temporal, and/or contextual analysis of a multimedia file and data structure derived therefrom. In an embodiment, a computer readable media that is physical and non-transitory includes a data structure for efficient audio matching and/or audio generation for a multimedia file. The data structure includes a multimedia object as a root of the data structure. The multimedia object includes a multimedia object UID, a multimedia file reference to the multimedia file, a multimedia data (including a multimedia description data, a multimedia summary data, and/or a multimedia tag), and/or a multimedia structure data that includes a first segmentation object reference storing a first segmentation object UID.

The data structure further includes a first segmentation object of a first order segmentation referenced by the first segmentation reference. The first segmentation object includes the first segmentation object UID. The first segmentation object also includes a segmentation description data of the first segmentation object, a segmentation summary data of the first segmentation object, and a segmentation tag of the first segmentation object.

The data structure may also include a first event object referenced by the first segmentation object and/or one or more other segmentation objects referenced by the first segmentation object. The first event object includes an event UID of the first event object and an event range data specifying a range over which an event of the first event object occurs within the multimedia file. The event object also includes an event description data of the first event object that includes an event description data of the first event object, an event summary data of the first event object, and/or an event tag of the first event object. The event ontology data of the first event object includes a subject-object parse of the first event object, a verb class data of the first event object, and/or a semantic roll label data of the first event object.

The first event object may further include a description vector of the first event object that encodes the event description data, the event summary data of the first event object, the event tag of the first event object, and/or the event ontology data of the first event object. The first event object may also include a temporal vector of the first event object that encodes the event range data. The first segmentation object may further include a description vector of the segmentation object that encodes the segmentation description data of the first segmentation object, and/or a segmentation tag of the first segmentation object.

The data structure may further include a second segmentation object of a second order segmentation. The second segmentation object may include a second segmentation UID, a segmentation description data of the second segmentation object, a segmentation summary data of the second segmentation object, and/or a segmentation tag of the second segmentation object. The one or more other segmentation objects referencing the first event object may include the second segmentation object.

The data structure may further include a second event object that includes an event UID of the second event object. The second event object may be referenced by the first event object and/or the second segmentation object such that the second event object can be defined to be and/or determined to be a related event to the event modeled by the first event object.

The first event object may further include a priority value of the first event object specifying a global priority, a local priority within a segmentation order, and/or a local priority among two or more event objects within a temporal proximity threshold. The second event object may include a priority value of the second event object such that query to the first event object and/or the second event object can resolve a priority between the event of the first event object and an event of the second event object.

The multimedia file may be a video file, the root that comprises the multimedia object may represent a video, the first order content segmentation may model a scene, and a second order segmentation may model a shot. Alternatively, the multimedia file may be a video game, the root that comprises the multimedia object may model a game subject, the first event object may represent an action and/or reaction performed by the game subject. Alternatively, the multimedia file may represent a text file, the root that comprises the multimedia object may represent a narrative text, the first order content segmentation may represent a chapter, and a second order segmentation may represent a paragraph and/or scene.

A method for storing and defining above data structure are contemplated herein, as is a system comprising computer readable instructions stored on a physical, non-transient computer readable medium that when executed perform the method to define, store, and perform other actions herein described with respect to the data structure.

One or more embodiments herein describe multimedia enhancement through matching, generation, and/or alignment of audio with an event of a multimedia file. One or more embodiments herein describe a system, device, and/or method may include context-aware multimedia audio enhancement through segmentation, event extraction, and adaptive audio matching and/or generation. In one or more embodiments, a method for enhancing a video file with audio includes: (1) selecting an audio library comprising a plurality of audio files each comprising an audio UID; (2) at least one of generating and extracting an audio description of each of the plurality of audio files within the audio library; (3) at least one of generating and extracting a time length of each audio file; (4) embedding a description vector of each audio file with the audio description of each audio file; (5) embedding a temporal vector of each audio file with the time length of each audio file and a temporal structure; (6) generating a library description map associating for each audio file (i) the description vector of each audio file, (ii) the temporal vector of each audio file, and (iii) the audio UID of each audio file; and (7) connecting the library description map to a large language model. In this embodiment, the library description map is connected to the large language model through storage in a retrieval augmented generation file. The method includes (8) selecting an event object linked through at least one of a database reference to a video object associated with a video file; (9) extracting from the event object at least one of an event description data, an event summary data; (10) extracting from the event object an ontology data comprising at least one of a verb class data and a semantic roll label data; (11) determining from the event object a time range; (12) inputting into the large language model a match instruction along with input comprising an encoding vector comprising: (i) at least one of the event description data and the event summary data, (ii) the ontology data, and (iii) the time range; (13) and determining a minimum vectorspace distance between the encoding vector and a description vector of a first audio file or the plurality of audio files. The minimum vectorspace distance may be calculated based on at least one of Euclidean distance, dot product, Manhattan distance, an/or cos distance. The method may then (14) determine the audio UID of the first audio file through association with the description vector of the first audio file; (15) output an audio UID of the first audio file and a confidence value of a match between the encoding vector and the description vector of the first audio file, and (16) storing the audio UID of the first audio file in association with the event object. The confidence value may be proportional to the minimum vectorspace distance.

The method may also include (17) inputting into a generative audio model a generative instruction along with an input of the generative audio model comprising at least one of: (i) at least one of the event description data and the event summary data, (ii) the ontology data, and (iii) the time range; (18) outputting a second audio file from the audio generation model; (19) generating an audio UID for the second audio file; and/or (20) storing the second audio file in association with the event object.

The method may further include (21) traversing a database reference between the event object and a multimedia segmentation object; and (22) extracting at least one of an encoding vector of the multimedia segmentation object, a multimedia segmentation description data, a multimedia segmentation summary data, and a multimedia segmentation tag to gather a descriptive context for generation of audio for an event modeled by the event object. A model input of the large language model may further comprise at least one of the multimedia segmentation description data, the multimedia segmentation summary data, and the multimedia segmentation tag. A model input of the generative audio model may further comprise at least one of the multimedia segmentation description data, the multimedia segmentation summary data, and the multimedia segmentation tag.

The method may also include (23) traversing a database reference between the multimedia segmentation object and the video object; (24) extract at least one of an encoding vector of the video object, a video description data, a video summary data, and a video tag; (25) generating a context data comprising data extracting from the event object, data extracting from the multimedia segmentation object, and data extracting from the video object; and (26) import the context data into at least one of a context window of the generative audio model and an argument of the generative audio model.

In addition, the method may include (27) extracting a context weight value of the multimedia segmentation object; and (28) extracting a context weight value of the video object. A context weight of the event object, the context weight of the multimedia segmentation object, and the context weight of the video object may decrease with each referential distance from the event object. The method may further include (29) generating the second audio file based on the referential distance from the event object; (30) overriding at least one of the event description data, the event summary data, the time range, the multimedia segmentation description data, the multimedia segmentation summary data, the multimedia segmentation tag, the video description data, the video summary data, and the video tag with a first user modification; and (31) overriding at least one of the context weight of the event object, the context weight of the multimedia segmentation object, and the context weight of the video object with a second user modification.

Still further, the method may include (32) extracting a portion of one or more existing audio channels associated with the video file associated with the video object; (33) inputting the portion of the one or more existing audio channels into an audio description model; and (34) outputting an audio description of the portion of the one or more existing audio channels. The portion of the existing audio channel may be extracted within the time range of the event object. The model input of the large language model may further comprise the audio description of the portion of the existing audio channel. The model input of the generative audio model may further include the audio description of the portion of the existing audio channel.

The method may also include (35) extracting at least one of the first audio file and the audio description of the first audio file from the audio library. The model input of the generative audio model may further comprise the audio description of the first audio file. The method may also include (36) storing the audio UID of the first audio file in association with the UID of the second audio file to track a creative contribution of at least one of an artist of the first audio file and a rights holder of the first audio file; (37) extracting an encoding vector from a different event object; and (38) determining a contrast imperative for the audio of the event object relative to the different event object. The model input of the generative audio model may further comprise a contrast instruction associated with the encoding vector of the different event object, and the multimedia segmentation object may comprise a scene segmentation object.

The immediately preceding method for enhancing a video file with audio may be implemented as executable computer readable instructions stored on a non-transitory, computer readable media, that when executed perform each step of the method. Similarly, the computer readable instructions may be stored on and executed by one or more computers, including server computers, as shown and described herein.

One or more embodiments here describe multimedia event audio enhancement through contextual prioritization relative to other event audio and/or refined audio matching, alignment, and/or re-generation. In an embodiment, a method for mixing audio to enhance video includes (1) selecting a video file; (2) querying an object datastore storing on a non-transitory computer readable media a data structure comprising: (a) a video object associated with a video file, (b) a plurality of database references drawn to a set of two or more event objects modeling events within the video file, the plurality of database references drawn (i) directly from the video object and (ii) indirectly from the video object through one or more segmentation objects, and (c) a plurality of database references to two or more audio files associated with each of the two or more event objects for generating audio matching an event modeled by each of the two or more event objects.

The method includes (3) traversing the plurality of database references to the set of two or more event objects; (4) extracting event range data comprising a start time and a duration for each of the events modeled by each of the two or more event objects; (5) retrieving the two or more audio files associated with each of the two or more event objects modeled by each of the two or more event objects; (6) displaying to a user a graphical event element representing each of the events modeled by the two or more event objects; (7) receiving from the user a sound preview request for a first event object that the user selected from the set of two or more event objects; (8) querying a video object referencing the first event object; (9) traversing a reference from the video object to a second event object of the two or more event objects referenced by the video object; (10) determining an event range data of the first event object overlaps within the video file with an event range of the second event object; (11) loading a first audio file associated with the first event object and a second audio file associated with a second event object; (12) mixing the first audio file and the second audio file; and (13) initiating playback of the audio file of the first event object and the audio file of the second event object overlapping the first event object. The playback is in association with a first video clip of the video file spanning a union of the event range data of the first event object and the event range data the second event object to generate a synchronized audio-visual preview of overlapping events that assists the user in at least one of (i) coordinating the first audio file with the video file, (ii) selecting a priority value for the first event object associated with the video file, and (iii) selecting a different audio file to replace the first audio file.

The method may further include (14) extracting from each of the two or more event objects at least one of an event description data, an event summary data, an event tag, and an ontology data; (15) applying a prioritization algorithm assigning, to each of the two or more event objects, a priority value of the two or more event objects based on factors comprising at least one of a subject, the event description data, the event summary data, the event tag, and the ontology data; and (16) determining a priority value of the first event object and a priority value of the second event object. The priority value of the first event object may be greater than the priority value of the second event object. The method may include (17) assigning a scaling function to at least one of a first waveform of the first audio file and a second waveform of the second audio file. The scaling function may be at least one of an amplification function of the first waveform and an attenuation function of the second waveform.

Still further, the method may include (18) receiving an updated event range data for the first event object specified by the user; (19) extracting a second video clip of the video file specified by the updated event range data; (20) generating a training data package comprising the second video clip, the updated event range data of the first event object, and the first audio file of the first event object; (21) automatically overriding the training data package following further update to the event range data for the first event object; (22) training an event range determination model comprising an artificial neural network that receives as a model input of the event range determination model the video file and outputs an event location and a location confidence; and (23) training an audio alignment model comprising an artificial neural network that receives as a model input of the audio alignment model a video, an event boundary, and an audio, and outputs an audio alignment to the event location.

The method may also include (24) normalizing a waveform of each audio file of the two or more audio files with respect to each other waveform of each other audio file of the two or more audio files; and (25) applying a non-linear normalization function based on the priority value of the two or more event objects.

The audio library may comprise the first audio file and the first audio file may be matched to the first event object. The method may then further include (26) receiving a generative request from the user to replace the first audio file; (27) generating an audio description of the first audio file; (28) inputting into a generative audio model a generative instruction along with a model input of the generative audio model comprising at least one of: (i) the audio description of the first audio file, and (ii) the first audio file; (29) outputting a generative audio file from the audio generation model; (30) generating an audio UID for the generative audio file; and (31) storing the generative audio file in association with the first event object.

The method also can include (32) selecting a third event object of the set of one or more event objects; (33) associating the first event object with the third event object within the data structure by storing an event reference between the first event object and the third event object; and (34) designating a relational imperative comprising at least one of an identity imperative, a similarity imperative, a differentiation imperative, a contrast imperative, and a complementary imperative. A model input of the generative audio model may further include the relational imperative, and at least one of (i) an audio description of a third audio file associated with the third event object; and (ii) the third audio file associated with the third event object.

The method may further include (35) receiving an updated priority value for the first event object; (36) determining a match between the first event object and a fourth event object through at least one of (i) traversing an event reference between the first event object and the fourth event object, where the event reference is designated as an identity imperative and a similarity imperative; (ii) a match between the event description data of the first event object and an event description data of the fourth event object; (iii) a match between a subject of the first event object and a subject of the fourth event object; and (iv) a match between an event tag of the first event object and an event tag of the fourth event object; (37) propagating the updated priority value to the fourth event object; and (38) mastering into a master audio file at least a subset of the two or more audio files associated with each of the two or more event objects, the subset comprising at least one of the first audio file matched to the first event object and the generative audio file generated for the first event object.

The above method for mixing audio to enhance video may be implemented as executable computer readable instructions stored on a non-transitory, computer readable media, that when executed perform each step of the method. Similarly, the computer readable instructions may be stored on and executed by one or more computers, including server computers, as shown and described herein.

### Definitions

Video—may be a video encoded as a digital file. The digital file may be an ordered sequence of still images, which may be known as frames. These frames may be played back at a specific rate, known as the frame rate, which may be the number of frames played back per second. These video files can be compressed. A common video file format can include .mp4 and .mov format. Video may or may not have an audio component. When the video includes audio, it may be explicitly indicated as either: video file with audio, or audio-video file. Videos may be narratives, and may contain stories. Videos do not need to depict the real world. Videos may be animated. Videos may be entirely abstract. Videos may be fully synthetic.

Video may refer to videos of arbitrary number of channels and resolution. Videos may be single channel (e.g., like television or YouTube), where only one video file is played at a time. Videos may have more than one channel. Virtual Reality (VR) headsets may have two video channels, e.g., one for each eye. Video Art installations may have over ten channels, or sometimes hundreds.

Videos may be masked onto other videos or images. Masking videos onto video streams of reality may be a form of visual Augmented Reality (AR). Videos may be live or prerecorded. When videos are live this may be referred to as a video stream. This may encompass both live stream video (Twitch®, Youtube®, Netflix®) and videos temporarily stored and processed in stream buffers. When videos are prerecorded they may be saved in persistent storage as a digital file.

Sound—Sound may include vibrations of air or other media, which may be heard by a person. Sound is a real world phenomena. A bird chirping is a sound. A distorted guitar playing from an amplifier is a sound. The crashing of a tree falling in the woods emits a sound.

Audio—Audio may produce sound through electrical or mechanical processes. Audio may be played over speakers and turned into sound. Audio may be digitally encoded in a file, such as .wav and .mp3. This data may be stored in a long term format as an audio file. This audio data also may be stored temporarily in memory (RAM or Random Access Memory), transmitted as part of a stream, or placed in a buffer for immediate processing by other computational processes. During one or more processes, audio may not always be saved as a file, but may be saved in more temporary containers, which may allow for more efficient computation (in terms of speed and/or storage). These files may be at an arbitrary sample rate. Typical sample rates of the embodiments herein may be between 11 kHz and 200 kHz. A common sample rate may include 48 kHz. However, for the embodiments described herein, the sample rate of the audio is arbitrary. The systems and methods described herein may apply to audio with any sample rate.

The audio file may be compressed or uncompressed and may have at minimum one channel, which is known as a mono. One or more other embodiments herein may use stereo audio files, which may have two channels. However, audio files with more than two channels may be used without departing from the scope hereof. The audio file may contain any type of audio, from music, to environmental noise, to talking, to sound effects, to noise, and so on.

The audio files may be made in many ways. The embodiments herein are relevant to a multitude of audio creation processes. For example, audio may be recorded from real world sounds with a microphone, and the recording then encoded into a digital file. The audio may also be synthesized, e.g., through an analog or digital system that generates an audio file. An electronic music instrument may be used to directly write audio files. A VST (virtual studio technology) may create audio files, according to one or more embodiments. In addition, as shown and described herein, a neural network may generate an audio file.

Frame-Frame may be a span of time in a digital file. The digital file may be an audio file, or a video file. The embodiments herein may use frames to represent both a unit of time, or the actual audio or video data that is encoded in a file at the time of a particular frame.

One example of a frame being used as a unit of time is the following description of an event: “the dog runs from the left side of the screen to the right side of the screen from frame 250 to frame 500”. This means that the event of the dog running takes place during the time span of a video starting at the 250th image frame until the 500th image frame. Where each frame airs for 50 milliseconds, then this represents a span of 12.5 seconds.

Examples of frame being used as media or data include: a single frame of a video that is a static image (or more images if it is a multichannel video) and/or a single frame of an audio file, if it is a digitized voltage value. When the audio file has more than one channel, it may have the same number of values as it does channels. Stereo files may have two values per frame and Quadraphonic files have four values per frame.

Foley—may include audio that represents homodiegetic sound events added to video after the video has been recorded. Foley may also mean the process by which audio is added to events. One purpose of foley may include adding sound effects that coincide with events depicted in the video. The full mixed track of the audio added to the video also may be known as foley.

Sound Effect—A sound effect may be audio added to video media or other multimedia that represent the sound of events diegetic to the video or multimedia, as well as heterodiegetic events. An example of this is a video of a chef chopping onions on a wooden cutting board. Each time the chef cuts the onion, the knife slices through the onion, and is in motion until it hits the wooden cutting board. The instant the knife hits the wooden board, a sound impulse is to be heard. Each of these impulses is a sound effect. This sound effect is a depiction of a homodiegetic event with respect to the events shown in the video or other multimedia. A second example is a video showing a person riding a skateboard. The person suddenly crashes into a stop sign and falls to the floor. Immediately after they fall, the video's audio track plays a comedic voice that loudly yells the word fail. The use of the fail recording is an heterodiegetic event with respect to the events shown in the video. Nobody in the actual environment in the video is actually saying “fail.” However, the director or creator of the media is deliberately making the creative gesture of playing a voice that says fail at the moment a person is experiencing pain. This sound effect is used for a comedic effect, almost like a punch line in a joke.

Sound effects may be used for more structural heterodiegetic events in videos. Like risers, laugh tracks, and/or meme sound effects. These are all sounds that respond to either the homodiegetic events or to the contextual structure of the video. A riser, for example, may be played after one scene ends and before another scene begins. The scene break may be an event that is separate from the homodiegetic events of the video.

Diegesis—may be a concept from narratology. Diegesis means “whether the narrator is involved (homodiegetic) or not involved (heterodiegetic) in the story.” Further, “in a homodiegetic narrative, the narrator is not just the narrator but a character as well, performing actions that drive the plot forward.” In the context of videos, there may be a diegetic relationship of audio to video. Audio may either be homodiegetic or heterodiegetic. Homodiegetic audio may include any sounds that are happening as a result of events happening in the video. Examples include: a video showing a person walking, with audio of footsteps; and a video of a woman playing guitar, with the audio of what she is playing on the guitar. Heterodiegetic audio may include any sounds that do not come from the events depicted in the video. Heterodiegetic sounds may be reactions to the events happening in the video's narrative. An example is a video of a woman walking on a beach where the video's audio track is a full mix of a recorded song by The Beatles. This music is not coming from anything depicted in the video. Another example is a video of a dog catching a frisbee. The video's audio track plays a sound of a door bell ding-dong. The ding-dong sound may not be actually coming from the depicted door bell. The ding-dong sound may have been deliberately inserted by the creators of the video to evoke a reaction from the audience. Another example is a laugh track in a video of a sit-com. The main character tells a joke. Immediately after the joke is told, an audio recording of laughing is played. The sound of laughing is heterodiegetic. The laughter is a response to the events of the video.

Event—The concept of event may come from the field of narratology. In the context of text-based narrative, an event may include “ . . . an action or state of being depicted in text span.” In the context of video, an event may include an action or state of being depicted in a video. An example is a video of a person walking in the desert. The event is the walking. This event is an action. Another example is a video that shows a person accidentally dropping their ice cream cone on the floor. The person starts crying because they are sad. In this example, there are at least three events here: 1) Dropping the ice cream cone is an action. 2) Crying is an action. 3) The person crying is sad. Being sad is a state of being.

Event extraction—Event extraction may include automated process which takes the input of a video or multimedia, performs computation on the video, and produces an output which is information in a structured format which represents the heterodiegetic events depicted in the video. This structure may come in many forms, including ontologies. For example, TimeML and FrameNet are ontologies sometimes used for representing the semantics of events and their timing.

An example structure that some event extractions may use is a temporal class of event: impulse (e.g., instantaneous), durational (e.g., temporal), periodic, sustained, etc. Timed events may occur in video as measured in seconds. Duration of events may continue for specific types of temporal classes. The example structure may also include an event agent, an event patient, and/or a description of event, such as: a dog running down an alley, a cat climbing a tree, and a pitcher throwing a ball. Because event extraction may have originated in a natural language processing discipline, some persons skilled in the art of computer vision and/or video processing have adopted some of the semantics of the NLP community.

Video understanding—Video understanding may include the process of automatically extracting information from a video in a structured format.

Audio Mixing—Audio mixing may include the process of altering and combining one or more audio sources over the course of time. The result of mixing is either an audio file or a recording on analog media. Mixing may include mixing digital audio to create a digital audio file. Each audio source may have an arbitrary number of channels (e.g., one or more). In both analog and digital mixing, the act of combining two audio signals is additive. Mixing may include more than just combining audio signals. Audio channels may be panned and/or mixed to specific channels, or proportionally mixed to different channels simultaneously. Mixing also may be used to reduce the number of channels in a recording, according to one or more embodiments. Mixing may be used to process audio recordings, via effects loops. For example, an audio file containing a recording of a drum set playing a beat in 4/4 at 120 beats per minute (BPM), may be altered so that it is mixed with itself with a reverb effect. The original dry recording might be reduced to 60% of its original volume, and the reverb version of the recording is mixed in at 50% volume. This may produce a single audio that is an altered version of the original. For example, traditional Foley techniques may commonly employ these and other types of mixing.

In one or more embodiments, mixing herein may occur when two or more portions of audio are mixed into a single audio file. This audio file may be layered onto a video of a video file 630.

Layering—In one or more of the present embodiments, layering audio onto a video or other multimedia may include putting an audio track of time duration equal to the video's or other multimedia's duration. The result of this process may include creation of a video or other multimedia where the audio track is aligned, and plays simultaneously with the video or other multimedia. This processing also may be known as “overlaying.”

Depicted multimedia context—Multimedia (such as video) depicted context may include the scene and state that is depicted in a video. The setting in the video is part of the context, as well as other details like the time, what is shown in the frame, etc. For example: a video of a beach is shown. It is very sunny. There are children playing with a ball in the ocean. There are many women sun tanning on lounge chairs. This all may be depicted contextual information relevant to what is depicted in the video. Some of these are events, specifically state of beings.

Although the present embodiments have been described with reference to specific example embodiments, it will be evident that various modifications and changes may be made to these embodiments without departing from the broader spirit and scope of the various embodiments. For example, the various devices, engines, agent, routines, and modules described herein may be enabled and operated using hardware circuitry (e.g., CMOS based logic circuitry), firmware, software, or any combination of hardware, firmware, and software (e.g., embodied in a non-transitory machine-readable medium). For example, the various electrical structures and methods may be embodied using transistors, logic gates, and electrical circuits (e.g., application specific integrated circuitry (ASIC) and/or Digital Signal Processor (DSP) circuitry).

In addition, it will be appreciated that the various operations, processes, and methods disclosed herein may be embodied in a non-transitory machine-readable medium and/or a machine-accessible medium compatible with a data processing system (e.g., the client device 102, the enhancement server 200, the event structure server 300, the audio server 400, the generative server 500, the multimedia server 600, etc.). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; a smartphone, application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, one or more embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The term “processor” may refer to any device or portion of a device that processes electronic data from registers and/or memory to transform that electronic data into other electronic data that may be stored in registers and/or memory. A “computing platform” may comprise one or more processors.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing the multimedia audio enhancement network 100 and elements thereof, according to the present invention will be apparent to those skilled in the art. Various aspects of the invention have been described above by way of illustration, and the specific embodiments disclosed are not intended to limit the invention to the particular forms disclosed. The particular implementation of the multimedia audio enhancement network 100 and elements thereof may vary depending upon the particular context or application. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

We claim:

1. A system for parsing a video file for audio enhancement of the video file, the system comprising a processor and a memory that comprising a physical non-transient computer readable memory storing computer readable instructions that when executed:
specify a video file;
initiate a video object in a database;
store a video UID in association with the video object;
store a video file reference drawn from the video object to the video file;
generate a video structure data comprising a video segmentation reference drawn from the video object to a segmentation object within the database;
parse the video file to extract an event comprising at least one of an action and a state of being depicted in the video file, a parsing process comprising:
determining an event range comprising at least one of a time range of the event and a frame range of the event,
inputting a portion of the video file specified by the event range to an event description model,
receiving at least one of an event description data and an event summary data,
inputting the portion of the video file specified by the event range into an event ontology determination module, and
receiving an event ontology data comprising at least one of a verb class data and a semantic roll label data;
initiate an event object in the database and storing an event UID in association with the event object;
store in association with the event object (i) an event range data comprising at least one of the time range and the frame range, (ii) at least one of the event description data and the event summary data, and (iii) the event ontology data; and
associate within the database the video object and the event object through at least one of (i) an event object reference drawn between the video object and the event object and (ii) two or more segmentation references linking the video object to the event object through one or more interstitial segmentation objects between the video object and the event object within the database, to form a contextual link for efficiently importing context for at least one of audio matching and audio generation to assign to the event.

2. The system of claim 1, wherein the memory further comprising computer readable instructions that when executed:
input at least one of the event description data, the event summary data, the verb class data, and the semantic roll label data into a vector embedding engine;
receive a description vector encoding text from at least one of the event description data, the event summary data, the verb class data, and the semantic roll label data,
input the event range data into the vector embedding engine;
receive a temporal vector embedding event range data; and
store the description vector and the temporal vector in association with the event object for rapid query and use in at least one of audio matching and audio generation associated with the event.

3. The system of claim 2, wherein the memory further comprising computer readable instructions that when executed:
parse the video file to extract a shot comprising a continuous recording from a single camera perspective, the parsing process comprising:
determining a shot range comprising at least one of a time range of the shot and a frame range of the shot,
inputting a portion of the video file specified by the event range into an event description model,
receiving at least one of a shot description data and a shot summary data,
initiate a shot object in the database and storing a shot UID in association with the shot object;
associate within the database the video object and the shot object through at least one of (i) a shot object reference drawn between the video object and the shot object and (ii) a segmentation reference linking the video object to the shot object through an interstitial segmentation object between the video object and the shot object; and
associate within the database the shot object and the event object through a second event object reference drawn between the shot object and the event object.

4. The system of claim 3, wherein the memory further comprising computer readable instructions that when executed:
parse the video file to extract a scene comprising a series of one or more shots depicting events closely interrelated in time, the parsing process comprising:
determining a scene range comprising at least one of a time range of the scene and a frame range of the scene,
inputting a portion of the video file specified by the scene range into a segmentation description model,
receiving at least one of a scene description data and a scene summary data,
initiate a scene object in the database and storing a scene UID in association with the scene object;
associate within the database the scene object and the shot object through a shot object reference drawn between the scene object and the shot object; and
associate within the database the video object and the scene object through a scene object reference drawn between the video object and the scene object.

5. The system of claim 4, wherein the memory further comprising computer readable instructions that when executed:
determine an event of the event object is associated with a different event of a different event object;
classify at least one of a subject of the event and an action of the event and classifying at least one of a different subject of the different event and a different action of the different event;
determine at least one of (i) the subject is higher priority than the different subject, and (ii) the action is higher priority of the different action; and
write a priority value of the event in the event object that is greater than a priority value of the different event such that an audio assigned to the event is signaled for amplification relative to the audio assigned to the different event.

6. The system of claim 5, wherein the memory further comprising computer readable instructions that when executed:
select the event object for audio generation;
extract at least one of an encoding vector of the event object, the event description data, the event summary data, an event tag, and the event ontology data;
traverse a database reference between the event object and the shot object;
extract at least one of an encoding vector of the shot object, the shot description data, a shot summary data, and a shot tag;
traverse a database reference between the shot object and the scene object;
extract at least one of an encoding vector of the scene object, the scene description data, a scene summary data, and a scene tag;
traverse a database reference between the scene object and the video object;
extract at least one of an encoding vector of the scene object, the scene description data, a scene summary data, and a scene tag; and
generate a context data comprising data extracted from each of the event object, the shot object, the scene object, and the video object, to gather relevant context for generation of the audio for the event.

7. The system of claim 6, wherein the memory further comprising computer readable instructions that when executed:
input the context data into a generative audio engine;
receive an audio file that is output from the generative audio engine;
store the audio file in association with the event object;
determine an event of the event object is associated with another event of another event object, wherein the association is a causal relation,
define a third event reference drawn between the event object and another event object;
impose a contrast requirement on at least one of an audio matching engine matching the audio to be associated with the event object and a generative engine generating the audio associated with the event object,
wherein the audio file associated with the event is at least one of matched and generated based on contrast with a different audio file of the different event; and
import the context data into at least one of a context window of a generative audio model and an argument of the generative audio model,
wherein a context weight assigned to data within the context data diminishes with each database reference traverse from the event object,
wherein extraction of a scene comprising recognition of similar graphical data between frames within a time horizon of the video file, and
wherein extraction of a shot comprising recognition of low relative variation in graphical data between frames within a time horizon of the shot.

8. A computer readable media that is physical and non-transitory comprising a data structure for efficient audio matching and/or audio generation for a video file, the data structure comprising:
a video object as a root of the data structure, comprising:
a video object UID,
a video file reference to the video file,
a video data comprising at least one of a video description data, a video summary data, and a video tag, and
a video structure data comprising a first segmentation object reference storing a first segmentation object UID;
a first segmentation object of a first order segmentation referenced by the first segmentation reference, the first segmentation object comprising:
the first segmentation object UID, and
at least one of a segmentation description data of the first segmentation object, a segmentation summary data of the first segmentation object, and a segmentation tag of the first segmentation object; and
a first event object referenced by at least one of the first segmentation object and one or more other segmentation objects referenced by the first segmentation object, the first event object comprising:
an event UID of the first event object,
an event range data specifying a range over which an event of the first event object occurs within the video file,
an event description data of the first event object comprising at least one of an event description data of the first event object, an event summary data of the first event object, and an event tag of the first event object, and
an event ontology data of the first event object comprising at least one of a subject-object parse of the first event object, a verb class data of the first event object, and a semantic roll label data of the first event object.

9. The computer readable media of claim 8, wherein:
the first event object further comprising at least one of (i) a description vector of the first event object that encodes at least one of the event description data, the event summary data of the first event object, the event tag of the first event object, and the event ontology data of the first event object, and (ii) a temporal vector of the first event object that encodes at least the event range data, and
the first segmentation object further comprising a description vector of the segmentation object that encodes at least one of the segmentation description data of the first segmentation object, and a segmentation tag of the first segmentation object.

10. The computer readable media of claim 9, wherein the data structure further comprising:
a second segmentation object of a second order segmentation, the second segmentation object comprising:
a second segmentation UID,
at least one of a segmentation description data of the second segmentation object, a segmentation summary data of the second segmentation object, and a segmentation tag of the second segmentation object; and
wherein the one or more other segmentation objects referencing the first event object comprises the second segmentation object.

11. The computer readable media of claim 10, wherein the data structure further comprising:
a second event object comprising an event UID of the second event object,
wherein the second event object referenced by at least one of the first event object and the second segmentation object such that the second event object can be at least one of defined to be and determined to be a related event to the event modeled by the first event object.

12. The computer readable media of claim 11,
wherein the first event object further comprising a priority value of the first event object specifying at least one of a global priority, a local priority within a segmentation order, and a local priority among two or more event objects within a temporal proximity threshold, and
wherein the second event object comprising a priority value of the second event object such that query to at least one of the first event object and the second event object can resolve a priority between the event of the first event object and an event of the second event object.

13. The computer readable media of claim 12, wherein the first order segmentation models a scene, and a second order segmentation models a shot.

14. A method for parsing a video file for audio enhancement of the video file, the method comprising:
specifying a video file;
initiating a video object in a database stored in one or more non-transitory computer readable memories;
storing a video UID in association with the video object;
storing a video file reference drawn from the video object to the video file;
generating a video structure data comprising a video segmentation reference drawn from the video object to a segmentation object within the database;
parsing the video file to extract an event comprising at least one of an action and a state of being depicted in the video file, a parsing process comprising:
determining an event range comprising at least one of a time range of the event and a frame range of the event,
inputting a portion of the video file specified by the event range to an event description model,
receiving at least one of an event description data and an event summary data,
inputting the portion of the video file specified by the event range into an event ontology determination module, and
receiving an event ontology data comprising at least one of a verb class data and a semantic roll label data;
initiating an event object in the database and storing an event UID in association with the event object;
storing in association with the event object (i) an event range data comprising at least one of the time range and the frame range, (ii) at least one of the event description data and the event summary data, and (iii) the event ontology data; and
associating within the database the video object and the event object through at least one of (i) an event object reference drawn between the video object and the event object and (ii) two or more segmentation references linking the video object to the event object through one or more interstitial segmentation objects between the video object and the event object within the database, to form a contextual link for efficiently importing context for at least one of audio matching and audio generation for the event.

15. The method of claim 14, further comprising:
inputting at least one of the event description data, the event summary data, the verb class data, and the semantic roll label data into a vector embedding engine;
receiving a description vector encoding text from at least one of the event description data, the event summary data, the verb class data, and the semantic roll label data,
inputting the event range data into the vector embedding engine;
receiving a temporal vector embedding event range data; and
storing the description vector and the temporal vector in association with the event object for rapid query and use in at least one of audio matching and audio generation associated with the event.

16. The method of claim 15, further comprising:
parsing the video file to extract a shot comprising a continuous recording from a single camera perspective, the parsing process comprising:
determining a shot range comprising at least one of a time range of the shot and a frame range of the shot,
inputting a portion of the video file specified by the event range into an event description model,
receiving at least one of a shot description data and a shot summary data,
initiating a shot object in the database and storing a shot UID in association with the shot object;
associating within the database the video object and the shot object through at least one of (i) a shot object reference drawn between the video object and the shot object and (ii) a segmentation reference linking the video object to the shot object through an interstitial segmentation object between the video object and the shot object; and
associating within the database the shot object and the event object through a second event object reference drawn between the shot object and the event object.

17. The method of claim 16, further comprising:
parsing the video file to extract a scene comprising a series of one or more shots depicting events closely interrelated in time, the parsing process comprising:
determining a scene range comprising at least one of a time range of the scene and a frame range of the scene,
inputting a portion of the video file specified by the scene range into a segmentation description model,
receiving at least one of a scene description data and a scene summary data,
initiating a scene object in the database and storing a scene UID in association with the scene object;
associating within the database the scene object and the shot object through a shot object reference drawn between the scene object and the shot object; and
associating within the database the video object and the scene object through a scene object reference drawn between the video object and the scene object.

18. The method of claim 17, further comprising:
determining an event of the event object is associated with a different event of a different event object;
classifying at least one of a subject of the event and an action of the event and classifying at least one of a different subject of the different event and a different action of the different event;
determining at least one of (i) the subject is higher priority than the different subject, and (ii) the action is higher priority of the different action; and
writing a priority value of the event in the event object that is greater than a priority value of the different event such that an audio assigned to the event is signaled for amplification relative to the audio assigned to the different event.

19. The method of claim 18, further comprising:
selecting the event object for audio generation;
extracting at least one of an encoding vector of the event object, the event description data, the event summary data, an event tag, and the event ontology data;
traversing a database reference between the event object and the shot object;
extracting at least one of an encoding vector of the shot object, the shot description data, a shot summary data, and a shot tag;
traversing a database reference between the shot object and the scene object;
extracting at least one of an encoding vector of the scene object, the scene description data, a scene summary data, and a scene tag;
traversing a database reference between the scene object and the video object;
extracting at least one of an encoding vector of the video object, the video description data, a video summary data, and a video tag; and
generating a context data comprising data extracted from each of the event object, the shot object, the scene object, and the video object, to gather relevant context for generation of the audio for the event.

20. The method of claim 19, further comprising:
inputting the context data into a generative audio engine;
receiving an audio file that is output from the generative audio engine;
storing the audio file in association with the event object;
determining an event of the event object is associated with another event of another event object, wherein the association is a causal relation,
defining a third event reference drawn between the event object and another event object;
imposing a contrast requirement on at least one of a audio matching engine that matches the audio to be associated with the event object and a generative audio engine that generates the audio to be associated with the event object,
wherein the audio file associated with the event is at least one of matched and generated based on contrast with a different audio file of the different event; and
importing the context data into at least one of a context window of a generative audio model and an argument of the generative audio model,
wherein a context weight assigned to data within the context data diminishes with each database reference traverse from the event object,
wherein extraction of a scene comprising recognition of similar graphical data between frames within a time horizon of the video file, and
wherein extraction of a shot comprising recognition of low relative variation in graphical data between frames within a time horizon of the shot.
